(19) United States
(12) Patent Application Publication
(10) Pub. No.: US 2025/0065979 A1
(43) Pub. Date: Feb. 27, 2025

(54) REDUCER BODIES, EXTENDER BODIES, SUSPENSION LINKAGES, AND TWO-WHEELED VEHICLES INCLUDING THE SAME

(71) Applicant: YETI CYCLING, LLC, Golden, CO (US)

(72) Inventor: Peter ZAWISTOWSKI, Lakewood, CO (US)

(21) Appl. No.: 18/799,150

(22) Filed: Aug. 9, 2024

Related U.S. Application Data
(60) Provisional application No. 63/534,560, filed on Aug. 24, 2023.

(51) Int. Cl. B62K 25/28

(52) U.S. Cl. CPC B62K 25/286

(57) ABSTRACT

Two-wheeled vehicles, suspension linkages, and reducer and extender bodies therefor are disclosed. A two-wheeled vehicle suspension can include a links movably joined together, including a suspended body and a rear frame and defining a suspension linkage; a shock including first and second primary mounting features and defining a primary mounting length therebetween; and a reducing body coupled between the shock and the links. The shock can be operably coupled at the first and second primary mounting features between at least two links and can define a dynamic performance of the rear frame with respect to the suspended body when actuated between a first configuration and a second configuration. The reducing body can be coupled to the first primary mounting feature and one of the two links and can reduce the primary mounting length by a reduction length.

### CROSS-REFERENCE TO RELATED APPLICATION(S)

This application claims the benefit of priority pursuant to 35 U.S.C. § 119(e) of U.S. Provisional Patent Application No. 63/534,560, filed 24 Aug. 2023, and entitled “Two Wheeled Vehicle Suspension with Reducer Body,” which is hereby incorporated by reference in its entirety.

### TECHNICAL FIELD

The technology described herein relates to vehicle suspension systems. Specifically, the technology described herein relates to reducer bodies (also referred to as instenders) that can be used with a shock for a vehicle suspension system to reduce an effective length of the shock. The technology can further include extender bodies (also referred to as extenders) that can be used with a shock for a vehicle suspension system to increase an effective length of the shock.

### BACKGROUND

Vehicle suspension terminology depends upon the reference frame considered. Consider a static two-wheel vehicle that has two wheels, each of which is supported by the ground, and a suspended body operatively coupled to each wheel. In a two-wheel vehicle, such as a bicycle, an electric bicycle (e.g., an e-bike, an e-MTB, an electrically assisted pedal cycle, a pedelec, or the like), a motorcycle, etc., there may be a rear wheel, known as the driven wheel, which includes a driven cog. There may also be a front wheel. A driving cog may be operatively coupled to the suspended body. A driving chain or belt may connect the driven cog and the driving cog such that the driven cog may be rotated by a human power through a crank, by a motor, or by a combination of human power and a motor. The reaction of the driven wheel and the ground causes the vehicle to accelerate forward, or in the general direction from the rear wheel to the front wheel. Rearward may be defined as the general direction from the front wheel to the rear wheel.

A suspension linkage may operatively couple the suspended body and the driven wheel. The suspension linkage may be composed of multiple bodies (referred to as links, bodies, members, bars, linkage members, linkage bodies, linkage bars, etc.) that are operatively coupled to each other in a manner that allows the bodies to flex, cam, rotate or translate relative to one another. The suspension linkage constrains the movement of the driven wheel (e.g., and a brake, which may be operatively coupled to the driven wheel) relative to the suspended body. One or more dampers, shocks, and/or springs (also referred to as suspension resistance devices) may be arranged to react to relative motion between the suspended body and the driven wheel. The suspension linkage may define the vehicle's dynamic response to acceleration and deceleration and the mechanical advantage over the suspension resistance device. This can include when the vehicle is traveling over obstacles, forces are applied through the driving cog and the brake, and the like.

The suspension resistance device used with a vehicle suspension system may have an effective eye-to-eye distance (also referred to as a shock mounting length or the like), which is defined as a distance between mounting axes or attachment points of the suspension resistance device. Shock “extensions” can be coupled between a suspension resistance device and a vehicle suspension in order to increase the effective eye-to-eye distance between mounting axes of a suspension resistance device. However, this results in the suspension resistance device having an enlarged design envelope. It can be desirable to provide a suspension resistance device with a reduced design envelope in order to provide increased design freedom for vehicle suspension systems.

### SUMMARY

A suspension system for a two-wheel vehicle is disclosed. The suspension system can include a reducer body that can reduce a design envelope of a shock (e.g., a suspension resistance device) of the suspension system. Among other benefits, this can allow for a position of the shock to be raised with respect to the suspension system, while providing the shock with a design envelope that is beneficial to at least the design of dynamic performance of the suspension system and/or the placement of accessories and components within the suspension system.

One aspect of the present disclosure relates to a two-wheeled vehicle suspension assembly including a plurality of links movably joined together, the plurality of links including a suspended body and a rear frame and defining a suspension linkage, a suspension resistance device including a first primary mounting feature and a second primary mounting feature, the suspension resistance device defining a primary mounting length between the first and second primary mounting features, and a reducing body coupled between the suspension resistance device and the plurality of links. The suspension resistance device can be operably coupled at the first and second primary mounting features between at least two links of the plurality of links. The suspension resistance device can define a dynamic performance of the rear frame with respect to the suspended body when actuated between a first configuration and a second configuration. The reducing body can be coupled to the first primary mounting feature and one of the at least two links of the plurality of links. The reducing body can reduce the primary mounting length by a reduction length.

In some examples, the at least two links of the plurality of links to which the suspension resistance device is operably coupled can include the suspension linkage and the suspended body. In some examples, the reducing body can be operably coupled to the suspension resistance device and the suspension linkage.

In some examples, the reducing body can be rigidly coupled to the suspension resistance device. In some examples, the reducing body can reduce the primary mounting length by the reduction length in both the first configuration and the second configuration.

In some examples, the first primary mounting feature can include a first aperture defining a first axis and the second primary mounting feature can include a second aperture defining a second axis. The primary mounting length can be defined by a distance between the first axis and the second axis. The first axis can be nonparallel to the second axis.

In some examples, one of the first or second primary mounting features can be located adjacent a first end of the suspension resistance device and the other of the first or second primary mounting features can be located along a length of the suspension resistance device. The first primary mounting feature can include a first aperture defining a first axis and the second primary mounting feature can include a second aperture defining a second axis. The reducing body can be rigidly coupled to the first primary mounting feature. The first axis can be nonparallel to the second axis. In some examples, the first or second aperture of the other of the first or second primary mounting features can be threaded. In some examples, the suspension resistance device can include a shaft and a body. The other of the first or second primary mounting features can be positioned on the body.

In some examples, one end of the suspension resistance device can define a surface extending laterally across the suspension resistance device. The first primary mounting feature can be formed on the surface. The reducing body can be rigidly coupled to the surface. In some examples, the surface is planar. In some examples, the first primary mounting feature can include an aperture in the surface.

Another aspect of the present disclosure relates to a two-wheeled vehicle including a suspension assembly including a suspended body, a suspension linkage coupled to the suspended body, a suspension resistance device coupled between the suspended body and the suspension linkage, and an instender bracket defining a first connection feature and a second connection feature. The suspension resistance device can define a first end and a second end opposite the first end. The first end can define a first mounting feature and the second end can define a second mounting feature. A distance between the first and second mounting features can define a primary shock length. The first connection feature can be coupled to one of the first or second mounting features and the second connection feature can be coupled to the suspension linkage. A distance between the second connection feature and the other of the first or second mounting features can define an effective shock length.

In some examples, the effective shock length can be less than the primary shock length.

In yet another aspect of the present disclosure, a two-wheeled vehicle including a suspension assembly includes a front frame, a suspension linkage including a plurality of link bodies, a reducing body including a body portion, and a suspension resistance device coupled between the suspension linkage and the front frame. The suspension linkage can be movably coupled with the front frame. The body portion of the reducing body can define a first connection feature and a second connection feature. A distance between the first connection feature and the second connection feature can define a reduction length. The suspension resistance device can include a first portion including a first inner end and a first outer end and defining a first mounting feature and a second portion including a second inner end and a second outer end and defining a second mounting feature. The second portion can be movably coupled to the first portion at the first and second inner ends. The first and second portions can be configured to move telescopically relative to one another. The first outer end can be coupled with the front frame and the second outer end can be coupled with the suspension linkage. A distance between the first and second mounting features can define a primary mounting length. The first connection feature can be coupled to the suspension linkage. The second connection feature can be coupled to the second mounting feature of the suspension resistance device. A distance from the first connection feature to the first mounting feature can define an effective mounting length. The effective mounting length can be less than the primary mounting length by the reduction length.

In some examples, the body portion can extend from the second mounting feature along at least part of a length of the second portion to the first connection feature. In some examples, the body portion can be a first component. The reducing body can further include a second component.

In some examples, the first or second connection feature can include a flip chip. The reducing body can define a first reduction length or a second reduction length depending on an orientation of the flip chip.

In still another aspect of the present disclosure, a reducer body for a suspension linkage includes a first mounting axis configured to couple the reducer body to a suspension linkage and a second mounting axis configured to couple the reducer body to a shock. The first mounting axis can be nonparallel to the second mounting axis. The reducer body can be configured to reduce an effective mounting length of the shock.

In some examples, the first mounting axis can be defined at a first aperture and the first aperture can be threaded. In some examples, the reducer body can include a first component and a second component coupled to the first component at the second mounting axis. In some examples, the second body can be disposed between a first portion and a second portion of the first body. In some examples, the reducer body can be configured to be coupled to the shock with a mounting feature of the shock between the first and second bodies.

In some examples, first mounting axis and the second mounting axis can be configured to pivotally couple the reducer body to the suspension linkage and the shock, respectively. In some examples, the first mounting axis can be configured to pivotally couple the reducer body to the suspension linkage and the second mounting axis can be configured to rigidly couple the reducer body to the shock. In some examples, the reducer body can include a first connection feature and a second connection feature, and the reducer body can be configured to be coupled to the shock with a mounting feature of the shock between the first and second connection features. In some examples, the second mounting axis can be defined at an aperture, the aperture including threads.

In some examples, the reducer body can further include a flip chip. The first or second mounting axis can be defined by an aperture of the flip chip. The reducer body can be configured to reduce the effective mounting length of the shock by a different reduction length depending on an orientation of the flip chip.

In some examples, the reducer body can be configured to be coupled between a first mounting feature and a second mounting feature of the shock. In some examples, an inner diameter of the reducer body can be configured to extend along a portion of a length of the shock. The inner diameter can be greater than an outer diameter of a shaft portion of the shock and less than an outer diameter of a body portion of the shock.

In another aspect of the present disclosure, an extender body for a suspension linkage includes a first mounting axis configured to pivotally couple the extender body to a suspension linkage, a friction reducer, and a second mounting axis extending through the friction reducer and configured to pivotally couple the extender body to a shock. The first mounting axis can be nonparallel to the second mounting axis. The extender body can be configured to increase an effective mounting length of the shock.

In some examples, the first mounting axis can be defined at a first aperture and the first aperture can be threaded. In some examples the extender body can include a first component and a second component coupled to the first component at the second mounting axis. In some examples, the first mounting axis can be defined at a first aperture in the first component and a second aperture in the second component. In some examples, the first aperture and the second aperture can be threaded.

In some examples, the friction reducer can be a bushing. In some examples, the friction reducer can be a bearing.

### BRIEF DESCRIPTION OF THE DRAWINGS

FIGS. 1A and 1B show right-side views of a suspension linkage system in an extended state and a compressed state, respectively.

FIGS. 2A and 2B show right-side views of a suspension linkage system with a raised shock in an extended state and a compressed state, respectively.

FIG. 3A shows a right-side view of a bicycle including a suspension linkage system with a reducer body.

FIG. 3B shows a perspective view of the suspension linkage system of FIG. 3A.

FIGS. 4A and 4B show zoomed-in right-side views of the suspension linkage system of FIG. 3A in an extended state and a compressed state, respectively.

FIGS. 4C and 4D show zoomed-in right-side views of the suspension linkage system of FIG. 3A in an extended state and a compressed state, respectively.

FIG. 5 shows a perspective view of a shock, a reducer body, and an upper link of the suspension linkage system of FIG. 3A.

FIG. 6 shows a perspective view of a shock and a reducer body of the suspension linkage system of FIG. 3A.

FIGS. 7A and 7B show right-side views of a shock and a reducer body of the suspension linkage system of FIG. 3A in an extended state and a compressed state, respectively.

FIGS. 7C and 7D show front-to-back views of a shock and a reducer body of the suspension linkage system of FIG. 3A in an extended state and a compressed state, respectively.

FIG. 8 shows leverage rate curves for the suspension linkage systems of FIGS. 1A through 3C.

FIG. 9 shows a perspective view of a shock, a reducer body, and an upper link including a bridge.

FIG. 10 shows a perspective view of a shock, a 2-part reducer body, and an upper link.

FIG. 11 shows a perspective view of the shock, 2-part reducer body, and upper link of FIG. 10 in a partially assembled state.

FIG. 12 shows a perspective view of a shock and a reducer body rigidly mounted to the shock.

FIG. 13 shows an exploded perspective view of the shock and reducer body of FIG. 12.

FIG. 14 shows a perspective exploded view of a 2-part reducer body including an adjustable insert.

FIGS. 15A and 15B show perspective views of the 2-part reducer body of FIG. 14 and a shock with the adjustable insert in a first position and a second position, respectively.

FIG. 16 shows a perspective view of a shock and a reducer body.

FIG. 17 shows a cross-sectional view of the shock and reducer body of FIG. 16.

FIG. 18 shows a back-to-front view of the shock and reducer body of FIG. 16.

FIG. 19 shows a perspective view of a shock and a 2-part reducer body.

FIG. 20 shows a cross-sectional view of the shock and 2-part reducer body of FIG. 19.

FIG. 21 shows an exploded view of the shock and 2-part reducer body of FIG. 19.

FIG. 22 shows a back-to-front view of the shock and reducer body of FIG. 19.

FIG. 23 shows a perspective view of a shock and a 2-part reducer body.

FIG. 24 shows a cross-sectional view of the shock and 2-part reducer body of FIG. 23.

FIG. 25 shows an exploded view of the shock and 2-part reducer body of FIG. 23.

FIG. 26 shows a back-to-front view of the shock and reducer body of FIG. 23.

FIG. 27 shows a perspective view of a shock and a 2-part reducer body.

FIG. 28 shows a cross-sectional view of the shock and 2-part reducer body of FIG. 27.

FIG. 29 shows an exploded view of the shock and 2-part reducer body of FIG. 27.

FIG. 30 shows a back-to-front view of the shock and reducer body of FIG. 27.

FIG. 31A shows a right-side view of a suspension linkage system including a 2-part extender body in an extended state.

FIG. 31B shows a perspective view of the suspension linkage system of FIG. 31A.

FIGS. 32A and 32B show zoomed-in right-side views of the suspension linkage system of FIG. 31A in an extended state and a compressed state, respectively.

FIG. 33 shows a perspective view of a shock and an extender body of the suspension linkage system of FIG. 31A.

FIG. 34 shows an exploded perspective view of the shock and extender body of FIG. 33.

FIG. 35 shows a perspective view of a shock and a one-part extender body.

FIG. 36 shows an exploded perspective view of the shock and extender body of FIG. 35.

FIG. 37 shows a perspective view of a shock and a two-part extender body.

FIG. 38 shows an exploded perspective view of the shock and extender body of FIG. 37.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to vehicle suspension linkage systems that include a suspended body operatively coupled to a driven wheel. A vehicle suspension linkage system can include a rear linkage (e.g., a suspension linkage, a rear frame, or the like) coupled between the suspended body and the driven wheel. A shock (e.g., a damper, a coil, a suspension resistance device, or the like) can be coupled between the suspended body and the rear linkage. A reducer body (also referred to as an instender, a shock instender, a reducer, a reduction body, a reducing body, or the like) can couple the shock to the rear linkage. The reducer body can be used to decrease an effective mounting length of the shock. In other words, the reducer body can decrease an effective eye-to-eye distance between mounting axes or attachment points of the shock. This can be used to decrease a design envelope of the shock in order to provide increased design freedom for vehicle suspension linkage systems including the reducer body. In some examples, this can be used to raise a vertical position of the shock relative to the suspended body and/or the rear linkage.

In some examples, an extender body (also referred to as an extender, a shock extender, an extension or extending body, or the like) can couple the shock to the rear linkage. The extender body can be used to increase an effective mounting length of the shock. In other words, the extender body can increase an effective eye-to-eye distance between mounting axes or attachment points of the shock. This can be used to move a position of a shock forward relative to a suspension linkage, such as in a suspension linkage with a generally horizontally mounted shock. Positioning the shock forward relative to the suspension linkage can allow for a narrower design of the shock and the suspension linkage, creating more space within the suspension linkage to allow for improved shock capability, easier assembly and disassembly of the shock, and room for accessories or components, such as, for example, electric drive components, water bottles, tools, and spare parts. Further, providing an extender body coupled between the shock and the suspension linkage can provide leverage rate benefits to the suspension linkage. For example, increasing the effective mounting length of the shock can tend to linearize the leverage rate of the shock and suspension linkage and allow for increased progression, such as when the shock is mounted generally horizontally in the suspension linkage. These attributes can be difficult to achieve while providing clearance for components within the suspension linkage without an extender body coupled between the shock and the suspension linkage.

Both reducer bodies and extender bodies as disclosed herein can be provided with different and/or adjustable reduction or extension lengths, respectively. The reducer and extender bodies can be used with shocks having standard mounting lengths in order to provide custom effective mounting lengths for the shocks. This can be used to tune leverage rate curves of the shocks with suspension linkages.

In some examples, bearings (e.g., bushings, planar bearings, spherical bearings, other bearings, or friction reducers) can be provided between a shock and reducer or extender bodies coupled between the shock and a suspension linkage. The bearings can allow for low-friction or frictionless movement between the shock and the reducer/extender body. Movement between the shock and the reducer/extender body can be a result of misalignment of suspension elements of a suspension linkage. Providing the bearings between the reducer/extender body and the shock can reduce wear on the shock caused by movement and misalignment between components of the suspension linkage and the shock. An axis of a joint between the shock and the reducer/extender body can be clocked (e.g., nonparallel to) mounting axes of the reducer/extender body and the shock that are coupled to the suspension linkage. This can provide for rigid coupling of the reducer/extender body and the shock to the suspension linkage, while allowing for some slight movement between the shock and the reducer/extender body.

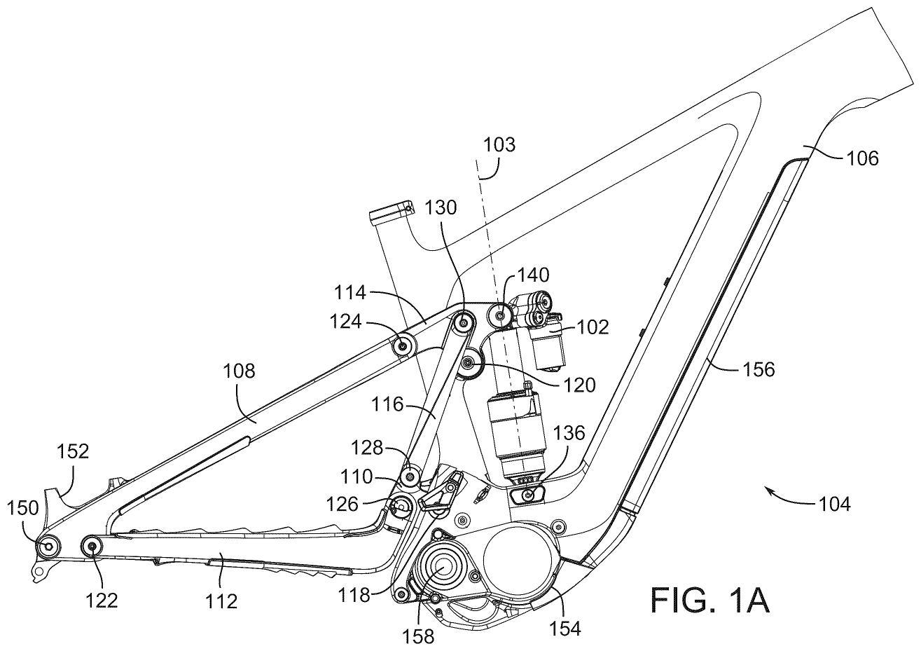

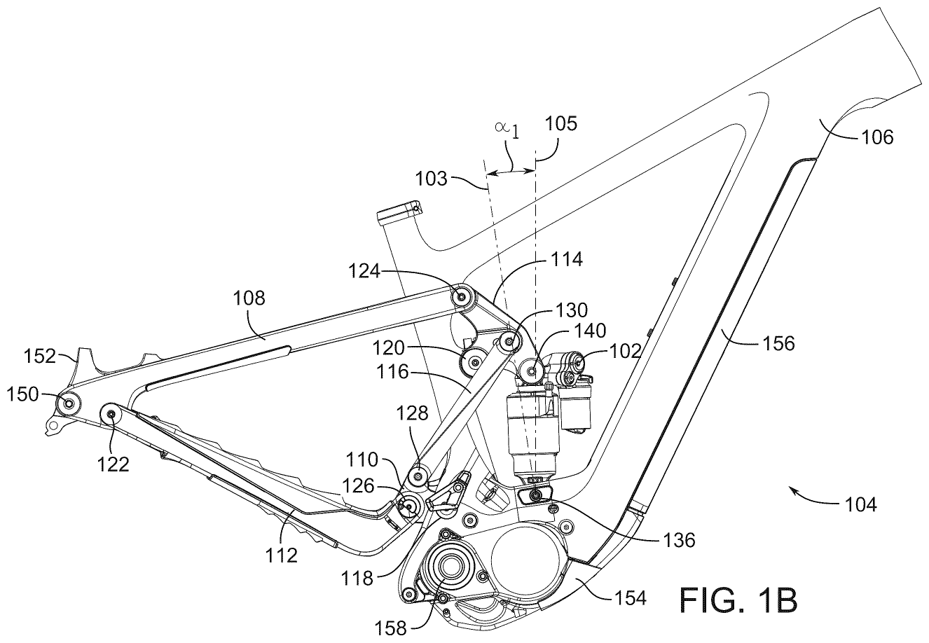

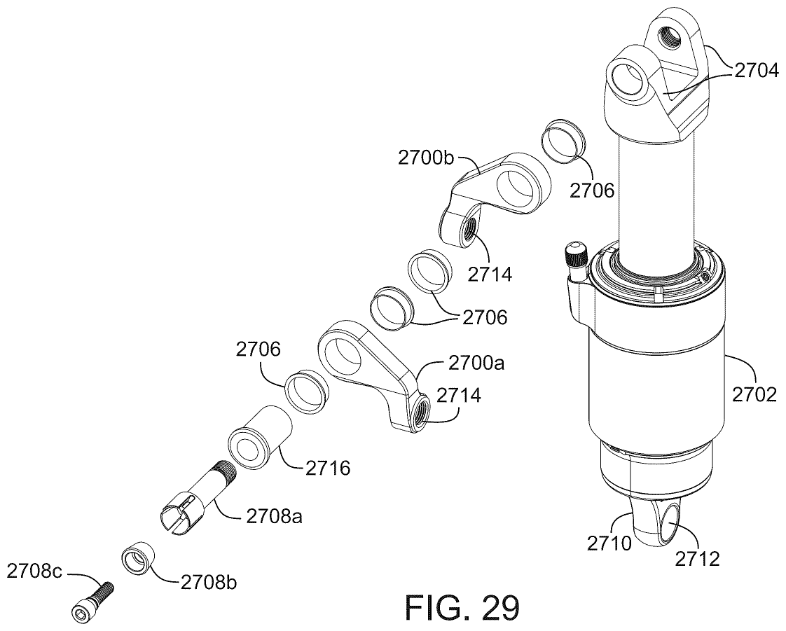

These and other examples are discussed below with reference to FIGS. 1A through 30. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

The present disclosure is described and illustrated in the context of an e-bike that includes a 6-bar suspension linkage system. The 6-bar suspension linkage system can include six linkage bodies that define 15 instantaneous velocity centers (IVCs). In the illustrated examples, 7 of the IVCs are physical IVCs (PIVCs) defined at joints or pivots operatively coupling various linkage bodies and the suspended body. However, the teachings of the present disclosure, related to reducer bodies and the like, can be used in any two-wheeled vehicle suspension linkage system, such as a suspension linkage system for a bicycle (e.g., a pedal bicycle), a motorcycle, etc. Moreover, the teachings of the present disclosure can be used in vehicle suspension linkage systems having more or fewer than six linkage bodies and any number of IVCs and PIVCs.

A suspension resistance device may be referred to as a shock. The shock may include a spring and a damper mechanism. The spring may be a coil (typically a metal, such as steel or titanium), an air canister, an elastomer, or the like. The damper may control the flow of oil within a canister. The spring and the damper can be combined into a single shock unit; however, the spring and the damper may be independent. A piggyback shock may refer to a shock that includes a damper disposed outside of a main body of a shock. An in-line or non-piggyback shock may refer to a shock that includes a damper within a main body of the shock. In some examples, the shock may be a compression shock, which may refer to a shock that builds resistance as the shock moves from an initial extended state and towards a compressed state. In some examples, the shock may be an extension shock, which may refer to a shock that builds resistance as the shock moves from an initial compressed state towards an extended state. The examples provided herein are described in the context of a compression shock for purposes of consistency. However, the teachings of the present disclosure can be applied to extension shocks.

Shocks generally include a body portion and a shaft portion that are concentrically connected. Depending on the shock architecture, the terms body or shaft may be used interchangeably. Both the body and the shaft can include mounting points or mounting features that allow the shock to be connected to a suspension linkage. The mounting features can be disposed at opposite outer ends of the body and the shaft, and inner ends of the body and the shaft can be coupled the body to the shaft. In some examples, mounting points of the mounting features can be pivotal mounting points.

In one arrangement, commonly referred to as a standard mount (or conventional mount) in the cycling industry, the mounting features can include through-hole eyelets positioned on opposing ends of the shock. For example, one eyelet can be coupled with or to a distal end of the shaft and another eyelet can be coupled with or to a distal end of the body. Typically, a bearing (or bushing) may be installed within or at each of the eyelets to minimize friction at pivotal connections where there may relative rotation between the shock and a linkage body of a suspension linkage to which the shock is mounted. These bearings allow for some misalignment between the shock and the suspension linkage, preventing binding and/or wear of the shock. Each of the eyelets defines a respective axis, and the axes of the eyelets are typically parallel when mounted to the suspension linkage. The eyelet axes are also typically parallel to linkage joint axes of a suspension linkage to which the shock is mounted. However, the eyelet axes may be nonparallel to one another and/or to linkage joints of the suspension linkage to which the shock is mounted. Note, in some examples, the eyelet axes may be in planes parallel to one another, but the eyelet axes themselves may be nonparallel with one another. The telescoping concentric connection between the body and the shaft of the shock may allow the eyelet axes to be nonparallel. Standard mount shocks and conventional mount shocks can be referred to as standard shocks.

In another arrangement, commonly referred to as a trunnion mount in the cycling industry, one of the body or the shaft can include a through-hole eyelet as described in the context of a standard shock, while the other of the body or the shaft can include one or more threaded interfaces. The body or the shaft can include two threaded interfaces on opposite sides of the body or shaft. The threaded interfaces form pivotal connections positioned along a length of the body or the shaft. The threaded interfaces can be positioned at a point other than at a terminal end. In other words, the threaded interfaces are positioned between opposite distal ends of the body and shaft. The threaded interfaces can be referred to as trunnion mounts or trunnion mount points. A bearing (or bushing) may be included at each respective threaded interface or within the suspension linkage at pivotal connections to the threaded interfaces. Threaded hardware, such as fasteners, may be installed through the bearings and into the threaded interfaces. The eyelet can define an axis and the threaded interfaces can define an axis. The axes of the eyelet and the threaded interfaces are typically parallel when mounted to the suspension linkage. The axes of the eyelet and the threaded interfaces are also typically parallel to linkage joint axes of a suspension linkage to which the shock is mounted. However, axes of the eyelet and the threaded interfaces may be nonparallel to one another and/or to linkage joints of the suspension linkage to which the shock is mounted. The telescoping concentric connection between the body and the shaft may allow the axes of the eyelet and the threaded interfaces of the shock to be nonparallel. Trunnion mount shocks can be referred to as trunnion shocks.

A distance between mounting points on a shock, such as between the two eyelets for a standard shock or between an eyelet and a threaded interface for a trunnion shock can define a primary mounting length of the shock (whether standard or trunnion). This may be referred to as a shock length, an eye-to-eye distance, or the like. This distance can be measured between pivot axes of the eyelets and/or threaded interfaces of a shock. For example, for a standard shock, a distance between an eyelet axis on an end of a shaft and an eyelet axis on an end of a body defines a shock length. For a trunnion shock, the shock length may be defined by a distance between an eyelet axis on an end of a shaft and a threaded interface (or a pivot mounting axis) on a sidewall of a body of the shock (or, from an eyelet axis on an end of a body to a threaded interface or pivot mounting axis on a sidewall of a shaft). In an example in which a shock has a mounting point on the body and a mounting point on the shaft (and does not use eyelets), the shock length may be the distance between pivot mounting axes of the mounting points. The shock length may have a maximum value when the shock is in an extended position (referred to as an extended state), such as when the shock is not under a compressive force. This may be referred to as a primary mounting length, an extended length, a baseline length, a nominal shock length, or the like. The shock length may have a minimum value when the shock is fully compressed (referred to as a compressed state), such as when the shock is under a large compressive force. This may be referred to as a secondary length or a compressed length.

A shock typically includes a pre-determined stroke length. The stroke length may the distance the shock length changes when the shock moves between the extended state (e.g., with the primary mounting length, extended length, or baseline length) and the compressed state (e.g., with the compressed length or secondary length). The shock length has a maximum value in the extended state and a minimum value in the compressed state. In other words, the stroke length of a shock is the distance between the shock length when the shock is in the extended state and the shock length with the shock is in the compressed state.

A standard shock typically has a longer eye-to-eye distance or shock length for a given shock than a corresponding trunnion shock since the mounting points (e.g., the eyelets) are at the respective ends of the shaft and the body. As an example, a common standard shock size may be “210 mm×55 mm.” This may refer to a standard shock having a 210 mm eye-to-eye distance and a 55 mm shock stroke. For the same 55 mm shock stroke, a common trunnion shock may be “185 mm×55 mm” or may include a 185 mm eye-to-eye distance. For a shock having the same stroke length, a trunnion shock typically has a shock length that may be about 25 mm shorter than a shock length of a standard shock. The shorter shock length of the trunnion shock can result in trunnion shocks having a smaller shock envelope. This means that the shock may take up less space in a suspension linkage and may move through a different range of angles during compression and extension than a standard shock. The shorter eye-to-eye distance can aid in tuning the leverage rate of a suspension linkage including a trunnion shock, as described below.

One disadvantage of using a trunnion shock as opposed to a standard shock may be that threaded interfaces of the trunnion shock allow for lower acceptable magnitudes of misalignment between the shock and a suspension linkage. Additionally, mounting axes of trunnion shocks are typically nonparallel to reduce wear and tear on the shock. Because the mounting points to the shock mount directly to the housing or shaft of the shock, any relative rotation between the shaft and the body of the shock during compression or extension of the shock can cause excessive wear and tear on the shock and reduce its performance. Thus, use of a trunnion shock can require tighter frame tolerances and a more rigid suspension linkage to prevent the shock from binding or wearing prematurely.

As discussed previously, a vehicle suspension linkage system (referred to as a suspension linkage), such as for a bicycle, can include a suspended body operatively coupled to a driven wheel by a rear linkage. The suspension linkage can be compressed or sag when the suspended body is loaded with a rider, passenger, or cargo to a desired vertical wheel travel at a sag point between an extended state and a compressed state. The ideal sag point varies depending upon desired ride characteristics, but typically ranges between 15-45% of the stroke length of a shock of the suspension linkage or a total wheel travel of the suspension linkage. The suspension linkage will be positioned near this sag point as the vehicle accelerates from a static position. The sag percentage may be defined as the following: a Vertical wheel travel value at sag point 100%

$$Sag = ( \frac{Vertical wheel travel value at sag point}{Total vertical wheel travel value} ) 100 \%$$

A leverage ratio for a vehicle suspension linkage system may be defined as a ratio of vertical rear wheel travel to stroke of a shock of the suspension linkage. As an example, a suspension linkage with a total vertical rear wheel travel of 140 mm that includes a shock with a stroke of 55 mm may have a leverage ratio of 2.55.

The leverage rate (LR) for a vehicle suspension linkage system may be the instantaneous ratio of the change in vertical wheel travel to the change in shock stroke. A plot of the leverage rate can be generated to represent the instantaneous leverage rate of a suspension linkage as the suspension linkage (and the shock of the suspension linkage) moves between a fully extended state and a fully compressed state. A motion ratio (MR) for a vehicle suspension linkage system may be the inverse of the LR. A higher leverage rate of a suspension linkage results in the suspension linkage having a greater mechanical advantage on the shock and a lower force being required to compress the shock. Conversely, a lower leverage rate results in the suspension linkage having a lesser mechanical advantage on the shock and a higher force being required to compress the shock. The overall leverage rate progression percentage represents the slope of the instantaneous leverage rate curve. This can be determined by the percentage change of the extended state leverage rate to the compressed state leverage rate. As an example, if the extended state leverage rate is 2.86 and the compressed state leverage rate is 2.06, the overall leverage rate progression can be calculated as follows:

$$Overall LR Progression = ( \frac{2.86 - 2.06}{2.86} ) 100 \%$$

$$Overall LR Progression = ( \frac{0.8}{2.86} ) 100 \% = 28 \%$$

The eye-to-eye distance of a shock may have an important impact on the leverage rate of a suspension linkage, depending upon the geometry of the suspension linkage and the mounting location of the shock.

Reducer bodies are described herein that can be attached to a shock in order to reduce or decrease the eye-to-eye distance of the shock (e.g., a mounting length or shock length of the shock). In some examples, the magnitude of the reduction in shock length may be specifically chosen, as compared to a standard decrease of about 25 mm that may be available when using a trunnion shock. In some examples, the reducer bodies may allow for a greater range of shocks to be used with a suspension linkage, such as shocks with different piggyback reservoir mounting locations and orientations. Decreasing the eye-to-eye distance or shock length and/or allowing for alternative piggyback reservoir locations/orientations may be desirable, as explained below. In some examples, the shock may be oriented in an approximately vertical position relative to a suspended body of the suspension linkage. Approximately vertical includes a range of about 90 degrees relative to ground, plus or minus 40 degrees. FIGS. 1A through 3C illustrate suspension linkages with shocks mounted in approximately vertical positions relative to the suspended bodies.

It may be desirable to move a shock location vertically upwards for several reasons. For example, by moving the shock vertically upwards, the suspended body of a suspension linkage can be moved vertically upwards, increasing ground clearance of the suspended body. In the case of an assisted vehicle, such as an electric bicycle, certain components are often located in a position that interferes with a desired placement of the shock. For example, components such as the drive unit or battery may interfere with positioning of the shock. By moving the shock vertically upwards, there is more room for these components without interfering with the position of the shock.

However, moving the position of the shock vertically upwards by means of a linkage arrangement of the suspension linkage without shortening a shock mounting length may result in the leverage rate progression percentage of the suspension linkage becoming undesirably high for intended suspension performance. A leverage rate progression percentage that is too high can result in in the inability for the suspension linkage to use its full travel. Providing a reducer body mounted between a shock and a suspension linkage can reduce the shock mounting length, lowering the leverage rate progression percentage, even as the shock is moved vertically upwards. By reducing the shock mounting length, it may be possible to achieve a desired leverage rate progression percentage and leverage rate curve shape beneficial to the performance of a suspension linkage, while also moving the shock position vertically upwards to allow for other design considerations.

In some examples, shortening the eye-to-eye distance or shock length may also be useful when using a shock that has a piggyback reservoir. For example, a short eye-to-eye distance or shock length may allow for various orientations of the piggyback reservoir as well as allow a water bottle or other components to fit within a suspended body (e.g., a front frame or front triangle) of a suspension linkage without interference with the shock. In systems that do not include a shortened eye-to-eye distance or shock length, a frame designer may be limited in the piggyback reservoir orientation, especially when using a trunnion shock. Thus, including the reducer bodies that shorten the eye-to-eye distance or shock length allows for greater design flexibility in suspension linkage systems.

Decreasing the eye-to-eye distance or shock length may be particularly beneficial when the orientation of the shock is in an approximately vertical position. In this configuration, it may often be difficult to achieve a sufficiently low overall leverage rate progression percentage as well as a linear curve to aid in suspension performance. The decreased eye-to-eye distance or shock length provided by a reducer body may allow for packaging and suspension linkage arrangements that provide for a lower overall leverage rate progression percentage, and/or increased linearity, while simultaneously providing additional packaging space.

In some examples, a reducer body (e.g., a positioning bracket, an instender, or the like) can be used to reduce an effective mounting length of a shock by a fixed or adjustable length or distance. The distance by which the reducer body decreases the mounting length of the shock (e.g., by an offset distance, a reduction distance, a reduction length, or the like) establishes an effective mounting length of the shock and the reducer body. The effective mounting length be less than a primary mounting length of the shock by a reduction length. Shortening the effective mounting length relative to the primary mounting length can impact suspension kinematics of a suspension linkage on which the reducer body and shock are mounted, including a leverage rate, an anti-squat, an anti-rise, and the like and can allow for geometry of the suspension linkage to be altered. This offers users and designers the ability to finely tune the performance and other characteristics of a bicycle or other vehicle including the suspension linkage based on their desires.

As provided in U.S. Pat. No. 11,173,983, which is incorporated by reference for all purposes as if fully disclosed herein, one method for rigidly attaching an extension to increase a shock length may include rotating an axis (also referred to as “clocking”) of an eyelet or a trunnion mount axis that accepts the extension so that it is nonparallel to an axis of an opposite eyelet or trunnion mount.

The shock length of a standard or trunnion shock may be reduced by attaching a positioning bracket or reducing body to the shock. In some examples, a pivot axis at a mounting position that receives the positioning bracket can be non-parallel to an opposite pivot axis of the shock. A pivot axis of a mounting position, the pivot axis of the mounting position of the positioning bracket may be oriented to be parallel to the opposite eyelet.

A shock may also be designed with mounting features that allow for a reducer body or bodies to be rigidly mounted. For example, a shock may include threaded features to rigidly mount reducer body or bodies via bolts in order to reduce the shock mounting length.

Shock “extensions” are commonly used to increase the effective eye-to-eye distance of a shock. These may be mounted to the body or shaft end of a shock, and to a standard or trunnion mounting provision. Shock extensions, however, often result in the shock having a larger mounting length (e.g., the distance between the top and bottom attachment points), which increases its design envelope. A larger design envelope negatively affects the design flexibility related to the rear suspension system for a two-wheeled vehicle, whether the shock is generally vertically mounted or horizontally mounted on the front frame. It may also negatively impact the locations available for convenience items, such as water bottles or frame packs.

For shocks that are approximately or generally vertically mounted in a suspension linkage relative to a front frame or front triangle, raising the placement of a shock vertically (e.g., relative to the front frame) is believed to be beneficial for allowing desired suspension dynamics. However, raising the placement of a vertically oriented shock also creates design constraints.

FIGS. 1A and 1B illustrate side views of a suspension linkage 104 that includes a generally vertically oriented shock 102. In this example, the suspension linkage 104 includes a suspended body 106, a rear linkage (also referred to as a rear frame) for coupling the suspension linkage 104 with a driven wheel, and a suspension resistance device (e.g., the shock 102). Certain components of a bicycle are not illustrated in FIGS. 1A and 1B for clarity, including but not limited to a handlebar, a front fork, wheels, a seat, brakes, and a derailleur. A driven wheel axis 150 for a driven wheel and a brake caliper mount 152 for a brake caliper can be included on a seatstay 108 of the suspension linkage 104. FIGS. 1A and 1B illustrate an example of the suspension linkage 104, which can be applied to an e-bicycle and that includes a drive unit 154, including a motor and gearbox, and a battery 156 integrated into a down tube of the suspended body 106. The drive unit 154 can include a crank interface 158, which can be used to allow a crank and/or a driving cog to be coupled to the drive unit 154.

The rear linkage can include the seatstay 108, a lower link 110, a chainstay 112, an upper link 114, and a center link 116. The rear linkage and the suspended body 106 can define the suspension linkage 104. The suspension linkage 104 includes six linkage bodies and is an example of a 6-bar linkage.

The linkage bodies can include flexible joints, pivots, jointed connections, or the like that can operatively couple the linkage bodies to one another. The flexible joints/pivots/jointed connections can include revolute, slider, cam joints, or any other suitable flexible joints or pivots that allow one degree of freedom of movement between two linkage bodies they connect. The suspension linkage 104 can include seven physical instantaneous velocity centers (IVCs), which are illustrated as pivots or jointed connections between the six linkage bodies of the suspension linkage 104. The physical IVCs include an IVC[106][110] 118, an IVC[106][114] 120, an IVC[108][112] 122, an IVC[108][114] 124, an IVC[110][112] 126, an IVC[110][116] 128, and an IVC[114][116] 130. Additional hidden IVCs between each of the linkage bodies of the suspension linkage 104 can be numerically solved for. A total number of IVCs for the suspension linkage 104 can be 15, which includes both physical IVCs and hidden IVCs.

The shock 102 can be attached at one end to the suspended body 106 and at its other end to the rear linkage of the suspension linkage 104. The suspension linkage 104 can actuate the shock 102 as the rear linkage moves between an extended or uncompressed state, illustrated in FIG. 1A, and a compressed state, illustrated in FIG. 1B. The angle α₁ illustrated in FIG. 1B shows the angular movement of a longitudinal axis of the shock 102 from the extended state, indicated as axis 103, to the compressed state, indicated as axis 105. In FIGS. 1A and 1i, the shock 102 is attached at a lower end to the suspended body 106 at a joint 136 located just above the drive unit 154. The shock 102 is attached at an upper end directly to the upper link 114 of the suspension linkage 104 at a joint 134. The shock 102 is attached at its factory attachment locations, which are eyelets each having an axis. The axes of the eyelets are parallel to one another.

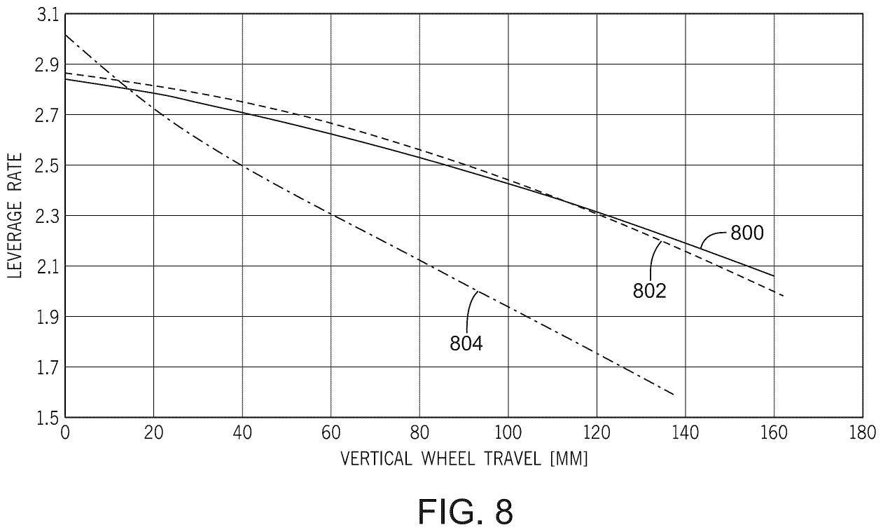

FIG. 8, discussed in detail below, illustrates a leverage rate curve 800 for the suspension linkage 104 of FIGS. 1A and 1B. For purposes of this description, the leverage rate curve 800 is a desired leverage rate curve. The leverage rate curve 800 can be a result of how the angle α₁ changes as the suspension linkage 104 moves between the extended state and the compressed state.

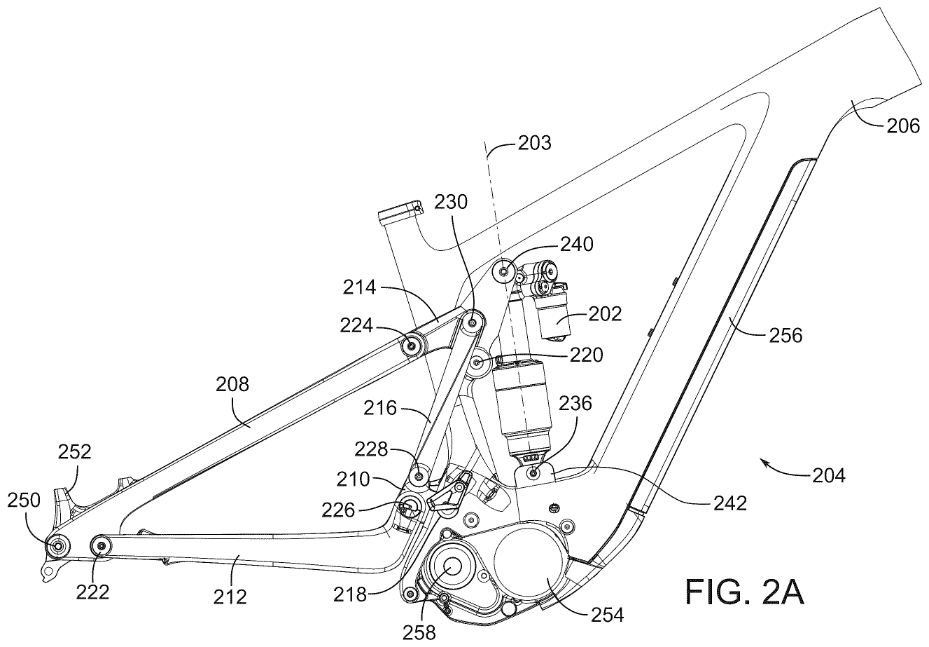

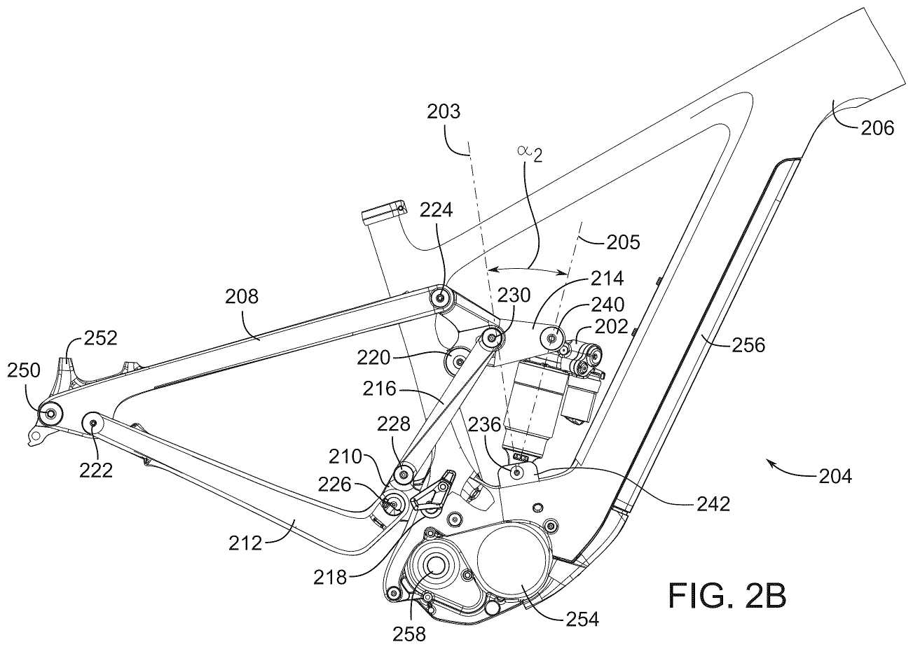

FIGS. 2A and 2B illustrate side views of a suspension linkage 204 that is similar to the suspension linkage 104 illustrated in FIGS. 1A and 1B. The primary difference in the suspension linkage 204 relative to the suspension linkage 104 of FIGS. 1A and 1B is that a position of a generally vertically oriented shock 202 is raised vertically relative to the suspension linkage 204. In this example, the suspension linkage 204 includes a suspended body 206, a rear linkage (also referred to as a rear frame) for coupling the suspension linkage 204 with a driven wheel, and a suspension resistance device (e.g., the shock 202). A driven wheel axis 250 for a driven wheel and a brake caliper mount 252 for a brake caliper can be included on a seatstay 208 of the suspension linkage 204. FIGS. 2A and 2B illustrate an example of the suspension linkage 204, which can be applied to an e-bicycle and that includes a drive unit 254, including a motor and gearbox, and a battery 256 integrated into a down tube of the suspended body 206. The drive unit 254 can include a crank interface 258, which can be used to allow a crank and/or a driving cog to be coupled to the drive unit 254.

The rear linkage can include the seatstay 208, a lower link 210, a chainstay 212, an upper link 214, and a center link 216. The rear linkage and the suspended body 206 can define the suspension linkage 204. The suspension linkage 204 includes six linkage bodies and is an example of a 6-bar linkage.

The linkage bodies can include flexible joints, pivots, jointed connections, or the like that can operatively couple the linkage bodies to one another. The flexible joints/pivots/jointed connections can include revolute, slider, cam joints, or any other suitable flexible joints or pivots that allow one degree of freedom of movement between two linkage bodies they connect. The suspension linkage 204 can include seven physical instantaneous velocity centers (IVCs), which are illustrated as pivots or jointed connections between the six linkage bodies of the suspension linkage 204. The physical IVCs include an IVC[206][210] 218, an IVC[206][214] 220, an IVC[208][212] 222, an IVC[208][214] 224, an IVC[210][212] 226, an IVC[210][216] 228, and an IVC[214] 1[216] 230. Additional hidden IVCs between each of the linkage bodies of the suspension linkage 204 can be numerically solved for. A total number of IVCs for the suspension linkage 204 can be 15, which includes both physical IVCs and hidden IVCs.

The shock 202 can be attached at one end to the suspended body 206 and at its other end to the rear linkage of the suspension linkage 204. The suspension linkage 204 can actuate the shock 202 as the rear linkage moves between an extended or uncompressed state, illustrated in FIG. 2A, and a compressed state, illustrated in FIG. 2B. The angle α₂ illustrated in FIG. 2B shows the angular movement of a longitudinal axis of the shock 202 from the extended state, indicated as axis 203, to the compressed state, indicated as axis 205. In the example of FIGS. 2A and 2B, the shock 202 is attached at a lower end to a riser bracket, a bottom riser mount, or an extension 242 of the suspended body 206 at a joint 236. The extension 242 can be used to move the joint 236 vertically upwards, away from the drive unit 254. The shock 202 is attached at an upper end to the upper link 214 of the suspension linkage 204 at a joint 234. The upper link 214 can have a lengthened lobe to provide a pivot connection to the shock 202 corresponding to the vertically raised position of a top attachment of the shock 202. The shock is attached at its factory attachment locations, which are eyelets each having an axis. The axes of the eyelets are parallel to one another.

FIG. 8, discussed in detail below, illustrates a leverage rate curve 804 for the suspension linkage 204 of FIGS. 2A and 2B. The leverage rate curve 804 can be a result of how the angle α₂ changes as the suspension linkage 204 moves between the extended state and the compressed state. The leverage rate curve 804 can trend down steeply and fall off significantly from the desired leverage rate curve 800 and can be an undesired leverage rate curve. The leverage rate curve 804 can signify an increased design envelope that can be associated with designing the shock 202 in the raised configuration of FIGS. 2A and 2B, as compared to the shock 102 in the configuration in FIGS. 1A and 1B. The angle α₂ can be greater than the angle α₁, at least in part due to the raised position of the shock 202 and the extended lobe of the upper link 214 used to compensate for the raised position of the shock 202.

Because it can be desirable to provide a shock in a vertically raised position within a suspension linkage and there are benefits associated with decreasing a design envelope of a shock, there is a need in the art for a shock mount that allows improved design freedom for mounting a shock relative to a suspended linkage. More particularly, there is a need to allow a generally vertically mounted shock to be positioned vertically higher relative to a suspension linkage and to be mounted with a reduced effective mounting length in order to allow improved design freedom.

### Reducer Bodies, Generally

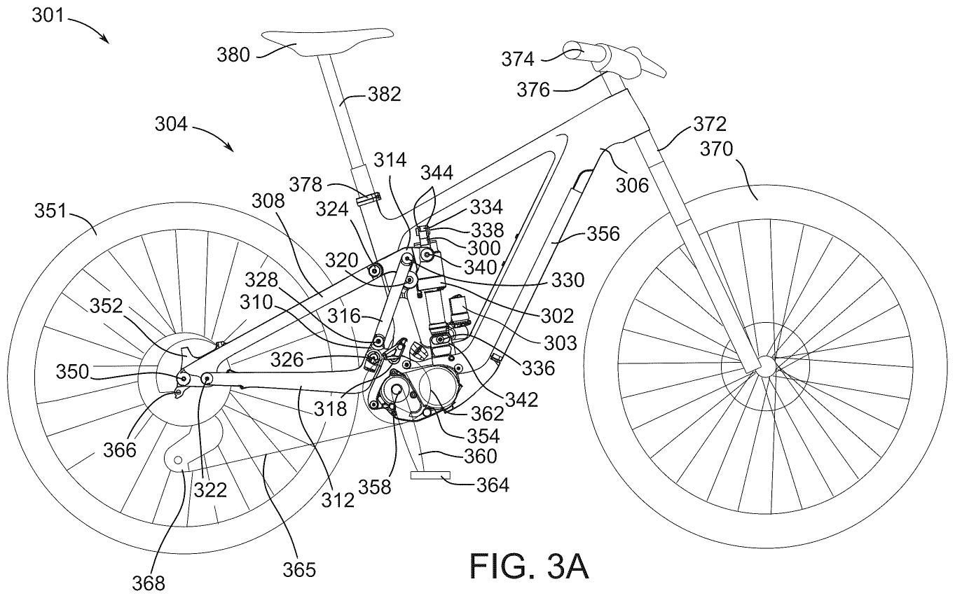

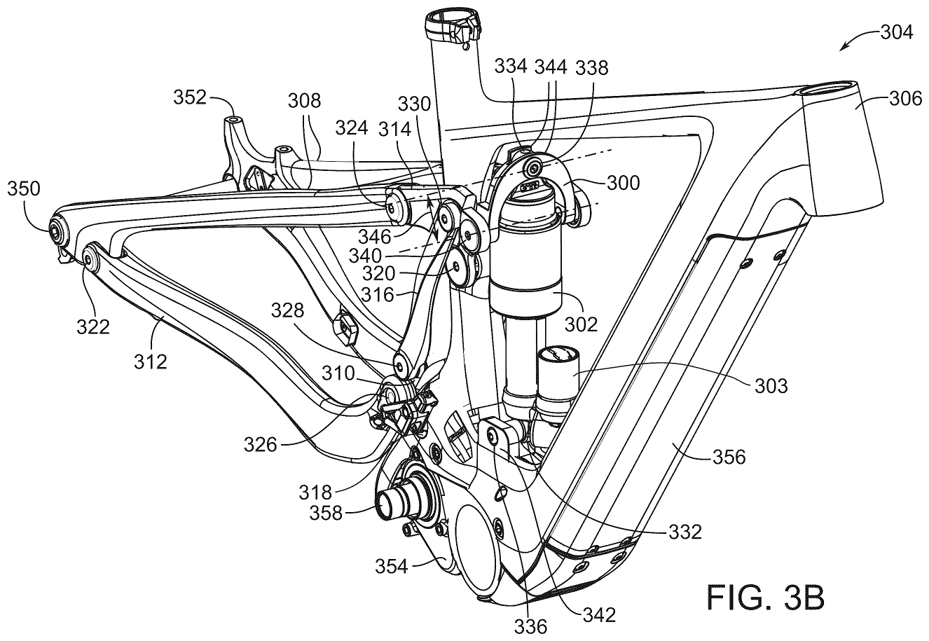

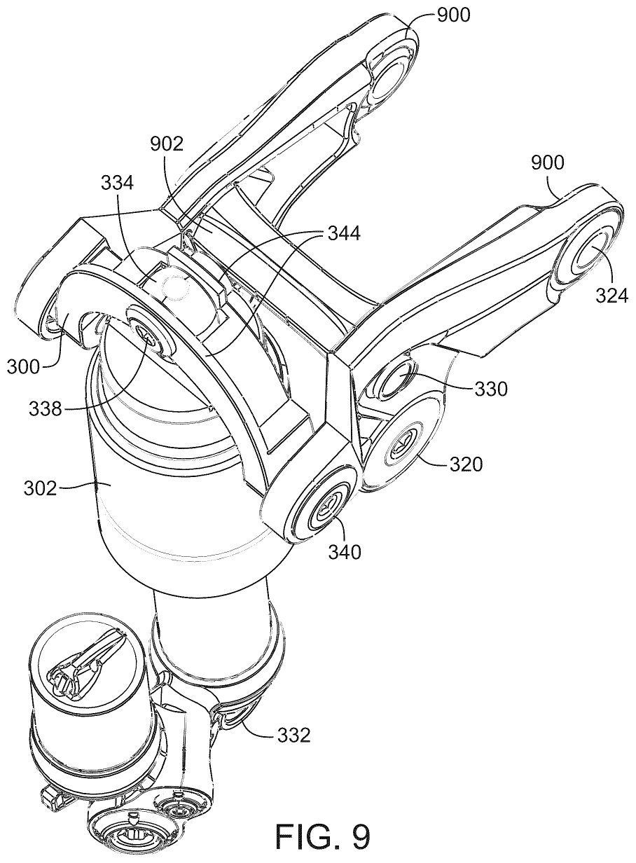

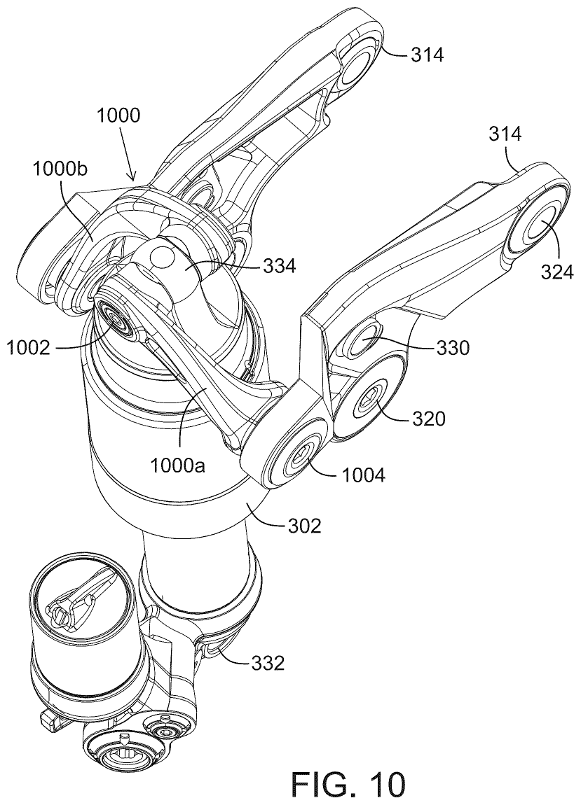

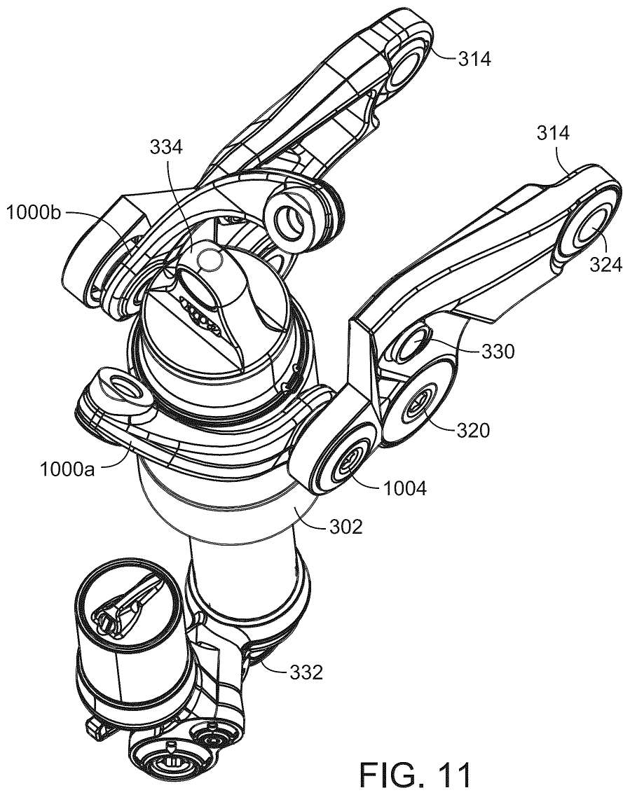

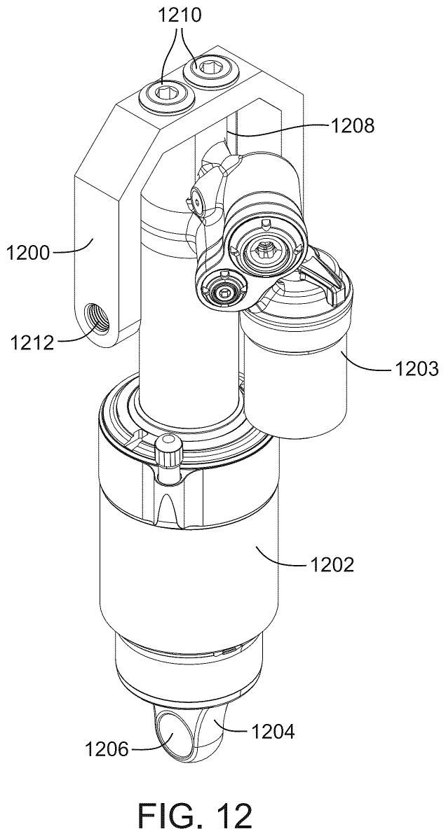

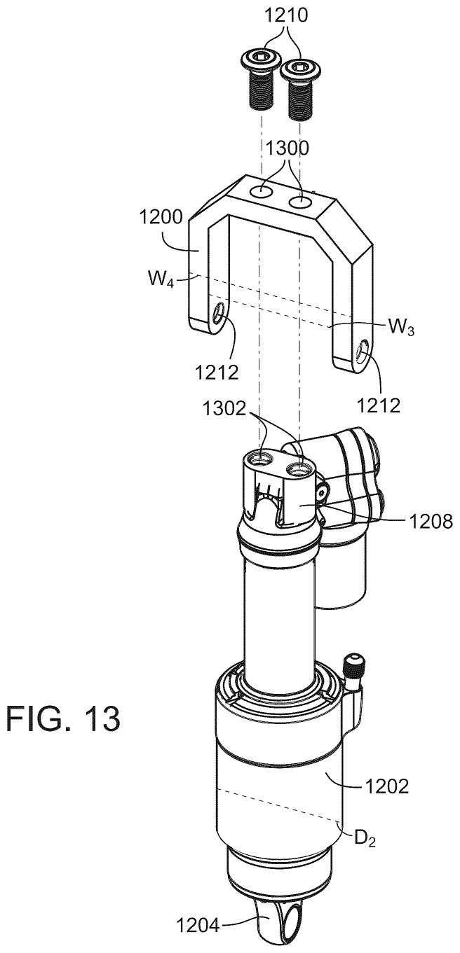

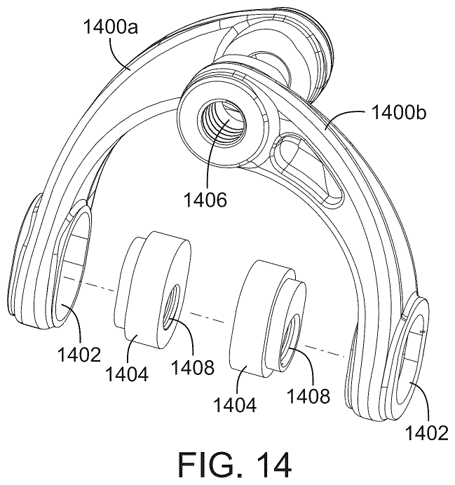

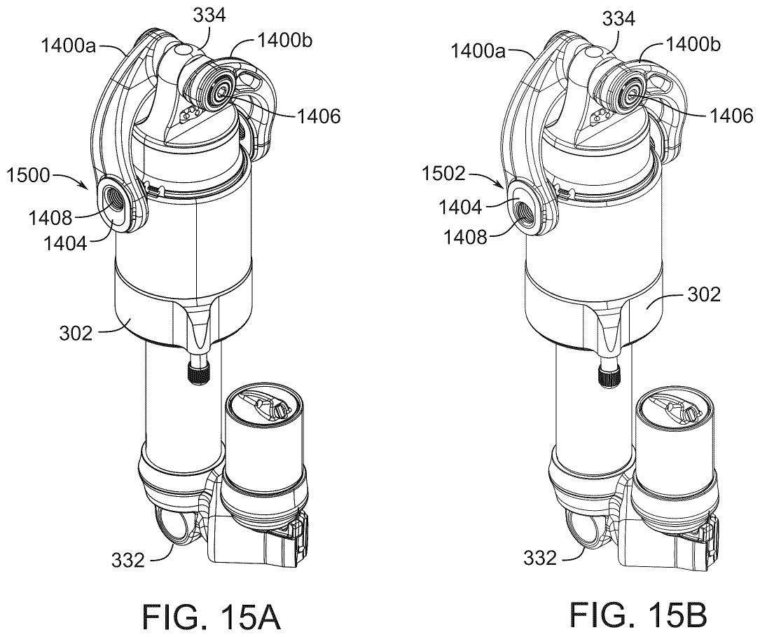

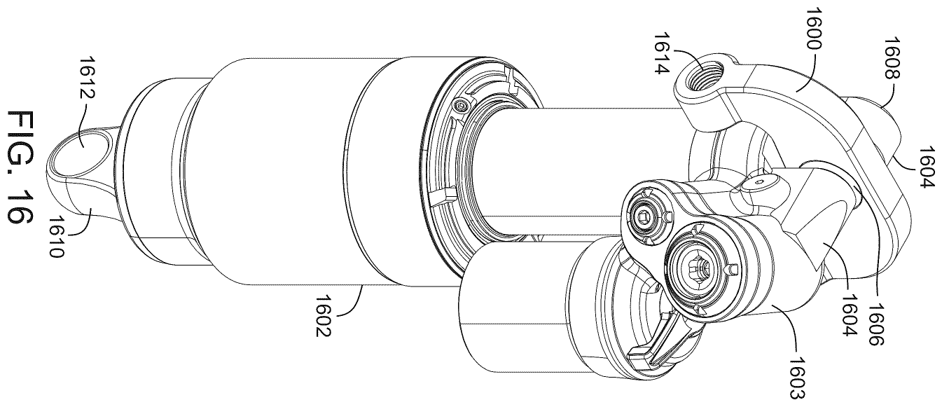

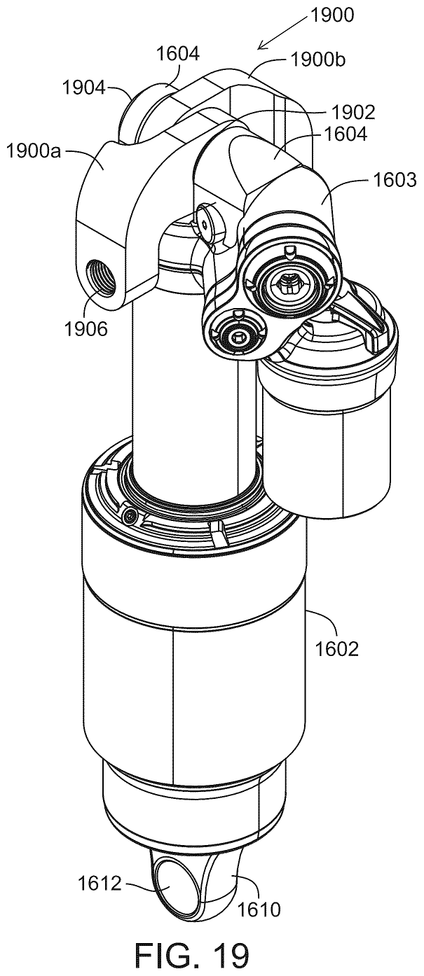

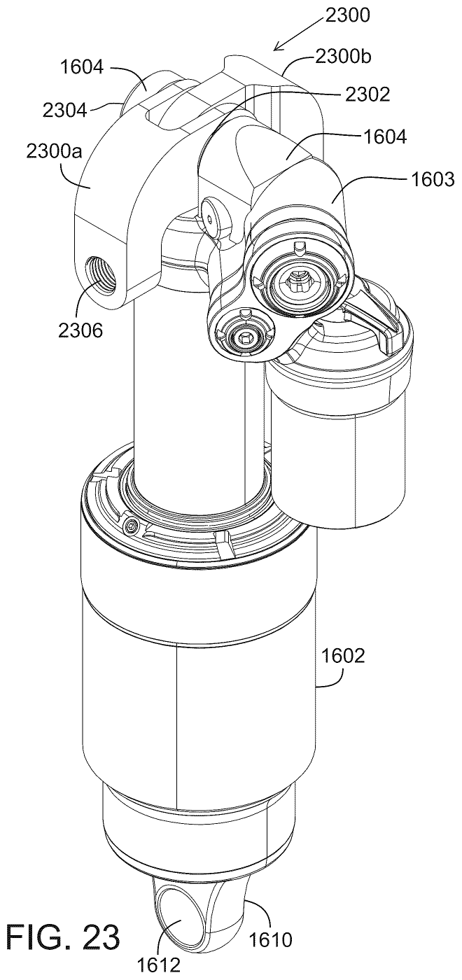

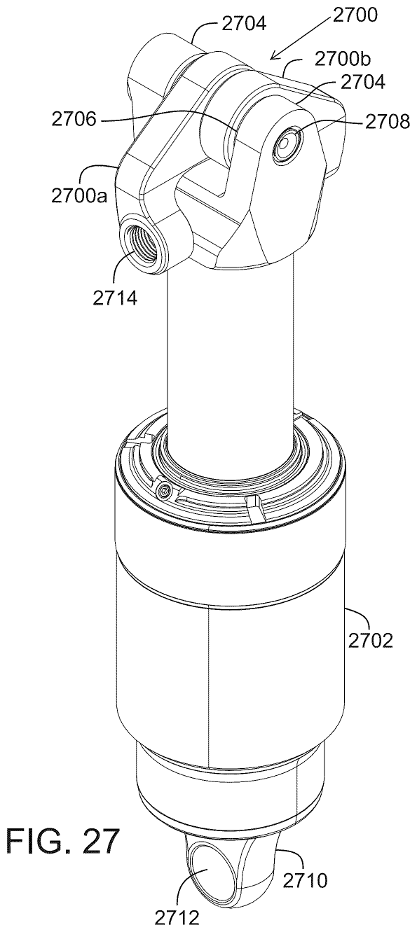

Throughout the present disclosure, reference may be made to a reducer body, which may be mounted on a suspension resistance device (e.g., a shock) to reduce the primary mounting length of the shock. The mounting length of the shock reduced by the reducer body can be referred to as an effective mounting length. FIGS. 3A through 7D illustrate a first example of a reducer body 300 that can be used with a suspension linkage 304 for a two-wheeled vehicle (e.g., a bicycle 301). In this example, the reducer body 300 includes a main body, which is a single component that may be pivotally connected to a shock 302. FIG. 9 illustrates the reducer body 300 mounted to an upper link 900 for a suspension linkage that includes a bridge 902 between two portions of the upper link 900. FIGS. 10 and 11 illustrate an example of a reducer body 1000 that can be used with a suspension system for a two-wheeled vehicle, where the reducer body 1000 includes a main body, which includes at least two components, first and second reducer bodies 1000a, 1000b, that may be pivotally connected to a shock 302. FIGS. 12 and 13 illustrate an example of a reducer body 1200 that can be used with a suspension system for a two-wheeled vehicle, where the reducer body 1200 includes a main body, which is a single component that may be rigidly connected to a shock 1202. FIGS. 14 through 15B show a further aspect applicable to any of the examples of reducer bodies in which a flip chip or adjustable insert 1404 may be used on a reducer body 1400 to modify a reduction length of the reducer body 1400. This can be used to modify a geometry of a suspension system between two or more configurations 1500, 1502 depending on the orientation of the adjustable insert 1404. FIGS. 16 through 18 show an example of a reducer body 1600 that includes a single-component main body mounted between mounting tabs 1604 of a shock 1602. FIGS. 19 through 22 show an example of a reducer body 1900 that includes a main body with two components 1900a, 1900b mounted between mounting tabs 1604 of a shock 1602. FIGS. 23 through 26 show an example of a reducer body 2300 that includes a main body with two components 2300a, 2300b mounted between mounting tabs 1604 of a shock 1602. FIGS. 27 through 30 show an example of a reducer body 2700 that includes a main body with two components 2700a, 2700b mounted between mounting tabs 2704 of an in-line shock 2702.

The reducer bodies, also referred to as positioning brackets, reducing bodies, reduction brackets, instenders, and the like, can include a body portion that may be elongated. The reducer bodies can define at least two connection features positioned at different places along the length of the body portion such that a distance may be defined between the at least two connection features. This distance may be referred to as a “reduction length.” The distance can be measured in a direction parallel to a longitudinal axis of a shock, or parallel to a mounting length of the shock.

The connection features may be defined by a structure or structures that facilitate rigid or movable connections (such as, for example, pivotal connections) with another object. For instance, a connection feature may be formed by an aperture (threaded or unthreaded, and with or without bearings or bushings), pins, rods, hooks, or the like, and may or may not require separate fasteners or other additional structure or components. Each connection feature may include one connection feature or more than one connection features. For example, one connection feature may include a single “first” connection feature, while another connection feature may include more than one “second” connection features. The first connection feature, as noted above, may be spaced apart from the second connection feature by a distance (e.g., the reduction length).

The body portions of the reducer bodies may be made of one or more components. In examples in which reducer bodies include more than one component, the components may be at least two components rigidly secured together to act as an integral part. There may be no relative motion between some or any of the components of the reducer bodies. Alternatively, the components of the reducer bodies may be at least two components integrated together to act as an assembly. Where the components are integrated together, there may or may not be relative motion between all, some or any of the components. The components may be assembled together with other components of the reducer body or may be assembled together in a configuration where other structure may be encompassed with or coupled to the components. In some examples in which a reducer body includes two or more components, the components of the reducer body can be pivotally coupled to one another and installing the reducer body on a shock and/or a suspension linkage or other suspension system can cause the components of the reducer body to be rigidly secured together to act as an integral part. Providing reducer bodies that include various bearings and one or more components can be used to provide for greater tolerances between the reducer bodies, shocks to which the reducer bodies are mounted, and suspension linkages to which the reducer bodies are mounted.

### Reducer Body—Example 1

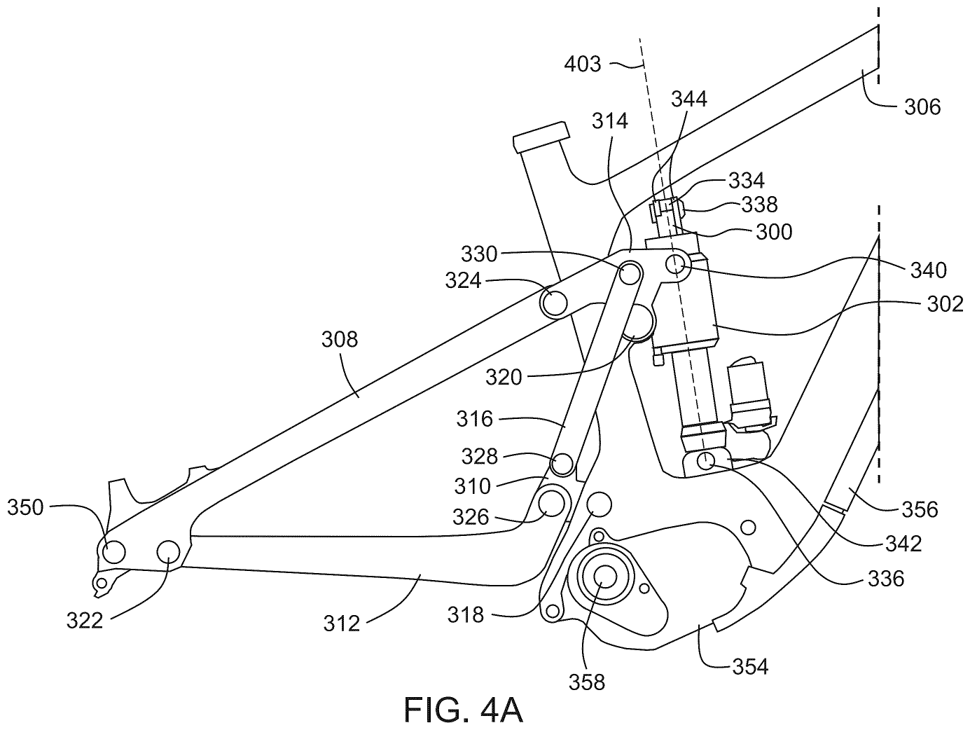

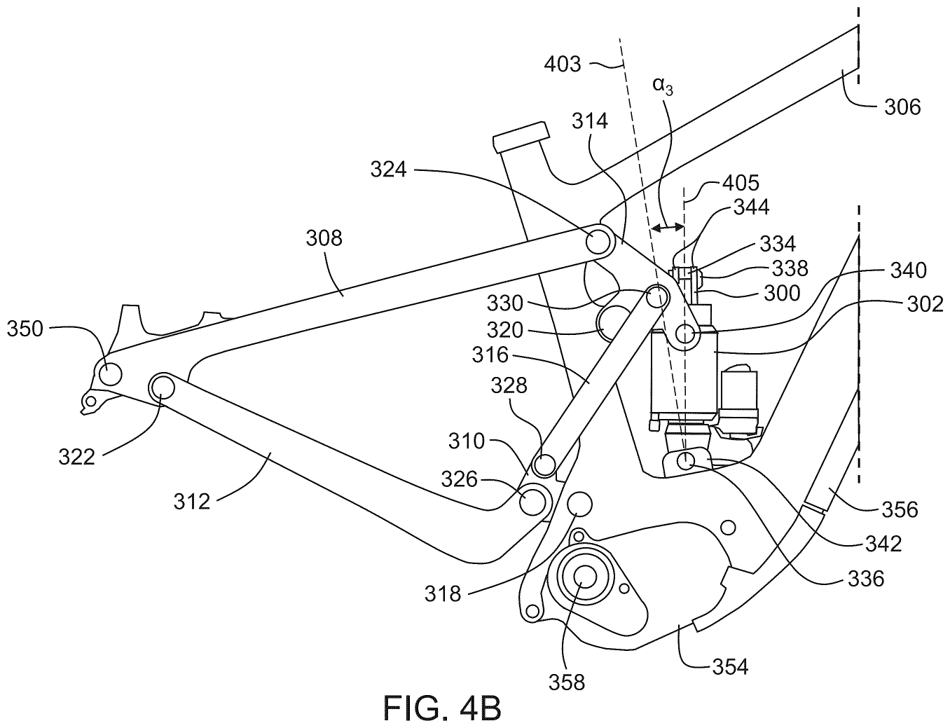

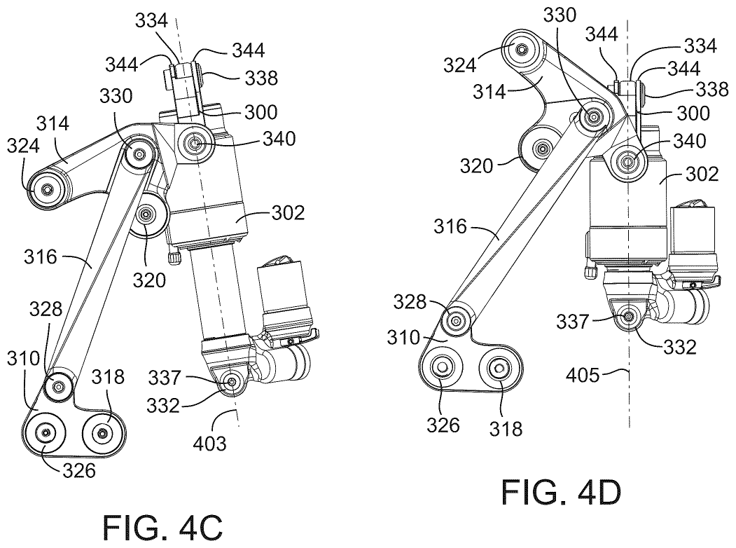

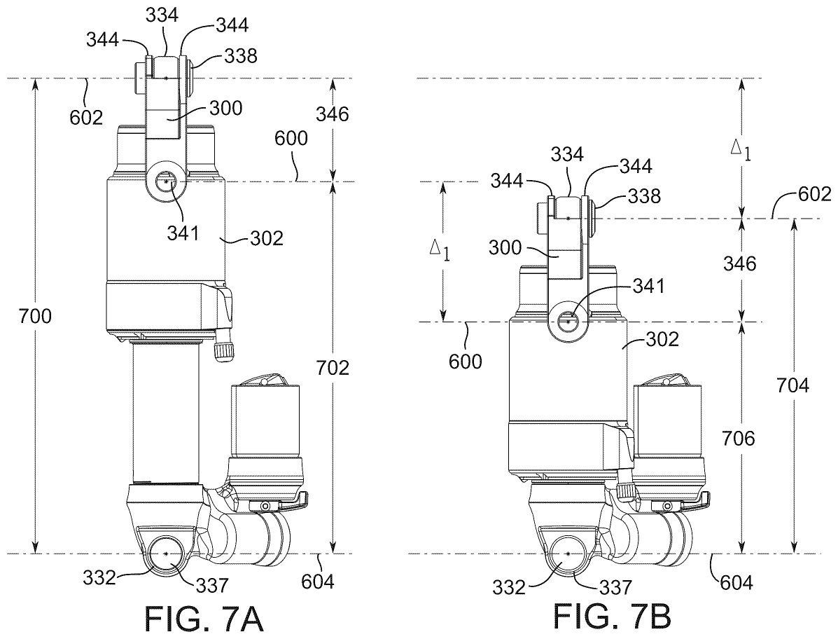

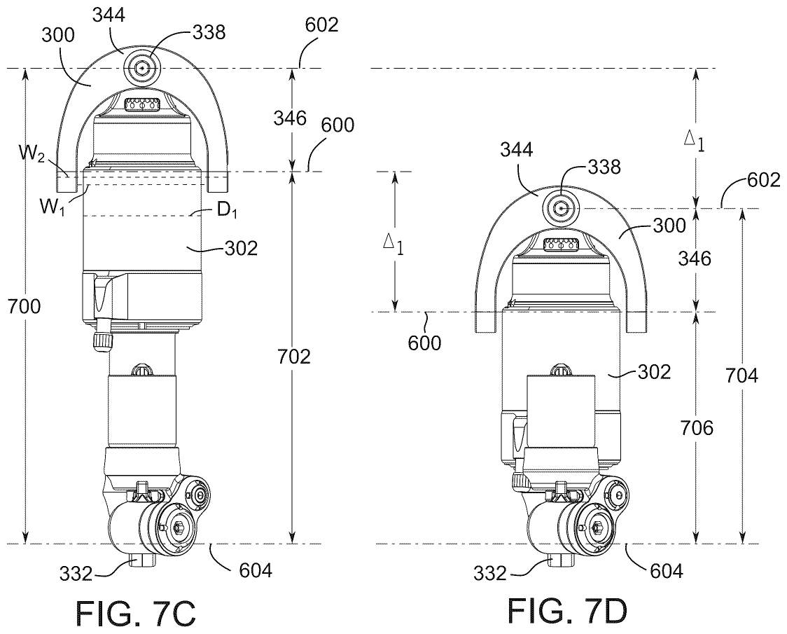

FIGS. 3A through 7D show various views of an example of a bicycle 301 that includes a reducer body 300 operatively coupling a shock 302 to a suspension linkage 304. In this example, the bicycle 301 includes a suspended body 306 and a rear linkage for supporting a driven wheel 351. The suspended body 306 and the rear linkage can collectively form the suspension linkage 304. In this example, the bicycle 301 may be an e-bicycle, which may include a drive unit 354, including a motor and gearbox, as well as a battery 356 integrated into a downtube of the suspended body 306. The shock 302 can be an example of a suspension resistance device. The shock 302 may be coupled at one end to the suspended body 306 and may be coupled at its other end to the rear linkage, such as through the reducer body 300. The suspension linkage 304 may made up of a plurality of links or linkage bodies that control the relative motion between the rear linkage and the suspended body 306 as the rear linkage and the shock 302 move between an extended or uncompressed state (illustrated in FIGS. 3A, 3B, 4A, 4C, 5, 6, 7A, and 7C) and a compressed state (illustrated in FIGS. 4B, 4D, 7B, and 7D).

The reducer body 300 can reduce a primary mounting length of the shock 302 by a reduction length 346 to an effective mounting length. Reducing the mounting length of the shock 302 can provide several improvements to the suspension linkage 304. For example, by decreasing the mounting length of the shock 302, a design envelope of the shock 302 is reduced and the shock 302 takes up less space in the suspension linkage 304 (e.g., in a direction parallel to a longitudinal axis of the shock). This allows designers greater flexibility in the positioning of the shock 302 and other components of the suspension linkage 304. This can allow additional components (e.g., electric or other drive components, tools, water bottles, and the like) to be integrated into the suspension linkage 304, such as within the suspended body 306 of the suspension linkage 304, without interfering with the shock 302. As illustrated in FIGS. 3A through 4B, a vertical position of the shock 302 can be raised vertically by coupling the shock 302 to an extension 342 on the suspended body 306. The vertical position of the shock 302 can also or alternatively be raised by positioning additional components of the bicycle 301 below the shock 302 (e.g., the drive unit 354, other drive components, or the like), by raising lower portions of the suspended body 306 (e.g., to provide increased ground clearance or the like), or the like. As will be discussed in greater detail with respect to FIG. 8, below, by utilizing the reducer body 300, a desirable leverage rate curve can be achieved by the shock 302 and the suspension linkage 304, even when the vertical position of the shock is raised relative to the suspension linkage 304. Reducer bodies 300 with different reduction lengths 346 or reducer bodies with adjustable reduction lengths can be used with shocks 302 having standard mounting lengths in order to provide custom effective mounting lengths for the shocks 302, to tune leverage rate curves of the shocks 302 with the suspension linkage 304, and the like. Additional examples of reducer bodies are discussed below with respect to FIGS. 9 through 30 and all of the reducer bodies can be associated with the described benefits of the reducer body 300.

The suspension linkage 304 can include six linkage bodies: a suspended body 306, a seatstay 308, a lower link 310, a chainstay 312, an upper link 314, and a center link 316. The components of the suspension linkage 304 other than the suspended body 306 (e.g., the seatstay 308, the lower link 310, the chainstay 312, the upper link 314, and the center link 316) can be collectively referred to as the rear linkage or a rear frame. In some examples, the term “rear frame” can refer to specific bodies of the suspension linkage 304, such as the seatstay 308 and the chainstay 312, and the term “suspension linkage” can refer to a remainder of the bodies of the suspension linkage 304, such as the upper link 314, the center link 316, and the lower link 310. The upper link 314 can be referred to as a rocker link and the center link 316 can be referred to as a tie link. The suspension linkage 304 illustrated in the example FIGS. 3A through 7D includes six linkage bodies and is an example of a 6-bar linkage.

The linkage bodies can include flexible joints, pivots, jointed connections, or the like that can operatively couple the linkage bodies to one another. The flexible joints/pivots/jointed connections can include revolute, slider, cam joints, or any other suitable flexible joints or pivots that allow one degree of freedom of movement between two linkage bodies they connect. The suspension linkage 304 can include seven physical instantaneous velocity centers (IVCs), which are illustrated as pivots or jointed connections between the six linkage bodies of the suspension linkage 304. The physical IVCs include an IVC[306][310] 318, an IVC[306][314] 320, an IVC[308][312] 322, an IVC[308][314] 324, an IVC[310][312] 326, an IVC[310] 1[316] 328, and an IVC[314][316] 330. Additional hidden IVCs between each of the linkage bodies of the suspension linkage 304 can be numerically solved for. A total number of IVCs for the suspension linkage 304 can be 15, which includes both physical IVCs and hidden IVCs.

The configuration of the general two-wheeled vehicle components (e.g., the components of the bicycle 301), including the general coupling of the shock 302 and the reducer body 300 to the suspension linkage 304 illustrated in FIGS. 3A through 5, may be used throughout this description. However, the present disclosure is not intended to limit the attachment configuration of the shock 302 and the reducer body 300. Rather, the shock 302 and the reducer body 300 may be coupled, such as by direct or indirect connection between any two members or linkage bodies (e.g., the rear linkage, the suspended body 306, the suspension linkage 304, or between individual links or linkage bodies in the suspension linkage 304) that move relative to each other during movement of the rear linkage relative to the suspended body 306.

The shock 302 can include a lower eyelet 332 (also referred to as a mount) and an upper eyelet 334. The lower eyelet 332 can be coupled to the suspended body 306 at a joint 336. The upper eyelet 334 can be coupled to the reducer body 300 through a joint 338. The reducer body 300 can be coupled to the upper link 314 at a joint 340. The shock 302 is illustrated as including two eyelets and is an example of a standard shock; however, the reducer body 300 can be applied to shocks with one or more trunnion mounts. For example, the reducer body 300 can be coupled to an eyelet or a trunnion mount of a trunnion shock. The shock 302 is further illustrated as including a piggyback 303; however, the reducer body 300 can be applied to in-line shocks. The reducer body 300 is illustrated as being coupled to the upper eyelet 334 opposite a the piggyback 303 of the shock 302. However, the position of the shock 302 can be flipped such that the reducer body 300 is coupled to an upper eyelet of the shock adjacent to the piggyback 303. Further, in some examples, the positions of the shock 302 and the reducer body 300 can be flipped such that an upper eyelet of the shock 302 is coupled to the upper link 314, a lower eyelet of the shock 302 is coupled to the reducer body 300, and the reducer body 300 is coupled to the suspended body 306.

The suspended body 306 can include an extension 342, which can be used to fasten the shock 302 to the suspended body 306. The extension 342 can be used to raise a position of the shock 302 in a vertical direction (e.g., relative to ground). In some examples, the extension 342 can be omitted, and the shock 302 can be fastened to a portion of the suspended body 306 below the extension 342. In some examples, the extension 342 can be omitted, portions of the suspended body 306 can be raised vertically (e.g., to provide increased ground clearance for the suspended body 306, as a result of components, such as drive components of the bicycle 301 being provided in the suspended body 306 below the shock 302, or the like), and the shock 302 can be directly mounted or fastened to the suspended body 306. The threads in the extension 342 of the suspended body 306 can be floating and/or a spherical or heim joint can be used to allow for misalignment between the shock 302 and the suspended body 306.

The suspension linkage 304 can actuate the shock 302 as the rear linkage moves between an extended or uncompressed state (illustrated in FIGS. 3A, 3B, 4A, 4C, 5, 6, 7A, and 7C) and a compressed state (illustrated in FIGS. 4B, 4D, 7B, and 7D). FIGS. 4A through 4D specifically illustrate how the linkage bodies of the suspension linkage 304 move as the suspension linkage 304 and the shock 302 move between the extended state (illustrated in FIGS. 4A and 4C) and the compressed state (illustrated in FIGS. 4B and 4D). The angle as illustrated in FIG. 4B shows the angular movement of a longitudinal axis of the shock 302 from the extended state, indicated as axis 403, to the compressed state, indicated as axis 405.

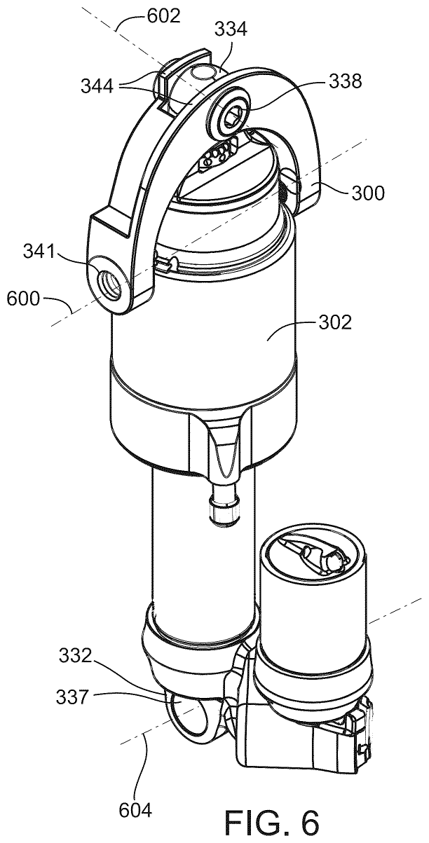

The shock 302 can be mounted to the suspended body 306 with the lower eyelet 332 between mounting tabs of the extension 342. A fastener can be inserted through a first of the mounting tabs of the extension 342, through the lower eyelet 332 of the shock 302, and screwed into threads in a second of the mounting tabs of the extension 342. The fastener can define a pivot axis 604 (illustrated in FIG. 6) of the joint 336. The fastener can extend through a lower opening 337 in the lower eyelet 332, and the pivot axis 604 can be defined within the lower opening 337. Bearings (e.g., bushings, planar bearings, spherical bearings, or other bearings) can be provided to facilitate relative movement between the shock 302 and the suspended body 306, such as being provided within the extension 342 and/or within the lower opening 337 in the lower eyelet 332.

The reducer body 300 can include mounting tabs 344, which are used to fasten the reducer body 300 to the shock 302. The shock 302 can be mounted to the reducer body 300 with the upper eyelet 334 between the mounting tabs 344 of the reducer body 300. A fastener can be inserted through a first of the mounting tabs 344 of the reducer body 300, through the upper eyelet 334 of the shock 302, and screwed into threads in a second of the mounting tabs 344 of the reducer body 300. The fastener can define a pivot axis 602 (illustrated in FIG. 6) of the joint 338. The fastener can extend through an upper opening in the upper eyelet 334, and the pivot axis 602 can be defined within the upper opening. Bearings (e.g., bushings, planar bearings, spherical bearings, or other bearings) can be provided to facilitate relative movement between the shock 302 and the reducer body 300, such as being provided within the mounting tabs 344 and/or within the upper opening in the upper eyelet 334. In some examples, the threads in the second of the mounting tabs 344 of the reducer body 300 can be floating and/or a spherical or heim joint can be used to allow for misalignment between the reducer body 300 (mounted to the upper link 314) and the shock 302 (mounted to the suspended body 306).

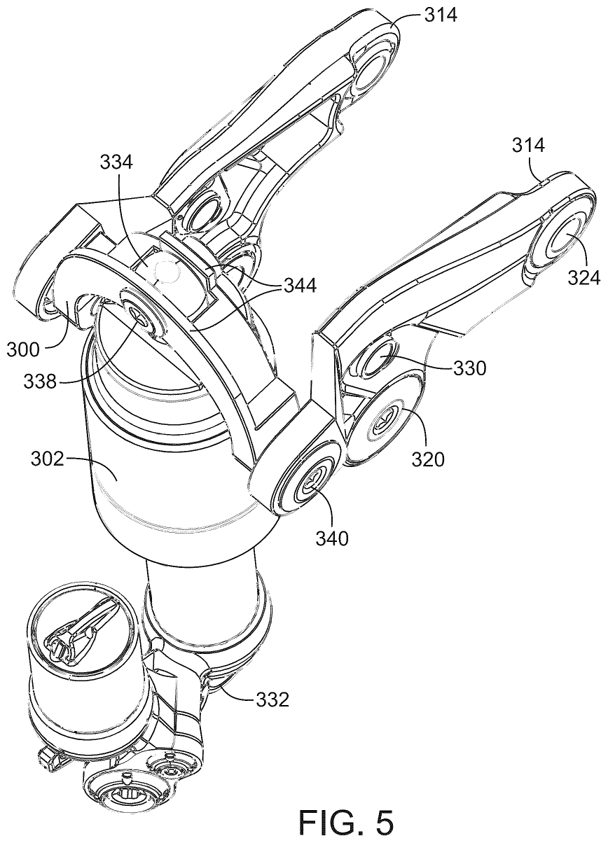

The upper link 314 can include openings in which bearings (e.g., bushings, planar bearings, spherical bearings, or other bearings) can be disposed, which are used to fasten the reducer body 300 to the upper link 314. The reducer body 300 can be mounted to the upper link 314 between two bodies of the upper link 314, as illustrated in FIGS. 3B and 5. Fasteners can be inserted through the bearings in the upper link 314 and screwed into threaded openings 341 in the reducer body 300 at the joints 340. The fasteners can define pivot axes 600 (illustrated in FIG. 6) of the joints 340. Specifically, the pivot axes 600 can be defined within the openings 341.

One example of the reducer body 300 is shown in the example of FIGS. 3A through 7D. Referring at least to FIGS. 7A through 7D, this example of the reducer body 300 includes a body portion that may be curved, with one connection feature positioned at a midpoint of the curved body (e.g., an upper connection feature). In this example the upper connection feature may be an aperture defining an axis (e.g., the pivot axis 602). In this example, the body portion may a single or unitary component. A first lower connection feature may be positioned at one end of the curved body portion. A second lower connection feature may be positioned at the opposite end of the curved body portion. In one example, the body portion may be a single member or component having a U-shape (e.g., in a rear or front view, as illustrated in FIGS. 7C and 7D), with the upper connection feature at the base of the U-shape, and the lower connection features at the ends of the opposing legs of the U-shape. The lower connection features may be defined by at least two connection features (as described above). Each of the lower connection features may be an aperture defining an axis (e.g., the pivot axes 600), with each axis being nonparallel to the axis of the upper connection feature. The lower connection features may be threaded. The U-shaped main body portion may have a fixed radius, may be oblong (with a varying radius), may be rectilinear, or may be a combination of any or all of these or other shapes.

In this example, a reduction length 346 of the reducer body 300 may be defined by a rectilinear distance between the upper connection feature and the lower connection features. The reduction length 346 may be defined in a direction parallel to a longitudinal axis of the shock 302, parallel to a mounting length of the shock 302, and perpendicular to pivot axes of the upper and lower connection features of the reducer body 300. The reducer body 300 may be mounted (e.g., by a pivot joint, such as the joint 338) on the shock 302, which can include first and second mounting features (e.g., the eyelets 332, 334) located at opposing ends of the shock 302. The reducer body 300 may be mounted to the second mounting feature, which may be the upper eyelet 334 protruding from an end surface of the shock 302. The upper eyelet 334 defines an aperture (e.g., the upper opening) defining an axis (e.g., the pivot axis 602). The first mounting feature on the shock 302 may be positioned at the opposite end of the shock 302 and may be the lower eyelet 332 protruding from the opposite end surface. The lower eyelet 332 also defines an aperture (e.g., the lower opening 337) defining an axis (e.g., the pivot axis 604). The axis of the lower eyelet 332 of the first mounting feature may be nonparallel to the axis of the upper eyelet 334 of the second mounting feature. In this example, the axes are nonparallel by being clocked by 90 degrees.

The suspension linkage 304 can include a driven wheel axis 350 and a driven wheel 351 can be operatively coupled to the suspension linkage 304 at the driven wheel axis 350. Although the driven wheel axis 350 is illustrated as being on the seatstay 308, the driven wheel axis 350 can be on the chainstay 312 or another body of the suspension linkage 304. In other words, the seatstay 308, the chainstay 312, or another body of the suspension linkage 304 can be a wheel carrier body. A brake caliper mount 352 can be included on the seatstay 308 and can interface with a rotor on the drivel wheel 351 to provide stopping forces to the bicycle 301. Although the brake caliper mount 352 is illustrated as being on the seatstay 308, the brake caliper mount 352 can be on the chainstay 312 or another body of the suspension linkage 304. In other words, the seatstay 308, the chainstay 312, or another body of the suspension linkage 304 can be a brake carrier body. The wheel carrier body and the brake carrier body can be the same or different linkage bodies of the suspension linkage 304.

The bicycle 301 is illustrated in the context of an e-bicycle, which can include a drive unit 354 and a battery 356. The drive unit 354 can include a motor, a gearbox, and the like. The battery 356 can power the drive unit 354 and can be integrated in a downtube of the suspended body 306. The drive unit 354 can include a crank interface 358 to allow a crank 360 and/or a driving cog 362 to be coupled to the drive unit 354. The bicycle 301 can include pedals 364 attached to the crank 360 that enable the bicycle 301 to be power at least in part by a rider's legs. Power from the rider's legs and/or the drive unit 354 can be transferred to the crank 360, which can transfer the power to the driving cog 362. A chain or belt 365 can be included to transfer power from the driving cog 362 to a driven cog of the driven wheel 351. The seatstay 308 (or the chainstay 312 or another body of the suspension linkage 304) can include a derailleur hanger 366 to which a derailleur 368 can be coupled. The derailleur 368 can move the chain or belt 365 between driven cogs on the driven wheel 351 in order to adjust a gear ratio between the driving cog 362 and the driven wheel 351.

A front wheel 370 can be coupled to the suspended body 306 through a front fork 372. The front fork 372 can be a telescoping, linkage, or other suspension fork, which can allow for desired movement between the front wheel 370 and the suspended body 306. Handlebars 374 can be coupled to the front fork 372 through a stem 376 and can allow a rider of the bicycle 301 to turn or rotate the front fork 372 and the front wheel 370. A seat post clamp 378 can be coupled to the suspended body 306. A seat 380 can be coupled to a seat tube of the suspended body 306 through a seat post 382 and the seat post clamp 378. A rider's weight can be supported on the bicycle through combinations of the pedals 364, the handlebars 374, and/or the seat 380. The driven wheel 351 and the front wheel 370 can contact the ground and the suspended body 306 can be coupled to the driven wheel 351 and the front wheel 370 through the suspension linkage 304 (e.g., the seatstay 308, the lower link 310, the chainstay 312, the upper link 314, and the center link 316) and the front fork 372, respectively. The shock 302 and the front fork 372 can resist movement of the driven wheel 351 and the front wheel 370, respectively, relative to the suspended body 306 caused by contact with the ground and the like.

FIG. 6 illustrates a perspective view of the reducer body 300 and the shock 302. FIG. 6 shows pivot axes of the reducer body 300 and the shock 302. As illustrated in FIG. 6, pivot axes 600 can extend through the reducer body 300 at the joints 340. The pivot axes 600 can be defined at fasteners that fasten the reducer body 300 to the upper link 314 (illustrated in FIGS. 3A through 5). A pivot axis 602 can extend through the mounting tabs 344 of the reducer body 300 and the upper eyelet 334 of the shock 302 at the joint 338. The pivot axis 602 can be defined by a fastener that fastens the reducer body 300 to the shock 302. A pivot axis 604 can extend through the lower eyelet 332 of the shock 302 at the joint 336. The pivot axis 604 can be perpendicular or otherwise nonparallel (e.g., clocked) to the pivot axis 602 and parallel to the pivot axes 600. The pivot axis 604 can be defined by a fastener that fastens the shock 302 to the suspended body 306 (illustrated in FIGS. 3A through 4B).

The pivot axis 602 (e.g., at the joint 338) may be nonparallel with the pivot axes 600 (e.g., at the joints 340) and the pivot axis 604 (e.g., at the joint 336). In one example, the pivot axis 602 is clocked about 90 degrees nonparallel relative to the pivot axes 600 and the pivot axis 604. However, the pivot axis 602 can be clocked or otherwise nonparallel relative to the pivot axes 600 and the pivot axis 604 by any suitable angle. Providing pivotal connections at the pivot axes 600, 602, 604 and clocking the pivot axis 602 relative to the pivot axes 600, 604 allows for relative motion between the reducer body 300, the shock 302, and a suspension linkage as the reducer body 300 and the shock 302 are being mounted on the suspension linkage, but provides a rigid, non-rotating connection between the pivot axes 600, 602, 604 when the reducer body 300 and the shock 302 are mounted on the suspension linkage. In other words, the shock 302 and the reducer body 300 can be constrained in a rigid non-rotating connection with one another when the shock 302 and the reducer body 300 are mounted to a suspension linkage.

FIGS. 7A through 7D illustrate side views of the reducer body 300 and the shock 302 in extended and compressed states. Specifically, FIGS. 7A and 7C illustrate views of the reducer body 300 and the shock 302 in the extended state and FIGS. 7B and 7D illustrate views of the reducer body 300 and the shock 302 in the compressed state. A distance between the pivot axis 602 extending through the mounting tabs 344 of the reducer body 300 and the upper eyelet 334 of the shock 302 at the joint 338 and the pivot axis 604 extending through the lower eyelet 332 of the shock 302 at the joint 336 in the extended state is referred to as a primary mounting length 700 of the shock 302. The reducer body 300 reduces the mounting length of the shock 302 by the reduction length 346 such that the shock 302 and the reducer body 300 have an effective mounting length 702. When the shock 302 is compressed from the extended state to the compressed state, the primary mounting length 700 is reduced to a compressed (or secondary) mounting length 704 by a shock stroke Δ₁. The effective mounting length 702 is also reduced to a compressed (or secondary) effective mounting length 706 by the shock stroke Δ₁. The reducer body 300 reduces the compressed mounting length 704 by the same reduction length 346 such that the shock 302 has the compressed effective mounting length 706 in the compressed state.

FIGS. 7A through 7D illustrate dimensional changes in the shock 302 as the shock 302 transitions between an extended state (illustrated in FIGS. 7A and 7C) and a compressed state (illustrated in FIGS. 7B and 7D). In the extended state, the shock 302 has a mounting length 700 and a reduced effective mounting length 702 based on the reduction length 346 provided by the reducer body 300. In the compressed state, the same shock 302 has a compressed mounting length 704 and a reduced compressed effective mounting length 706 based on the reduction length 346 provided by the reducer body 300. The shock 302 has a shock stroke Δ₁, illustrated as the shock 302 transitions between the extended state of FIGS. 7A and 7C and the compressed state of FIGS. 7B and 7D.

The effective mounting length 702 of the shock 302 in the extended state reduced by the reducing body 300 may be determined by the following equation:

effective mounting length 702=mounting length 700−reduction length 346

The compressed effective mounting length 704 of the shock 302 in the compressed state because reduced by the reducing body 300 may be determined by the following equation:

compressed effective mounting length 706=compressed mounting length 704−reduction length 346

The shock stroke Δ₁ of the shock 302 may be determined by either of the following equations:

shock stroke 1=mounting length 700−compressed mounting length 704

Or

shock stroke Δ1=effective mounting length 702−compressed effective mounting length 706

The effective mounting length of a standard shock (e.g., the shock 302) or a trunnion shock may be reduced by attaching the reducer body 300 (or another reducer body, discussed herein) between the shock 302 and a suspension linkage (e.g., the suspension linkage 304). Additionally, by clocking the eyelet (e.g., the upper eyelet 334) or trunnion mount axis that accepts the reducer body 300 relative to the opposite eyelet (e.g., the lower eyelet 332) or trunnion mount so that the mount axes are nonparallel, the axes of the reducer body 300 (e.g., the joints 340) and the opposite eyelet or trunnion mount may be parallel and the reducer body 300 and the shock 302 may form a rigid body.

In the example illustrated in FIGS. 3A through 7D, the reducer body 300 is mounted to a body end of the shock 302 opposite a shaft end of the shock 302. The reducer body 300 can have a reduction length that prevents interference between the reducer body 300 and the body portion of the shock 302. The reducer body 300 can have an inner width W₁ and an outer width W₂ greater than a diameter D₁ of the body portion of the shock 302. In some examples, the orientation of the shock 302 can be flipped, such that the reducer body is mounted to a shaft end of the shock 302. In these examples, the inner width W₁ and even the outer width W₂ can be less than the diameter D₁ of the body portion of the shock 302. This can allow for the reducer body 300 to have a relatively narrow width. Thus, the reducer body 300 and the shock 302 can be provided with a reduced design envelope. The reducer body 300 can have a greater reduction length such that the reducer body 300 at least partially overlaps the body portion of the shock 302 in the compressed and/or extended state. In such examples, the inner width W₁ of the reducer body 300 can be greater than the diameter D₁ of the body portion of the shock 302 in order to avoid interference between the reducer body 300 and the shock 302.

FIG. 8 illustrates leverage rate curves for the suspension linkages of the examples of FIGS. 1A through 7D. Specifically, FIG. 8 illustrates a leverage rate curve 800 for the example of FIGS. 1A and 1B, a leverage rate curve 802 for the example of FIGS. 3A through 7D, and a leverage rate curve 804 for the example of FIGS. 2A and 2B.

The suspension linkage 104 of the example of FIGS. 1A and 1B results in the leverage rate curve 800 (illustrated as a solid line), as shown in FIG. 8. The leverage rate curve 800 of the suspension linkage 104 of the example of FIGS. 1A and 1, for the purposes of the present disclosure, is a desired leverage rate curve. The leverage rate curve 800 can be provided for showing the benefit of the reducer bodies disclosed herein. The leverage rate curve 800 may be one of many possible desirable leverage rate curves.

The leverage rate curve 802 (illustrated as a dashed line) may be created by using the reducer body 300. In other words, the leverage rate curve 802 is a leverage rate curve for the suspension linkage 304 of FIGS. 3A through 7D. The leverage rate curve 802 can be a result of how the angle as changes as the suspension linkage 304 moves between the extended state and the compressed state. As illustrated in FIG. 8, the leverage rate curve 802 closely follows the leverage rate curve 800 (e.g., a desired leverage rate curve). The reducer body 300 allows a position of the shock 302 to be raised vertically relative to the suspended body 306 (e.g., the front frame) and the suspension linkage 304, while still providing the suspension linkage 304 with a desired leverage rate curve. The reducer body 300 shortens the mounting length of the shock 302, which is used to offset the raised position of the shock 302. Mounting the shock 302 to a suspension linkage using the reducer body 300 gives designers greater freedom in the mounting position of the shock 302. Moreover, different reducer bodies with different reduction lengths can be used in order to specifically tune the mounting position of the shock 302 and the leverage rate curve of a suspension linkage.

The leverage rate curve 804 (illustrated as a dot-dashed line) of the suspension linkage 204 of the example of FIGS. 2A and 2B trends down steeply and falls off significantly from the leverage rate curve 800. This is caused by having a position of the shock 202 raised vertically relative to the suspended body 206 and the suspension linkage 204 by use of a bottom riser mount or extension 242. An extended upper lobe on the upper link 214, rather than a reducer body, is used to compensate for the raised position of the shock 202. The leverage rate curve 804 may be an undesirable rate curve. The undesirable rate curve 804 can be avoided and a desirable rate curve 802 can be provided by utilizing the reducer body 300 or other reducer bodies disclosed herein.

FIG. 9 illustrates a perspective view of an example in which an upper link 900 includes a bridge 902 between a drive-side body of the upper link 900 and a non-drive-side body of the upper link 900. In other words, the upper link 900 may be a unitary or single-part linkage body, in contrast to the two-part upper links 314 illustrated and discussed above with respect to FIGS. 3A through 7D. The upper link 900 and the upper link 314 may function similarly, and components or bodies thereof can move together in both the example of FIGS. 3A through 7D and the example of FIG. 9. Specifically, both parts of the upper link 314 can move in tandem along the same migration path as the suspension linkage 304 moves between an extended state and a compressed state. Including the bridge 902 in the upper link 900 can add stiffness, strength, and the like to the upper link 900. Reducer bodies, such as the reducer body 300 can act to reduce an effective mounting length of shocks when installed on suspension linkages including single-part or multi-part linkage bodies, or any suspension linkages including any linkage bodies.

### Reducer Body—Example 2—2-Part Reducer Body

FIGS. 10 and 11 illustrate perspective views of an example in which a reducer body 1000 includes a first reducer body 1000a and a second reducer body 1000b. In other words, the reducer body 1000 includes two body portions or components, the reducer bodies 1000a, 1000b. FIG. 10 illustrates a view of the reducer body 1000 mounted on a shock 302 and FIG. 11 illustrates a partially assembled view of the reducer body 1000 and the shock 302. FIGS. 10 and 11 further illustrate the reducer bodies 1000a, 1000b mounted on an upper link 314.

The reducer bodies 1000a, 1000b can be coupled to an upper eyelet 334 of the shock 302 at a joint 1002. Each of the reducer bodies 1000a, 1000b can be coupled to the upper link 314 through joints 1004. The reducer bodies 1000a, 1000b can be coupled to the shock 302 at the joint 1002 and to the upper link 314 at the joints 1004 by any suitable attachment mechanism, such as a fastener that can include a bolt, a machine screw, a pin, a collet axle, or the like. The joints 1004 can be the same as or similar to the joints 340, discussed above with respect to FIGS. 3A through 7D. The example of FIGS. 10 and 11 may be the same or similar to the example of FIGS. 3A through 7D, except that the reducer body 1000 includes two reducer body components, the reducer bodies 1000a, 1000b. The reducer bodies 1000a, 1000b, the shock 302, and/or the upper link 314 can include bearings (e.g., bushings, planar bearings, spherical bearings, or other bearings) that allow for rotation between the reducer bodies 1000a, 1000b and the shock 302 and the upper link 314. For example, the reducer bodies 1000a, 1000b can rotate relative to the upper link 314 in planes perpendicular to axes of the joints 1004. The reducer bodies 1000a, 1000b can rotate relative to the shock 302 in planes perpendicular to the axis of the joint 1002. Providing floating threads for the joints 1002, 1004, or providing spherical bearings in the reducer bodies 1000a, 1000b, the shock 302, and/or the upper link 314 can allow for additional degrees of freedom in the rotation of the reducer bodies 1000a, 1000b relative to the shock 302 and the upper link 314, and can allow for greater degrees of misalignment between the reducer bodies 1000a, 1000b and each of the shock 302 and the upper link 314.

In the example of FIG. 11, the reducer bodies 1000a, 1000b can be mounted to the upper link 314 at the joints 1004 and can then be mounted to the shock 302 at the joint 1002. Using the two reducer bodies 1000a, 1000b mounted on opposite sides of the upper eyelet 334 can provide for greater tolerance in the connection between the reducer bodies 1000a, 1000b and the shock 302. In some examples, the reducer bodies 1000a, 1000b can be mounted to the shock 302 at the joint 10002 and can ben be mounted to the upper link 314 at the joints 1004. This can provide for greater tolerance in the connections between the reducer bodies 1000a, 1000b and the upper link 314.

Each of the two reducer bodies 1000a, 1000b can include a body portion having a slight curve, with a connection feature at each end. The reducer bodies 1000a, 1000b together can form a U-shaped reducer body 1000, and each of the reducer bodies 1000a, 1000b can have a half U-shape. One connection feature may be located at an upper end of each of the two reducer bodies 1000a, 1000b, and the connection features can combine to form a single connection portion when coupled to a mounting feature (e.g., an upper eyelet 334) at the top of the shock 302. This connection portion can be formed at the joint 1002. The upper eyelet 334 in this example may be an aperture in an eyelet that defines an axis. The other connection feature of the respective reducer bodies 1000a, 1000b can include a connection feature at the lower end of each of the two reducer bodies 1000a, 1000b. The connection features at the lower ends in this example may be apertures defining respective axes.

The axis of the top connection feature (e.g., at the joint 1002) may be nonparallel with the axes of the bottom connection feature apertures (e.g., at the joints 1004). In one example, the axes at the joints 1004 are clocked 90 degrees nonparallel relative to the axis at the joint 1002. The upper eyelet 334 at the top of the shock 302, as shown, pivotally engages the top connection feature of each of the reducer bodies 1000a, 1000b at the joint 1002. The top connection features of the reducer bodies 1000a, 1000b are positioned on opposite sides of the upper eyelet 334 of the shock 302. The upper eyelet 334 may be an eyelet protruding above an end surface of the shock 302. The eyelet defines an aperture defining an axis. The other mounting feature of the shock 302, in this example a lower eyelet 332, may be positioned at an opposite end of the shock 302. In this example, the lower eyelet 332 may also be an eyelet protruding from an end surface of the shock 302. The eyelet of the lower eyelet 332 also defines an aperture, which in turn defines an axis. The axis of the eyelet of the upper eyelet 334 may be nonparallel to the axis of the lower eyelet 332. In the example illustrated in FIGS. 10 and 11, the axes of the lower eyelet 332 and the upper eyelet 334 are nonparallel by about 90 degrees.

In this example, a reduction length of the reducer body 1000 may defined by the rectilinear distance between the two connection features (e.g., between the axis of the joint 1002 and the axes of the joints 1004). The reduction length can be measured in a direction parallel to a longitudinal axis of the shock 302. As described in the example discussed with respect to FIGS. 3A through 7D, the reducer body 1000 can reduce the shock length in both the extended and compressed states, without reducing the shock length of the shock 302. The reducer body 1000 can be used to decrease the design envelope of the shock 302 in a suspension linkage, which can provide suspension designers and users with increased flexibility in the positioning of the shock 302 within a suspension linkage.

### Reducer Body—Example 3—Rigid-Mount Reducer Body

FIGS. 12 and 13 illustrate perspective views of an example in which a reducer body 1200 is rigidly coupled to a shock 1202. FIG. 12 illustrates a view of the reducer body 1200 mounted on the shock 1202 and FIG. 13 illustrates an exploded view of the reducer body 1200 and the shock 1202. The reducer body 1200 and the shock 1202 may be similar to the reducer body 300 and the shock 302, discussed above with respect to FIGS. 3A through 7D, except that the reducer body 1200 may not be pivotally attached the shock 302, but instead may be rigidly attached to the shock 1202.

As illustrated in FIGS. 12 and 13, the reducer body 1200 includes a body portion that may be U-shaped. The body portion can be a single member or component. The reducer body 1200 can include a connection feature (e.g., a top connection feature) positioned at a midpoint of the base of the U-shape. In the example of FIGS. 12 and 13, the top connection feature includes two apertures 1300, each defining an axis. The reducer body 1200 can further include connection features (e.g., bottom connection features) positioned at each end of the body portion. Each of the bottom connection features may be an aperture 1212 defining an axis. As illustrated in FIG. 12, the axes defined by the apertures 1300 may be nonparallel to the axes defined by the apertures 1212. The axes defined by the apertures 1300 may be parallel to a longitudinal axis of the shock 1202 and perpendicular to the axes defined by the apertures 1212.

The U-shaped body portion of the reducer body 1200 may have a rectilinear shape with straight portions connected at angles to form the U-shape. A reduction length may be defined by the rectilinear distance between the top and bottom connection features (e.g., between axes of the apertures 1212 and a surface of the reducer body 1200 that abuts the shock 1202). The reduction length can be measured in a direction parallel to a longitudinal axis of the shock 1202. As described in the example discussed with respect to FIGS. 3A through 7D, the reducer body 1200 can reduce the shock length in both the extended and compressed states, without reducing the shock stroke of the shock 1202. The reducer body 1200 can be used to decrease the design envelope of the shock 1202 in a suspension linkage, which can provide suspension designers and users with increased flexibility in the positioning of the shock 1202 within a suspension linkage, can increase space available in the suspension linkage for other components, and the like.

The shock 1202 can include an eyelet 1204 with an opening 1206 that can form a joint with a suspension linkage (e.g., a joint 336 with a suspension linkage 304). The apertures 1212 of the reducer body 1200 can form joints with the suspension linkage (e.g., joints 340 with the suspension linkage 304). Axes of the apertures 1212 and the opening 1206 can be parallel to one another and nonparallel to axes of the apertures 1300. The shock 1202 and the reducer body 1200 can be mounted in a suspension linkage the same as or similar to the shock 302 and the reducer body 300, discussed above in reference to FIGS. 3A through 7D.

The reducer body 1200 can be mounted to the shock 1202 through fasteners 1210. The fasteners 1210 can be bolts, collet axles, or any other suitable fasteners. The fasteners 1210 can extend through the apertures 1300 in the reducer body 1200 and can be screwed into threads in openings 1302 in the shock 1202. The openings 1302 can be disposed in a surface (e.g., a planar surface) of the shock 1202 disposed opposite the eyelet 1204. The surface can extend laterally across the shock 1202. In some examples, the surface that includes the openings 1302 can be disposed at a shaft end of the shock 1202 adjacent to a piggyback 1203 of the shock 1202. However, in some examples, positions of the openings 1302 and the eyelet 1204 can be flipped. For example, the openings 1302 can be formed in a surface of the shock 1202 at a body end of the shock and the eyelet 1204 can be disposed at a shaft end of the shock 1202 adjacent the piggyback 1203.

In the example illustrated in FIGS. 12 and 13, the reducer body 1200 is mounted to a shaft end of the shock 1202 opposite a body end of the shock 1202. The reducer body 1200 can have a reduction length that prevents interference between the reducer body 1200 and the body portion of the shock 1202, even when the shock 1202 is in the compressed state. This can allow for the reducer body 1200 to have a relatively narrow width, such as an inner width W₃ less than a diameter D₂ of the body portion of the shock 1202 and even an outer width W₄ less than the diameter D₂ of the body portion of the shock 1202. Thus, the reducer body 1200 and the shock 1202 can be provided with a reduced design envelope. However, the reducer body 1200 can have a greater reduction length such that the reducer body 1200 at least partially overlaps the body portion of the shock 1202 in the compressed and/or extended state. In such examples, the inner width W₃ of the reducer body 1200 can be greater than the diameter D₂ of the body portion of the shock 1202 in order to avoid interference between the reducer body 1200 and the shock 1202.

Reducer Body—Example 4—Reducer Body with Adjustable Insert

FIG. 14 illustrates a partially exploded view of a reducer body 1400 that includes a first reducer body 1400a and a second reducer body 1400b, each of which includes an opening 1402 for an adjustable insert 1404 (also referred to as a flip chip). The reducer body 1400 includes two body portions or components, the reducer bodies 1400a, 1400b. FIGS. 15A and 15B illustrate the reducer body 1400 mounted on a shock 302 in a first configuration 1500 and a second configuration 1502, respectively. FIGS. 14 through 15B are directed to the use of flip chip structural features (e.g., the adjustable inserts 1404) that allow modification of the geometry of the reducer body 1400, which can be used to modify a suspension linkage of a suspension system. More specifically, the adjustable inserts 1404 can be used to adjust a reduction length provided to the shock 302 by the reducer body 1400. The adjustable inserts 1404 of FIGS. 14 through 15B or other adjustable inserts may be part of any one of the connection features of reducer bodies according to any of the examples described herein.

The openings 1402 and the adjustable inserts 1404 can be part of connection features defined at ends of the reducer bodies 1400a, 1400b. Each of the adjustable inserts 1404 may include an elongated main body defining an off-center aperture or opening 1408. The openings 1408 can form connection features of the reducer body 1400 and can be coupled to a suspension linkage (e.g., to the upper link 314 of the suspension linkage 304, described above with respect to FIGS. 3A through 7D).

The adjustable inserts 1404 may be received in the openings 1402 of the reducer bodies 1400a, 1400b. The openings 1402 can be shaped to accommodate the adjustable inserts 1404 in one of two or more orientations. The orientation of the adjustable inserts 1404 in the openings 1402 can determine the location of the off-center aperture. The adjustable inserts 1404 may be received in the openings 1402 in one orientation where the openings 1408 are positioned at one end of the openings 1402 or in another orientation where the openings 1408 are positioned at an opposite end of the openings 1402. For instance, each of the openings 1408 may be positioned at an upper end of a respective opening 1402 in a first configuration 1500 illustrated in FIG. 15A. In another example, each of the openings 1408 may be positioned at a lower end of a respective opening 1402 in a second configuration 1502 illustrated in FIG. 15A. Depending on the orientation of the adjustable inserts 1404 in the openings 1402, a reduction length of the reducer body 1400 can be relatively larger (e.g., in the second configuration 1502 of FIG. 15B) or relatively smaller (e.g., in the first configuration 1500 of FIG. 15A). Thus, the adjustable inserts 1404 can be included in the reducer body 1400 in order to provide an adjustable reduction length for the reducer body 1400.

The adjustable inserts 1404 can have symmetrical outer shapes, that allow the adjustable inserts 1404 to be mounted in the openings 1402 in two or more positions. For example, the adjustable inserts 1404 can have bi-directionally symmetrical shapes, such as rectangular, oval, or other shapes that are symmetrical between two positions. The adjustable inserts 1404 can have tri-directionally symmetrical shapes, such as triangular or other shapes that are symmetrical between three positions. Adjustable inserts 1404 with higher levels of symmetry can be provided that are adjustable between greater numbers of positions. The openings 1408 can be positioned asymmetrically in the adjustable inserts 1404 such that mounting the adjustable inserts 1404 in the openings 1408 in different configurations changes the positions of the openings 1408 relative to the reducer body 1400. This can be used to adjust the reduction length provided by the reducer body 1400 between two or more distances.

The reducer bodies 1400a, 1400b can include openings 1406 defined at opposite ends of the reducer bodies 1400a, 1400b from the openings 1402. The openings 1406 can form connection features of the reducer body 1400 that can be coupled to one another and to a shock (e.g., to an upper eyelet 334 of a shock 302, as illustrated in FIGS. 15A and 15B). The reducer body 1400 can be secured to the shock 302 by a fastener 1407. The fastener 1407 can be a bolt, a collet axle, or any other suitable fastener. As illustrated in FIGS. 15A and 16B, the fastener 1407 can be inserted through the opening 1406 in the reducer body 1400b, through an opening in the upper eyelet 334 of the shock 302 and screwed into threads in the opening 1406 in the reducer body 1400a. The fastener 1407 allows each of the reducer bodies 1400a, 1400b to rotate or pivot relative to the shock 302 and relative to one another and fastens the upper eyelet 334 of the shock 302 between the reducer bodies 1400a, 1400b.

### Reducer Body—Example 5—1-Part Reducer Body

FIGS. 16 through 18 illustrate various views of a reducer body 1600 coupled to a shock 1602. The reducer body 1600 in the example of FIGS. 16 through 18 can be a U-shaped component (in a front or rear view) that is mounted to mounting tabs 1604 of the shock 1602. The reducer body 1600 can be mounted between the mounting tabs 1604. The reducer body 1600 can include a body portion that is a single member or component.

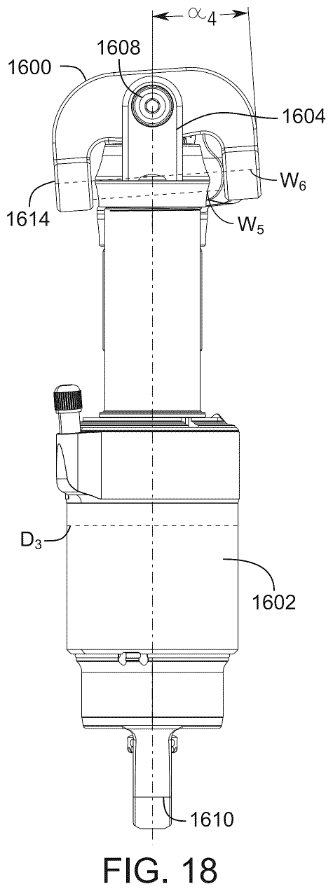

The reducer body 1600 can include a bearing 1606 (e.g., a bushing, a planar bearing, a spherical bearing, or another bearing) that allows the reducer body 1600 to rotate in a plane perpendicular to a pivot axis between the reducer body 1600 and the shock 1602. This allows for misalignment between a suspension linkage on which the reducer body 1600 and the shock 1602 are installed and the shock 1602 and can prevent binding or undesirable forces from being delivered from the suspension linkage to the shock 1602. Specifically, FIG. 18 illustrates an angle α4, which is a misalignment between the reducer body 1600 and the shock 1602 that can be permitted by the configuration of the reducer body 1600 and the shock 1602 in the example of FIGS. 16 through 18. The example of FIGS. 16 through 18 can permit misalignments in the angle α4 between the reducer body 1600 and the shock 1602 of up to about 2°, up to about 4°, or the like in either direction. Spherical bearings can be included in the reducer body 1600 and/or threads in the mounting tabs 1604 of the shock 1602 can be made floating in order to allow for misalignments between the reducer body 1600 and the shock 1602 in additional planes (e.g., a plane perpendicular to a longitudinal axis of the shock 1602).

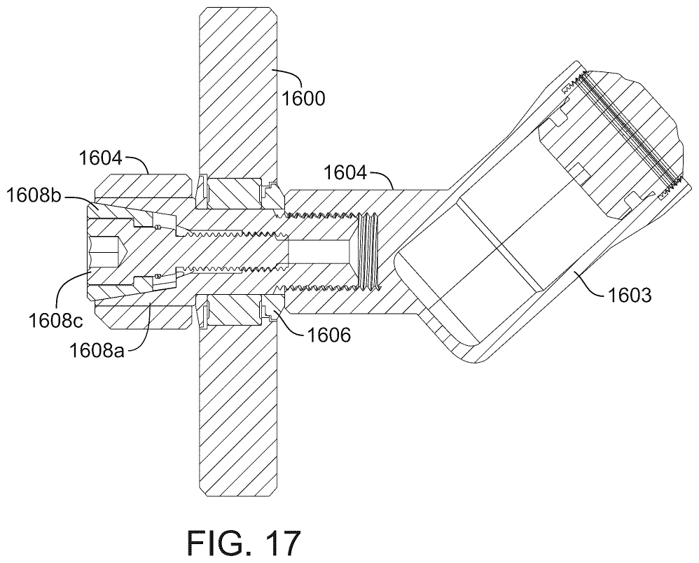

The reducer body 1600 can be secured to the shock 1602 by a collet axle 1608. The collet axle 1608 can include a collet 1608a, a taper 1608b, and a cap 1608c. As illustrated in FIG. 17, the collet 1608a can be inserted through a first of the mounting tabs 1604 of the shock 1602, through the bearing 1606 of the reducer body 1600, and screwed into threads in a second of the mounting tabs 1604 of the shock 1602. The collet 1608a can include an inner tapered surface and the taper 1608b can include a corresponding outer tapered surface. The cap 1608c can be inserted into the taper 1608b and screwed into the collet 1608a such that the tapered surfaces of the taper 1608b and the collet 1608a interface with one another, the collet 1608a expands, and interference between the collet 1608a and the first mounting tab 1604 can secure the collet axle 1608 in the first mounting tab 1604. Securing the reducer body 1600 to the shock 1602 using the collet axle 1608 can allow for large tolerances in dimensions of the reducer body 1600 and the mounting tabs 1604 of the shock 1602 and prevents the bearings 1606 from being overloaded. However, other fasteners can also be used. For example, the reducer body 1600 can be secured to the shock 1602 by a bolt that extends through the first mounting tab 1604, the bearing 1606 of the reducer body 1600, and is screwed into the threads of the second mounting tab 1604.

In the example illustrated in FIGS. 16 through 18, the reducer body 1600 is mounted to a shaft end of the shock 1602 opposite a body end of the shock 1602. The reducer body 1600 can have a reduction length that prevents interference between the reducer body 1600 and the body portion of the shock 1602, even when the shock 1602 is in the compressed state. This can allow for the reducer body 1600 to have a relatively narrow width, such as an inner width W₅ less than a diameter D₃ of the body portion of the shock 1602 and even an outer width W₆ less than the diameter D₃ of the body portion of the shock 1602. Thus, the reducer body 1600 and the shock 1602 can be provided with a reduced design envelope. However, the reducer body 1600 can have a greater reduction length such that the reducer body 1600 at least partially overlaps the body portion of the shock 1602 in the compressed and/or extended state. In such examples, the inner width W₅ of the reducer body 1600 can be greater than the diameter D₃ of the body portion of the shock 1602 in order to avoid interference between the reducer body 1600 and the shock 1602.

Providing the shock 1602 with the mounting tabs 1604 and mounting the reducer body 1600 within the mounting tabs 1604 can allow for the reducer body 1600 and the shock 1602 to be mounted in a suspension linkage in a greater variety of positions. For example, the reducer body 1600 does not interfere with a piggyback 1603 of the shock 1602 and the reducer body 1600 and the shock 1602 can be mounted in a suspension linkage with the shaft/piggyback end of the shock 1602 vertically above the body end of the shock 1602 and with the piggyback 1603 in front of the shock 1602 (e.g., to the right of the shock 1602 in a drive-side view of a suspension linkage or facing towards a front wheel and away from a driven wheel of a bicycle). This can provide additional design flexibility for positioning bicycle components and accessories (e.g., electric or other drive components, water bottles, tools, etc.) within a suspended body of a suspension linkage without causing interference between the components or accessories and the shock 1602.

The shock 1602 can include an eyelet 1610 with an opening 1612 that can form a joint with a suspension linkage (e.g., a joint 336 with a suspension linkage 304) and the reducer body 1600 can include openings 1614 that can form joints with the suspension linkage (e.g., joints 340 with the suspension linkage 304). The shock 1602 and the reducer body 1600 can be mounted in a suspension linkage the same as or similar to the shock 302 and the reducer body 300, discussed above in reference to FIGS. 3A through 7D.

Although the reducer body 1600 and the shock 1602 are illustrated in a configuration in which the mounting tabs 1604 are provided on the shaft end of the shock 1602 and the eyelet 1610 is provided on the body end of the shock 1602, in some examples, the mounting tabs 1604 can be provided on the body end of the shock 1602 and the eyelet 1610 can be provided on the shaft end of the shock 1602. In such examples, the inner width W₅ of the reducer body 1600 can be greater than the diameter D₃ of the body portion of the shock 1602 in order to avoid interference between the reducer body 1600 and the shock 1602. By flipping positions of the mounting tabs 1604 and the eyelet 1610, the reducer body 1600 and the shock 1602 can be mounted on a suspension linkage with the body end of the shock 1602 vertically above the shaft/piggyback end of the shock 1602 and with the piggyback 1603 in front of the shock 1602 (e.g., to the right of the shock 1602 in a drive-side view of a suspension linkage or facing towards a front wheel and away from a driven wheel of a bicycle).

Pivot axes of the opening 1612 and the openings 1614 (e.g., used to form joints 336, 340, respectively, with a suspension linkage 304) can be parallel to each other and can be clocked or nonparallel (e.g., perpendicular) to a pivot axis between the reducer body 1600 and the shock 1602 defined by the collet axle 1608. This allows for relative motion between the reducer body 1600, the shock 1602, and a suspension linkage as the reducer body 1600 and the shock 1602 are being mounted on the suspension linkage, but provides a rigid, non-rotating connection between the pivot axis of the opening 1612 and the pivot axes of the openings 1614 when the reducer body 1600 and the shock 1602 are mounted on the suspension linkage. In other words, the shock 1602 and the reducer body 1600 can be constrained in a rigid non-rotating connection with one another when the shock 1602 and the reducer body 1600 are mounted to a suspension linkage.

### Reducer Body—Example 6—2-Part Reducer Body

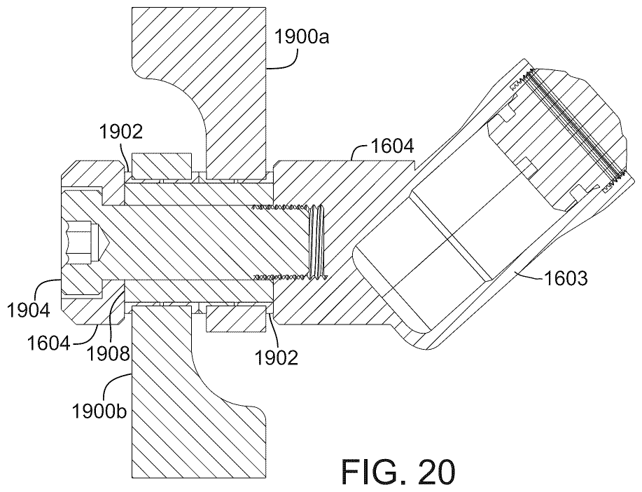

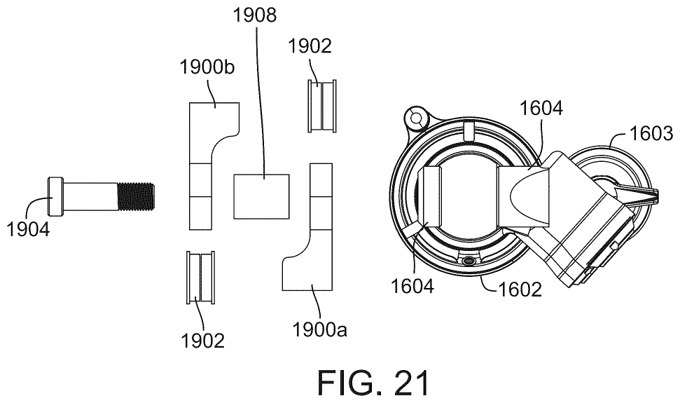

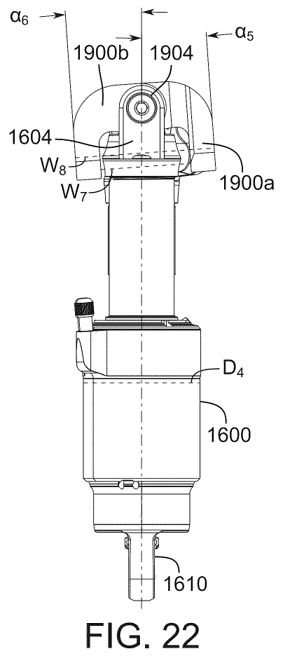

FIGS. 19 through 22 illustrate various views of a two-part reducer body 1900 coupled to a shock 1602. The shock 1602 can be the same as or similar to the shock 1602 discussed above in reference to FIGS. 16 through 18. The reducer body 1900 can include a first part 1900a and a second part 1900b. In other words, the reducer body 1900 includes two body portions or components, the parts 1900a, 1900b. As illustrated in FIGS. 19 and 22, the first part 1900a and the second part 1900b can form the reducer body 1900 as a U-shaped component (in a front or rear view) that is mounted to the mounting tabs 1604 of the shock 1602. As illustrated in FIG. 22, each of the first part 1900a and the second part 1900b can be L-shaped components in a front or rear view. As illustrated in FIGS. 20 and 21, the first part 1900a and the second part 1900b can be L-shaped components in a top or bottom view. The reducer body 1900 can be mounted between the mounting tabs 1604.

The reducer body 1900 can include bearings 1902 (e.g., bushings, planar bearings, spherical bearings, or other bearings) that allow the reducer body 1900 to rotate in a plane perpendicular to a pivot axis between the reducer body 1900 and the shock 1602. This allows for misalignment between a suspension linkage on which the reducer body 1900 and the shock 1602 are installed and the shock 1602 and can prevent binding or undesirable forces from being delivered from the suspension linkage to the shock 1602. Forming the reducer body 1900 as a two-part component including the first part 1900a and the second part 1900b allows for misalignment between both a drive-side and a non-drive-side of the suspension linkage and the shock 1602 and provides additional tolerance relative to a single-part or unitary reducer body. Specifically, FIG. 22 illustrates angles α₅ and α₆, which are drive-side and non-drive-side misalignments, respectively, between the reducer body 1900 and the shock 1602 that can be permitted by the configuration of the reducer body 1900 and the shock 1602 in the example of FIGS. 19 through 22. The example of FIGS. 19 through 22 can permit misalignments in the angles α₅, α₆ between the reducer body 1900 and the shock 1602 of up to about 2°, up to about 4°, or the like on each side of the suspension linkage on which the reducer body 1900 and the shock 1602 are mounted. Spherical bearings can be included in the reducer body 1900 and/or threads in the mounting tabs 1604 of the shock 1602 can be made floating in order to allow for misalignments between the reducer body 1900 and the shock 1602 in additional planes (e.g., a plane perpendicular to a longitudinal axis of the shock 1602).

The reducer body 1900 can be secured to the shock 1602 by a fastener 1904. The fastener 1904 can be a bolt, a collet axle, or any other suitable fastener. As illustrated in FIGS. 20 and 21, the fastener 1904 can be inserted through a first of the mounting tabs 1604 of the shock 1602, through a spacer 1908 (that extends through a first bearing 1902 in the second part 1900b and through a second bearing 1902 in the first part 1900a) and screwed into threads in a second of the mounting tabs 1604 of the shock 1602. The spacer 1908 can be used to maintain a desired distance between the mounting tabs 1604 of the shock 1602 and between the components of the reducer body 1900 and can prevent the bearings 1902 from being overloaded. The fastener 1904 allows each of the first part 1900a and the second part 1900b to rotate or pivot relative to the shock 1602 and fastens the reducer body 1900 within and between the mounting tabs 1604.

In the example illustrated in FIGS. 19 through 22, the reducer body 1900 is mounted to a shaft end of the shock 1602 opposite a body end of the shock 1602. The reducer body 1900 can have a reduction length that prevents interference between the reducer body 1900 and the body portion of the shock 1602, even when the shock 1602 is in the compressed state. This can allow for the reducer body 1900 to have a relatively narrow width, such as an inner width W₇ less than a diameter D₄ of the body portion of the shock 1602 and even an outer width W₈ less than the diameter D₄ of the body portion of the shock 1602. Thus, the reducer body 1900 and the shock 1602 can be provided with a reduced design envelope. However, the reducer body 1900 can have a greater reduction length such that the reducer body 1900 at least partially overlaps the body portion of the shock 1602 in the compressed and/or extended state. In such examples, the inner width W₇ of the reducer body 1900 can be greater than the diameter D₄ of the body portion of the shock 1602 in order to avoid interference between the reducer body 1900 and the shock 1602. The inner and outer widths W₇, W₈ can refer to widths of the reducer body 1900 when the first part 1900a and the second part 1900b are arranged with mirror misalignment angles α₅, α₆ (e.g., a top surface of the reducer body 1900 forms a plane between the first part 1900a and the second part 1900b) and can vary depending on the angles α₅, α₆.

Providing the shock 1602 with the mounting tabs 1604 and mounting the reducer body 1900 within the mounting tabs 1604 can allow for the reducer body 1900 and the shock 1602 to be mounted in a suspension linkage in a greater variety of positions. For example, the reducer body 1900 does not interfere with a piggyback 1603 of the shock 1602 and the reducer body 1900 and the shock 1602 can be mounted in a suspension linkage with the shaft/piggyback end of the shock 1602 vertically above the body end of the shock 1602 and with the piggyback 1603 in front of the shock 1602 (e.g., to the right of the shock 1602 in a drive-side view of a suspension linkage or facing towards a front wheel and away from a driven wheel of a bicycle). This can provide additional design flexibility for positioning bicycle components and accessories (e.g., electric or other drive components, water bottles, tools, etc.) within a suspended body of a suspension linkage without causing interference between the components or accessories and the shock 1602.

The shock 1602 can include an eyelet 1610 with an opening 1612 that can form a joint with a suspension linkage (e.g., a joint 336 with a suspension linkage 304) and the reducer body 1900 can include openings 1906 that can form joints with the suspension linkage (e.g., joints 340 with the suspension linkage 304). The shock 1602 and the reducer body 1900 can be mounted in a suspension linkage the same as or similar to the shock 302 and the reducer body 300, discussed above in reference to FIGS. 3A through 7D.

Although the reducer body 1900 and the shock 1602 are illustrated in a configuration in which the mounting tabs 1604 are provided on the shaft end of the shock 1602 and the eyelet 1610 is provided on the body end of the shock 1602, in some examples, the mounting tabs 1604 can be provided on the body end of the shock 1602 and the eyelet 1610 can be provided on the shaft end of the shock 1602. In such examples, the inner width W₇ of the reducer body 1900 can be greater than the diameter D₄ of the body portion of the shock 1602 in order to avoid interference between the reducer body 1900 and the shock 1602. By flipping positions of the mounting tabs 1604 and the eyelet 1610, the reducer body 1600 and the shock 1602 can be mounted on a suspension linkage with the body end of the shock 1602 vertically above the shaft/piggyback end of the shock 1602 and with the piggyback 1603 in front of the shock 1602 (e.g., to the right of the shock 1602 in a drive-side view of a suspension linkage or facing towards a front wheel and away from a driven wheel of a bicycle).

Pivot axes of the opening 1612 and the openings 1906 (e.g., used to form joints 336, 340, respectively, with a suspension linkage 304) can be parallel to each other and can be clocked or nonparallel (e.g., perpendicular) to a pivot axis between the reducer body 1900 and the shock 1602 defined by the fastener 1904. This allows for relative motion between the reducer body 1900, the shock 1602, and a suspension linkage as the reducer body 1900 and the shock 1602 are being mounted on the suspension linkage, but provides a rigid, non-rotating connection between the pivot axis of the opening 1612 and the pivot axes of the openings 1906 when the reducer body 1900 and the shock 1602 are mounted on the suspension linkage. In other words, the shock 1602 and the reducer body 1900 can be constrained in a rigid non-rotating connection with one another when the shock 1602 and the reducer body 1900 are mounted to a suspension linkage.

### Reducer Body—Example 7—2-Part Reducer Body

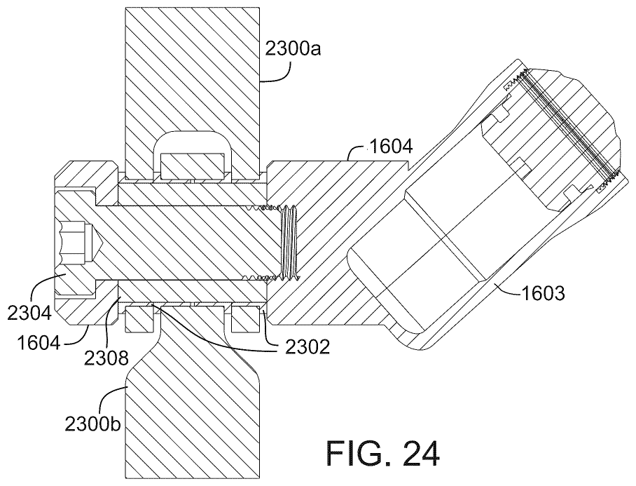

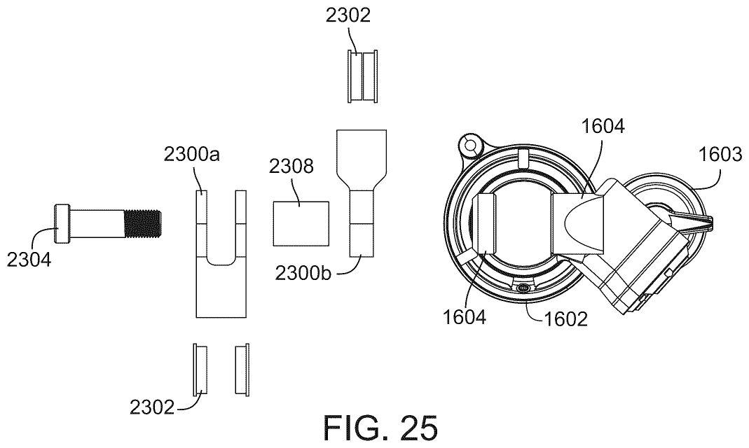

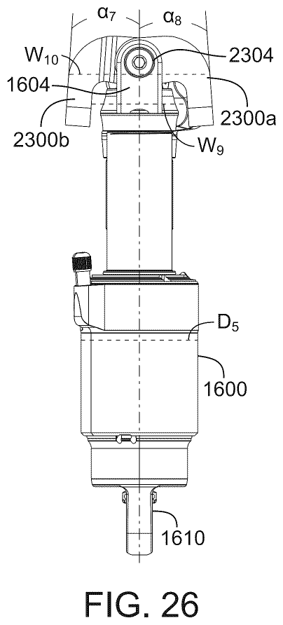

FIGS. 23 through 26 illustrate various views of a two-part reducer body 2300 coupled to a shock 1602. The shock 1602 can be the same as or similar to the shock 1602 discussed above in reference to FIGS. 16 through 18. The reducer body 2300 can include a first part 2300a and a second part 2300b. In other words, the reducer body 2300 includes two body portions or components, the parts 2300a, 2300b. As illustrated in FIGS. 23 and 26, the first part 2300a and the second part 2300b can form the reducer body 2300 as a U-shaped component (in a front or rear view) that is mounted to the mounting tabs 1604 of the shock 1602. As illustrated in FIG. 26, each of the first part 2300a and the second part 2300b can be L-shaped components in a front or rear view. As illustrated in FIGS. 24 and 25, the first part 2300a can be a U-shaped component and the second part 2300b can be an I-shaped or T-shaped component in a top or bottom view. The reducer body 2300 can be mounted between the mounting tabs 1604.

The reducer body 2300 can include bearings 2302 (e.g., bushings, planar bearings, spherical bearings, or other bearings) that allow the reducer body 2300 to rotate in a plane perpendicular to a pivot axis between the reducer body 2300 and the shock 1602. This allows for misalignment between a suspension linkage on which the reducer body 2300 and the shock 1602 are installed and the shock 1602 and can prevent binding or undesirable forces from being delivered from the suspension linkage to the shock 1602. Forming the reducer body 2300 as a two-part component including the first part 2300a and the second part 2300b allows for misalignment between both a drive-side and a non-drive-side of the suspension linkage and the shock 1602 and provides additional tolerance relative to a single-part or unitary reducer body. Specifically, FIG. 26 illustrates angles α₇ and α₈, which are drive-side and non-drive-side misalignments, respectively, between the reducer body 2300 and the shock 1602 that can be permitted by the configuration of the reducer body 2300 and the shock 1602 in the example of FIGS. 23 through 26. The example of FIGS. 23 through 26 can permit misalignments in the angles α₇, α₈ between the reducer body 2300 and the shock 1602 of up to about 2°, up to about 4°, or the like on each side of the suspension linkage on which the reducer body 2300 and the shock 1602 are mounted. Spherical bearings can be included in the reducer body 2300 and/or threads in the mounting tabs 1604 of the shock 1602 can be made floating in order to allow for misalignments between the reducer body 2300 and the shock 1602 in additional planes (e.g., a plane perpendicular to a longitudinal axis of the shock 1602).

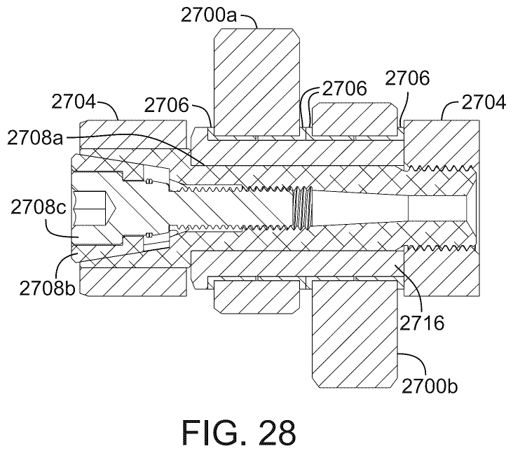

The reducer body 2300 can be secured to the shock 1602 by a fastener 2304. The fastener 2304 can be a bolt, a collet axle, or any other suitable fastener. As illustrated in FIG. 28, the fastener 2304 can be inserted through a first of the mounting tabs 1604 of the shock 1602, through a spacer 2308 (that extends through a first bearing 2302 in the first part 2300a, through a second bearing 2302 in the second part 2300b, and through a third bearing 2302 in the first part 2300a), and screwed into threads in a second of the mounting tabs 1604 of the shock 1602. The spacer 2308 can be used to maintain a desired distance between the mounting tabs 1604 of the shock 1602 and between the components of the reducer body 2300 and can prevent the bearings 2302 from being overloaded. The fastener 2304 allows each of the first part 2300a and the second part 2300b to rotate or pivot relative to the shock 1602 and fastens the reducer body 2300 within and between the mounting tabs 1604.

In the example illustrated in FIGS. 23 through 26, the reducer body 2300 is mounted to a shaft end of the shock 1602 opposite a body end of the shock 1602. The reducer body 2300 can have a reduction length that prevents interference between the reducer body 2300 and the body portion of the shock 1602, even when the shock 1602 is in the compressed state. This can allow for the reducer body 2300 to have a relatively narrow width, such as an inner width W₉ less than a diameter D₅ of the body portion of the shock 1602 and even an outer width W₁₀ less than the diameter D₅ of the body portion of the shock 1602. Thus, the reducer body 2300 and the shock 1602 can be provided with a reduced design envelope. However, the reducer body 2300 can have a greater reduction length such that the reducer body 2300 at least partially overlaps the body portion of the shock 1602 in the compressed and/or extended state. In such examples, the inner width W₉ of the reducer body 2300 can be greater than the diameter D₅ of the body portion of the shock 1602 in order to avoid interference between the reducer body 2300 and the shock 1602. The inner and outer widths W₉, W₁₀ can refer to widths of the reducer body 2300 when the first part 2300a and the second part 2300b are arranged with mirror misalignment angles α₇, as (e.g., a top surface of the reducer body 2300 forms a plane between the first part 2300a and the second part 2300b) and can vary depending on the angles α₇, as.

Providing the shock 1602 with the mounting tabs 1604 and mounting the reducer body 2300 within the mounting tabs 1604 can allow for the reducer body 2300 and the shock 1602 to be mounted in a suspension linkage in a greater variety of positions. For example, the reducer body 2300 does not interfere with a piggyback 1603 of the shock 1602 and the reducer body 2300 and the shock 1602 can be mounted in a suspension linkage with the shaft/piggyback end of the shock 1602 vertically above the body end of the shock 1602 and with the piggyback 1603 in front of the shock 1602 (e.g., to the right of the shock 1602 in a drive-side view of a suspension linkage or facing towards a front wheel and away from a driven wheel of a bicycle). This can provide additional design flexibility for positioning bicycle components and accessories (e.g., electric or other drive components, water bottles, tools, etc.) within a suspended body of a suspension linkage without causing interference between the components or accessories and the shock 1602.

The shock 1602 can include an eyelet 1610 with an opening 1612 that can form a joint with a suspension linkage (e.g., a joint 336 with a suspension linkage 304) and the reducer body 2300 can include openings 2306 that can form joints with the suspension linkage (e.g., joints 340 with the suspension linkage 304). The shock 1602 and the reducer body 2300 can be mounted in a suspension linkage the same as or similar to the shock 302 and the reducer body 300, discussed above in reference to FIGS. 3A through 7D.

Although the reducer body 2300 and the shock 1602 are illustrated in a configuration in which the mounting tabs 1604 are provided on the shaft end of the shock 1602 and the eyelet 1610 is provided on the body end of the shock 1602, in some examples, the mounting tabs 1604 can be provided on the body end of the shock 1602 and the eyelet 1610 can be provided on the shaft end of the shock 1602. In such examples, the inner width W₉ of the reducer body 2300 can be greater than the diameter D₅ of the body portion of the shock 1602 in order to avoid interference between the reducer body 2300 and the shock 1602. By flipping positions of the mounting tabs 1604 and the eyelet 1610, the reducer body 1600 and the shock 1602 can be mounted on a suspension linkage with the body end of the shock 1602 vertically above the shaft/piggyback end of the shock 1602 and with the piggyback 1603 in front of the shock 1602 (e.g., to the right of the shock 1602 in a drive-side view of a suspension linkage or facing towards a front wheel and away from a driven wheel of a bicycle).

Pivot axes of the opening 1612 and the openings 2306 (e.g., used to form joints 336, 340, respectively, with a suspension linkage 304) can be parallel to each other and can be clocked or nonparallel (e.g., perpendicular) to a pivot axis between the reducer body 2300 and the shock 1602 defined by the fastener 2304. This allows for relative motion between the reducer body 2300, the shock 1602, and a suspension linkage as the reducer body 2300 and the shock 1602 are being mounted on the suspension linkage, but provides a rigid, non-rotating connection between the pivot axis of the opening 1612 and the pivot axes of the openings 2306 when the reducer body 2300 and the shock 1602 are mounted on the suspension linkage. In other words, the shock 1602 and the reducer body 2300 can be constrained in a rigid non-rotating connection with one another when the shock 1602 and the reducer body 2300 are mounted to a suspension linkage.

### Reducer Body—Example 8—2-Part Reducer Body

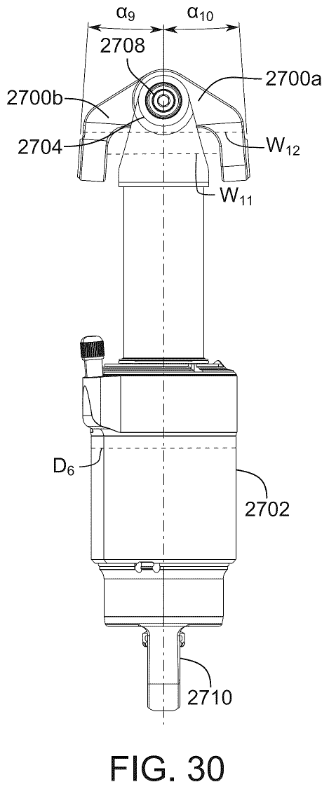

FIGS. 27 through 30 illustrate various views of a two-part reducer body 2700 coupled to a shock 2702. The shock 2702 can be similar to the shock 1602, discussed above in reference to FIGS. 16 through 18, except that the shock 2702 does not include a piggyback (e.g., the shock 2702 is an in-line shock). The reducer body 2700 can include a first part 2700a and a second part 2700b. In other words, the reducer body 2700 includes two body portions or components, the parts 2700a, 2700b. As illustrated in FIGS. 27 and 30, the first part 2700a and the second part 2700b can form the reducer body 2700 as a V-shaped or U-shaped component (in a front or rear view) that is mounted to the mounting tabs 1604 of the shock 1602. As illustrated in FIG. 30, each of the first part 2700a and the second part 2700b can be relatively L-shaped components (with an angle greater than 90° between legs) in a front or rear view. The reducer body 2700 can be mounted between mounting tabs 2704 of the shock 2702.

The reducer body 2700 can include bearings 2706 (e.g., bushings, planar bearings, spherical bearings, or other bearings) that allow the reducer body 2700 to rotate in a plane perpendicular to a pivot axis between the reducer body 2700 and the shock 2702. This allows for misalignment between a suspension linkage on which the reducer body 2700 and the shock 2702 are installed and the shock 2702 and can prevent binding or undesirable forces from being delivered from the suspension linkage to the shock 2702. Forming the reducer body 2700 as a two-part component including the first part 2700a and the second part 2700b allows for misalignment between both a drive-side and a non-drive-side of the suspension linkage and the shock 2702 and provides additional tolerance relative to a single-part or unitary reducer body. Specifically, FIG. 30 illustrates angles α₉ and α₁₀, which are drive-side and non-drive-side misalignments, respectively, between the reducer body 2700 and the shock 2702 that can be permitted by the configuration of the reducer body 2700 and the shock 2702 in the example of FIGS. 27 through 30. The example of FIGS. 27 through 30 can permit misalignments in the angles α₉, α₁₀ between the reducer body 2700 and the shock 2702 of up to about 2°, up to about 4°, or the like on each side of the suspension linkage on which the reducer body 2700 and the shock 2702 are mounted. Spherical bearings can be included in the reducer body 2700 and/or threads in the mounting tabs 2704 of the shock 2702 can be made floating in order to allow for misalignments between the reducer body 2700 and the shock 2702 in additional planes (e.g., a plane perpendicular to a longitudinal axis of the shock 2702).

The reducer body 2700 can be secured to the shock 2702 by a collet axle 2708. The collet axle 2708 can include a collet 2708a, a taper 2708b, and a cap 2708c. As illustrated in FIGS. 24 and 25, the collet 2708a can be inserted through a first of the mounting tabs 2704 of the shock 2702, through a spacer 2716 (that extends through bearings 2706 in the first part 2700a and through bearings 2706 in the second part 2700b) and screwed into threads in a second of the mounting tabs 2704 of the shock 2702. The collet 2708a can include an inner tapered surface and the taper 2708b can include a corresponding outer tapered surface. The cap 2708c can be inserted into the taper 2708b and screwed into the collet 2708a such that the tapered surfaces of the taper 2708b and the collet 2708a interface with one another, the collet 2708a expands, and interference between the collet 2708a and the first mounting tab 2704 can secure the collet axle 2708 in the first mounting tab 2704. Securing the reducer body 2700 to the shock 2702 using the collet axle 2708 can allow for large tolerances in dimensions of the reducer body 2700 and the mounting tabs 2704 of the shock 2702 and prevents the bearings 2706 from being overloaded. However, other fasteners can also be used. For example, the reducer body 2700 can be secured to the shock 2702 by a bolt that extends through the first mounting tab 2704 and the spacer 2716 and is screwed into the threads of the second mounting tab 2704.

In the example illustrated in FIGS. 27 through 30, the reducer body 2700 is mounted to a shaft end of the shock 2702 opposite a body end of the shock 2702. The reducer body 2700 can have a reduction length that prevents interference between the reducer body 2700 and the body portion of the shock 2702, even when the shock 2702 is in the compressed state. This can allow for the reducer body 2700 to have a relatively narrow width, such as an inner width W₉ less than a diameter D₅ of the body portion of the shock 2702 and even an outer width W₁₀ less than the diameter D₅ of the body portion of the shock 2702. Thus, the reducer body 2700 and the shock 2702 can be provided with a reduced design envelope. However, the reducer body 2700 can have a greater reduction length such that the reducer body 2700 at least partially overlaps the body portion of the shock 2702 in the compressed and/or extended state. In such examples, the inner width W₉ of the reducer body 2700 can be greater than the diameter D₅ of the body portion of the shock 2702 in order to avoid interference between the reducer body 2700 and the shock 2702.

Providing the shock 2702 with the mounting tabs 2704 and mounting the reducer body 2700 within the mounting tabs 2704 can allow for the reducer body 2700 and the shock 2702 to be mounted in a suspension linkage in a greater variety of positions. For example, the reducer body 2700 and the shock 2702 can be mounted in a suspension linkage with the shaft end of the shock 2702 vertically above the body end of the shock 2702. This can provide additional design flexibility for positioning bicycle components and accessories (e.g., electric or other drive components, water bottles, tools, etc.) within a suspended body of a suspension linkage without causing interference between the components or accessories and the shock 2702.

The shock 2702 can include an eyelet 2710 with an opening 2712 that can form a joint with a suspension linkage (e.g., a joint 336 with a suspension linkage 304) and the reducer body 2700 can include openings 2714 that can form joints with the suspension linkage (e.g., joints 340 with the suspension linkage 304). The shock 2702 and the reducer body 2700 can be mounted in a suspension linkage the same as or similar to the shock 302 and the reducer body 300, discussed above in reference to FIGS. 3A through 7D.

Although the reducer body 2700 and the shock 2702 are illustrated in a configuration in which the mounting tabs 2704 are provided on the shaft end of the shock 2702 and the eyelet 2710 is provided on the body end of the shock 2702, in some examples, the mounting tabs 2704 can be provided on the body end of the shock 2702 and the eyelet 2710 can be provided on the shaft end of the shock 2702. In such examples, the inner width W₉ of the reducer body 2700 can be greater than the diameter D₅ of the body portion of the shock 2702 in order to avoid interference between the reducer body 2700 and the shock 2702. By flipping positions of the mounting tabs 2704 and the eyelet 2710, the reducer body 2700 and the shock 2702 can be mounted on a suspension linkage with the body end of the shock 2702 vertically above the shaft end of the shock 1602.

Pivot axes of the opening 2712 and the openings 2714 (e.g., used to form joints 336, 340, respectively, with a suspension linkage 304) can be parallel to each other and can be clocked or nonparallel (e.g., perpendicular) to a pivot axis between the reducer body 2700 and the shock 2702 defined by the collet axle 2708. This allows for relative motion between the reducer body 2700, the shock 2702, and a suspension linkage as the reducer body 2700 and the shock 2702 are being mounted on the suspension linkage, but provides a rigid, non-rotating connection between the pivot axis of the opening 2712 and the pivot axes of the openings 2714 when the reducer body 2700 and the shock 2702 are mounted on the suspension linkage. In other words, the shock 2702 and the reducer body 2700 can be constrained in a rigid non-rotating connection with one another when the shock 2702 and the reducer body 2700 are mounted to a suspension linkage.

### Extender Bodies, Generally

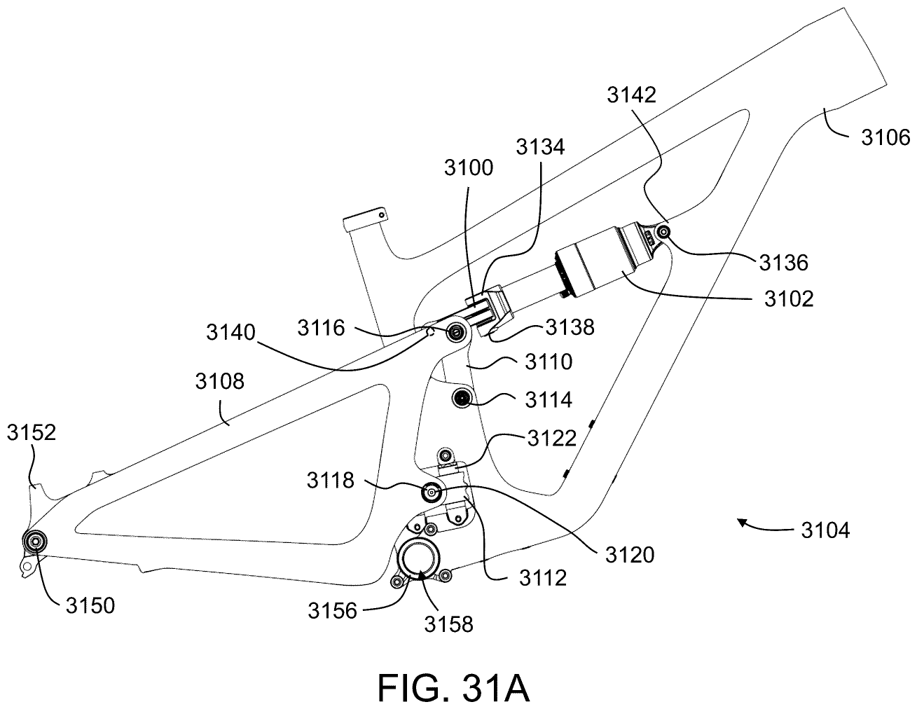

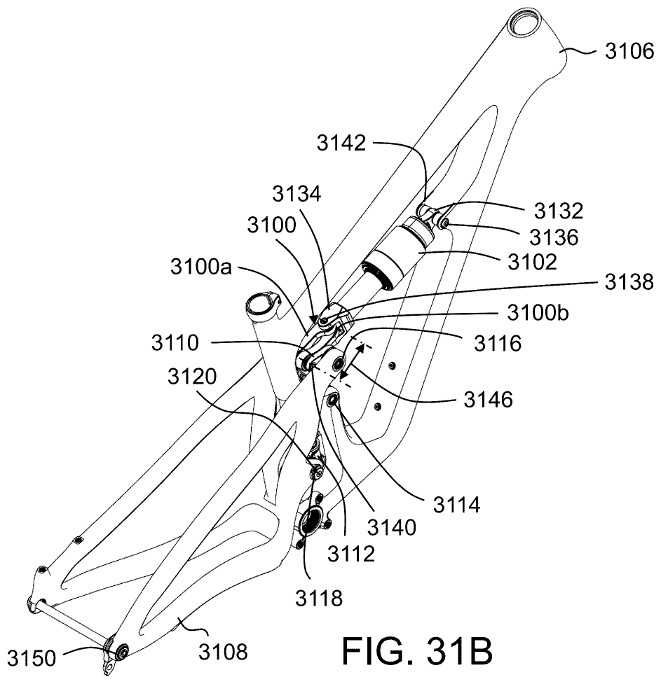

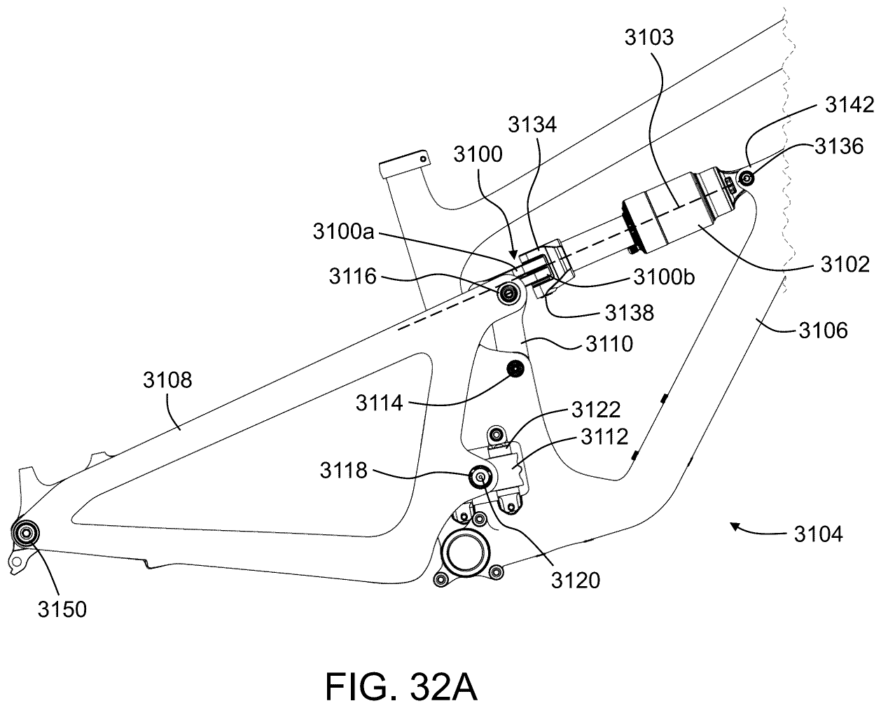

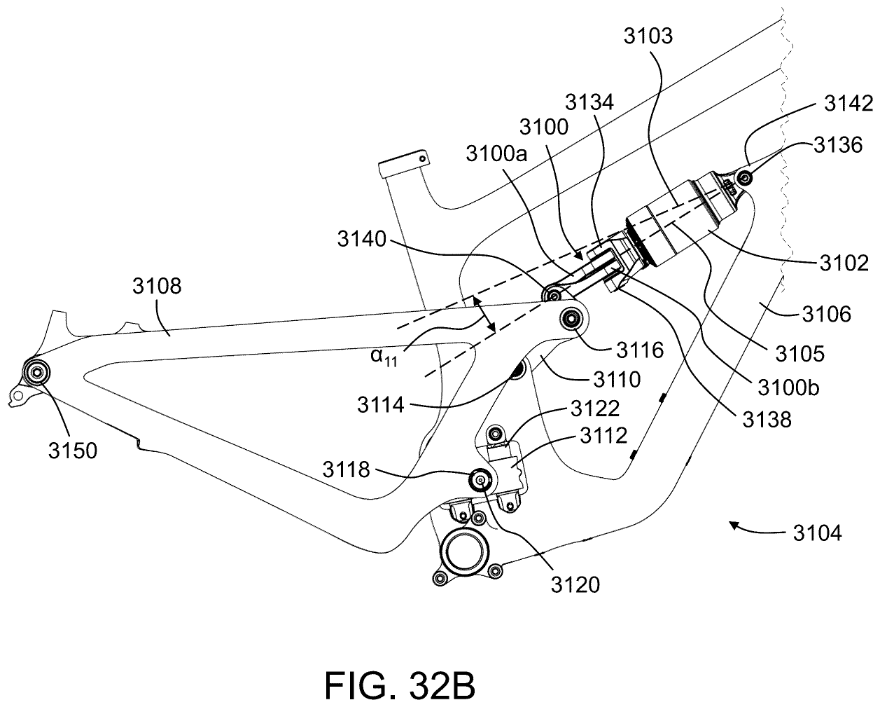

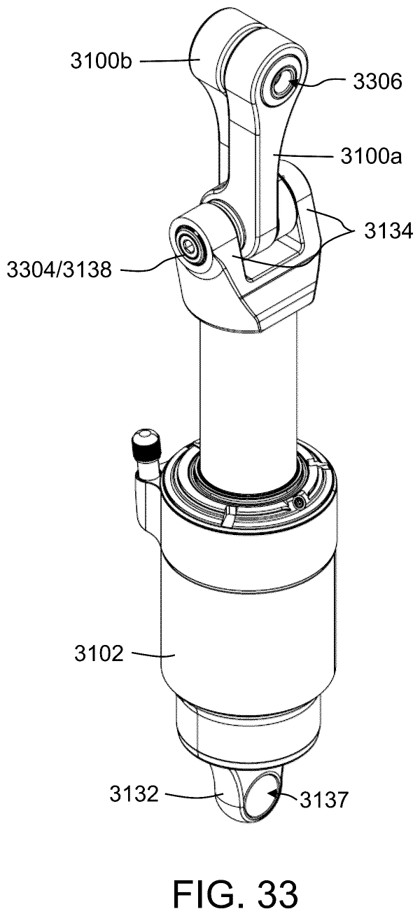

FIGS. 31A through 38 illustrate various views of extender bodies that can be mounted between a shock and a suspension linkage in order to increase an effective eye-to-eye distance or mounting length of the shock. FIGS. 31A through 32B illustrate an example of a suspension linkage 3104 that includes a shock 3102 in an approximately horizontal position. The extender bodies can increase a primary mounting length of the shock 3102 by an extension length 3146 to an effective mounting length. Increasing the mounting length of the shock 3102 can provide several improvements to the suspension linkage 3104. For example, when the shock 3102 is mounted to the suspension linkage 3104 in a generally horizontal orientation, as in FIGS. 31A through 32B, increasing the mounting length of the shock 3102 can allow for the shock 3102 to be positioned further forward within the suspension linkage 3104 as compared to a shock without an extender body. Positioning the shock 3102 forward relative to the suspension linkage 3104 can allow for a narrower design of the shock 3102 and the suspension linkage 3104, creating more space within the suspension linkage 3104 to allow for improved shock capability, easier assembly and disassembly of the shock 3102, and room for accessories or components, such as, for example, electric drive components, water bottles, tools, and spare parts. Extender bodies with different extension lengths 3146 or extender bodies with adjustable extension lengths can be used with shocks 3102 having standard mounting lengths in order to provide custom effective mounting lengths for the shocks 3102, to tune leverage rate curves of the shocks 3102 with the suspension linkage 3104, and the like.

Providing an extender body coupled between the shock 3102 and the suspension linkage 3104 can provide leverage rate benefits to the suspension linkage 3104. For example, increasing the effective mounting length of the shock 3102 can tend to linearize the leverage rate of the shock 3102 and suspension linkage 3104 and allow for increased progression, such as when the shock 3102 is mounted generally horizontally in the suspension linkage 3104 (e.g., in the example of FIGS. 31A through 32B). These attributes can be difficult to achieve while providing clearance for components within the suspension linkage 3104 (e.g., water bottles, tools, spare parts, etc.) without an extender body coupled between the shock 3102 and the suspension linkage 3104.

In some examples, bearings (e.g., bushings, planar bearings, spherical bearings, other bearings, friction reducers, friction reducing elements, or the like) can be provided between a shock and an extender body coupled between the shock and a suspension linkage. The bearings can allow for low-friction or frictionless movement between the shock and the extender body. Movement between the shock and the extender body can be a result of misalignment of suspension elements of a suspension linkage. Providing the bearings between the extender body and the shock can reduce wear on the shock caused by movement and misalignment between components of the suspension linkage and the shock. An axis of a joint between the shock and the extender body can be clocked (e.g., nonparallel to) mounting axes of the extender body and the shock that are coupled to the suspension linkage. This can provide for rigid coupling of the extender body and the shock to the suspension linkage, while allowing for some slight movement between the shock and the extender body.

### Extender Body—Example 1—2-Part Extender Body

FIGS. 31A through 34 illustrate various views of an extender body 3100 and a shock 3102. As illustrated in FIGS. 31A through 32B, the extender body 3100 can operatively couple the shock 3102 to a suspension linkage 3104. In this example, the shock 3102 is generally horizontally oriented within the suspension linkage 3104. The suspension linkage 3104 can include a suspended body 3106, a swingarm 3108 (also referred to as a rear triangle or a rear frame) for coupling the suspension linkage 3104 with a driven wheel, and a suspension resistance device (e.g., the shock 3102). A driven wheel axis 3150 for a driven wheel and a brake caliper mount 3152 for a brake caliper can be included on the swingarm 3108. FIGS. 31A and 31B illustrate an example of the suspension linkage 3104, which can be applied to a bicycle. The suspended body 3106 can include a crank interface 3158 in a bottom bracket 3156, which can be used to allow a crank and/or a driving cog to be coupled to the suspended body 3106.

The swingarm 3108 can include a seatstay and a chainstay rigidly coupled to one another. The suspension linkage 3104 can further include an upper link 3110 and a lower link 3112. The suspended body 3106, the swingarm 3108, the upper link 3110, and the lower link 3112 can define the suspension linkage 3104. The linkage bodies of the suspension linkage 304 and the connections therebetween control the relative motion between the driven wheel axis 3150 and the suspended body 3106 as the driven wheel axis 3150 and the shock 3102 move between an extended or uncompressed state (illustrated in FIGS. 31A, 31B, and 32A) and a compressed state (illustrated in FIG. 32B).

The suspension linkage 3104 includes four linkage bodies and is an example of a 4-bar linkage. The extender bodies of FIGS. 31A through 38 can be applied to any linkages, such as 4-bar, 6-bar, or linkages having more or fewer linkage bodies, and can be applied to suspension linkages with generally horizontally oriented shocks, generally vertically oriented shocks, or shocks with any other orientations.

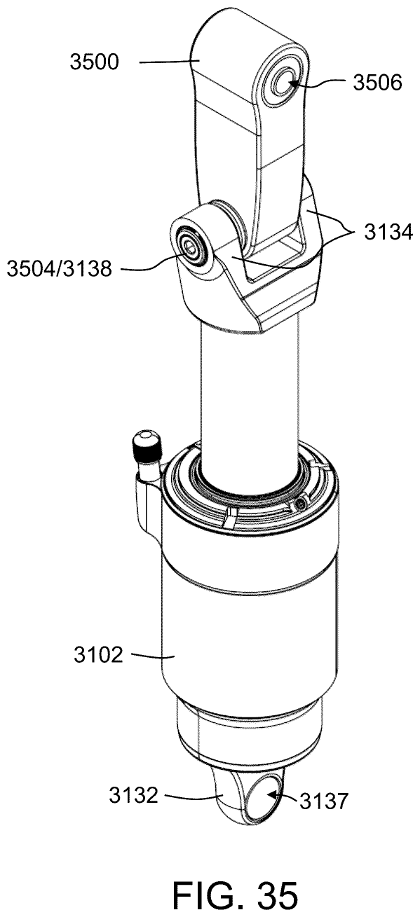

The extender body 3100 can increase a primary mounting length of the shock 3102 by an extension length 3146 to an effective mounting length. Increasing the mounting length of the shock 3102 can provide several improvements to the suspension linkage 3104. For example, when the shock 3102 is mounted to the suspension linkage 3104 in a generally horizontal orientation, as in FIGS. 31A through 32B, increasing the mounting length of the shock 3102 can allow for the shock 3102 to be positioned further forward within the suspension linkage 3104 as compared to a shock without the extender body 3100. Positioning the shock 3102 forward relative to the suspension linkage 3104 can allow for a narrower design of the shock 3102 and the suspension linkage 3104, creating more space within the suspension linkage 3104 to allow for improved shock capability, easier assembly and disassembly of the shock 3102, and room for accessories or components, such as, for example, electric drive components, water bottles, tools, and spare parts. Extender bodies 3100 with different extension lengths 3146 or extender bodies with adjustable extension lengths can be used with shocks 3102 having standard mounting lengths in order to provide custom effective mounting lengths for the shocks 3102, to tune leverage rate curves of the shocks 3102 with the suspension linkage 3104, and the like. Additional examples of extender bodies are discussed below with respect to FIGS. 35 through 38 and all of the extender bodies can be associated with the described benefits of the extender body 3100.

The linkage bodies can include flexible joints, pivots, jointed connections, or the like that can operatively couple the linkage bodies to one another. The flexible joints/pivots/jointed connections can include revolute, slider, cam joints, or any other suitable flexible joints or pivots that allow one degree of freedom of movement between two linkage bodies they connect. The suspension linkage 3104 can include three physical instantaneous velocity centers (IVCs), which are illustrated as pivots or jointed connections between the four linkage bodies of the suspension linkage 3104. Each of the physical IVCs may be a primary instantaneous velocity center (PIVC), which is defined at a joint between two linkage bodies. The physical IVCs include an IVC[3106][3110] 3114, an IVC[3108][3110] 3116, and an IVC[3108][3112] 3118. As illustrated in FIGS. 31A through 32B, the lower link 3112 can be coupled to the suspended body 3106 through a sliding connection between the lower link 3112 and rails 3122. The rails 3122 can be rigidly fixed or mounted to the suspended body 3106. An additional primary IVC, an IVC[3106] 1[3112] 3120 can be defined between the suspended body 3106 and the lower link 3112. The IVC[3106][3112] 3120 can be defined at a center of mass of the lower link 3112. Additional hidden IVCs between each of the linkage bodies of the suspension linkage 3104 can be numerically solved for. A total number of IVCs for the suspension linkage 3104 can be 6, which includes both primary IVCs and hidden IVCs.

The shock 3102 can be the same as or similar to the shock 2702, described above with respect to FIGS. 27 and 28. The shock 3102 can include a forward eyelet 3132 (also referred to as a mount) and rearward mounting tabs 3134. The eyelet 3132 can be coupled to the suspended body 3106 at a joint 3136. The mounting tabs 3134 can be coupled to the extender body 3100 through a joint 3138. The extender body 3100 can be coupled to the upper link 3110 at a joint 3140. The shock 3102 is illustrated as including an eyelet and a mounting tab. In some examples, the extender body 3100 can be applied to shocks with two eyelets (e.g., standard shocks), shocks with one or more trunnion mounts (e.g., trunnion shocks), or the like. For example, the extender body 3100 can be coupled to an eyelet or a trunnion mount. The shock 3102 is further illustrated as being an in-line shock without a piggyback; however, the extender body 3100 can be applied to piggyback shocks.

The extender body 3100 is illustrated as being coupled to the mounting tabs 3134 on a shaft portion of the shock 3102 with the eyelet 3132 on a body portion of the shock 3102. However, the position of the shock 3102 can be flipped such that the extender body 3100 is coupled to mounting tabs of the shock on a body portion of the shock with an eyelet on a shaft portion of the shock. Further, in some examples, the positions of the shock 3102 and the extender body 3100 can be flipped such that an eyelet of the shock (on one of a body portion or a shaft portion of the shock 3102) is coupled to the upper link 3110, mounting tabs of the shock (on the other of the body portion or the shaft portion of the shock 3102) are coupled to the extender body 3100, and the extender body 3100 is coupled to the suspended body 3106.

The suspension linkage 3104 can actuate the shock 3102 as the driven wheel axis 3150 and the shock 3102 move between an extended or uncompressed state (illustrated in FIGS. 31A, 31B, and 32A) and a compressed state (illustrated in FIG. 32B). FIGS. 32A and 32B specifically illustrate how the linkage bodies of the suspension linkage 3104 move as the suspension linkage 3104 and the shock 3102 move between the extended state (illustrated in FIG. 32A) and the compressed state (illustrated in FIG. 32B). An angle α₁ illustrated in FIG. 32B shows the angular movement of a longitudinal axis of the shock 3102 from the extended state, indicated as axis 3103, to the compressed state, indicated as axis 3105.

The shock 3102 can be mounted to the suspended body 3106 with the eyelet 3132 between mounting tabs 3142 of the suspended body 3106. A fastener can be inserted through a first of the mounting tabs 3142, through the eyelet 3132 of the shock 3102, and screwed into threads in a second of the mounting tabs 3142. The fastener can define a pivot axis of the joint 3136. The fastener can extend through an opening 3137 in the eyelet 3132, and the pivot axis can be defined within the opening 3137. Bearings (e.g., bushings, planar bearings, spherical bearings, or other bearings) can be provided to facilitate relative movement between the shock 3102 and the suspended body 3106, such as being provided within the mounting tabs 3142 and/or within the opening 3137 in the eyelet 3132.

As illustrated in FIGS. 31A through 34, the extender body 3100 can include a first extender body 3100a and a second extender body 3100b. In other words, the extender body 3100 includes two body portions or components, the extender bodies 3100a, 3100b. The extender bodies 3100a, 3100b can each be relatively linear or I-shaped components.

The extender bodies 3100a, 3100b can be coupled to the mounting tabs 3134 of the shock 3102 at the joint 3138. The extender bodies 3100a, 3100b can be coupled to the upper link 3110 at the joint 3140. The extender bodies 3100a, 3100b can be coupled to the shock 3102 and to the upper link 3110 by any suitable attachment mechanism, such as a fastener that can include a bolt, a machine screw, a pin, a collet axle, or the like. The extender bodies 3100a, 3100b can include bearings 3302 (e.g., bushings, planar bearings, spherical bearings, or other bearings) that allow for rotation between the extender bodies 3100a, 3100b and each of the shock 3102 and the upper link 3110. For example, the extender bodies 3100a, 3100b can rotate relative to the upper link 3110 about an axis defined by the joint 3140. The extender bodies 3100a, 3100b can rotate relative to the shock 3102 about an axis defined by the joint 3138. Providing floating threads for the joints 3138, 3140, or providing spherical bearings in the extender bodies 3100a, 3100b, the shock 3102, and/or the upper link 3110 can allow for additional degrees of freedom in the rotation of the extender bodies 3100a, 3100b relative to the shock 3102 and the upper link 3110, and can allow for greater degrees of misalignment between the extender bodies 3100a, 3100b and each of the shock 3102 and the upper link 3110.

The extender bodies 3100a, 3100b can include openings 3306 through which a fastener extends to secure the extender bodies 3100a, 3100b to the upper link 3110 at the joint 3140. Caps 3310 can be provided in the openings 3306 to protect the bearings 3302 disposed in the openings 3306 from damage, contaminants, and the like.

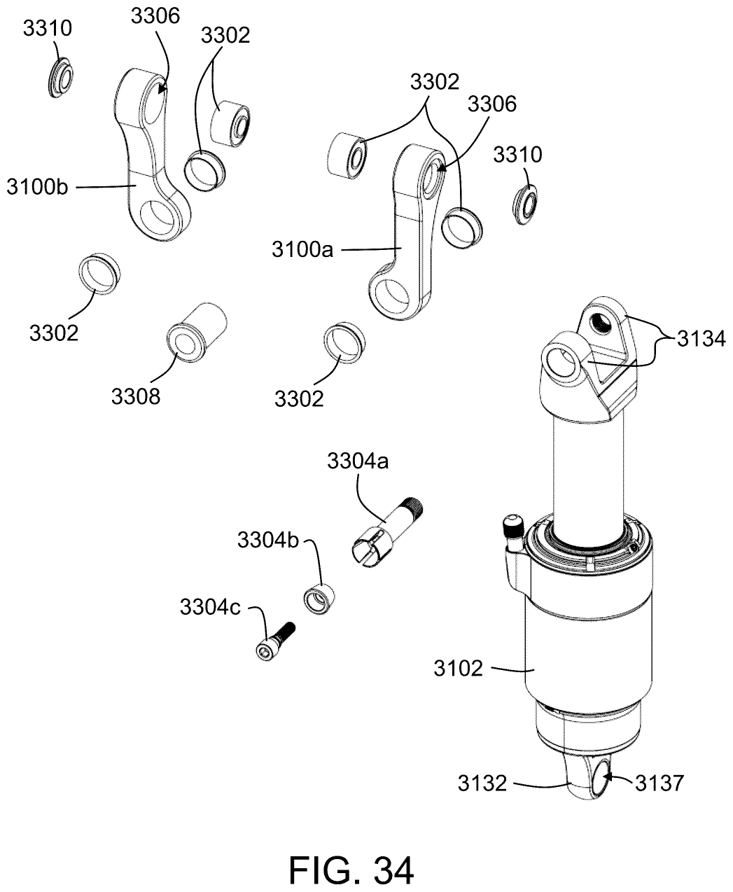

The extender body 3100 can be secured to the shock 3102 by a collet axle 3304. The collet axle 3304 can include a collet 3304a, a taper 3304b, and a cap 3304c. As illustrated in FIG. 34, the collet 3304a can be inserted through a first of the mounting tabs 3134 of the shock 3102, through a spacer 3308 (that extends through bearings 3302 in the extender bodies 3100a, 3100b) and screwed into threads in a second of the mounting tabs 3134 of the shock 3102. The collet 3304a can include an inner tapered surface and the taper 3304b can include a corresponding outer tapered surface. The cap 3304c can be inserted into the taper 3304b and screwed into the collet 3304a such that the tapered surfaces of the taper 3304b and the collet 3304a interface with one another, the collet 3304a expands, and interference between the collet 3304a and the first mounting tab 3134 can secure the collet axle 3304 in the first mounting tab 3134. Securing the extender body 3100 to the shock 3102 using the collet axle 3304 can allow for large tolerances in dimensions of the extender body 3100 and the mounting tabs 3134 of the shock 3102 and prevents the bearings 3302 from being overloaded. However, other fasteners can also be used. For example, the extender body 3100 can be secured to the shock 3102 by a bolt that extends through the first mounting tab 3134 and the spacer 3308 and is screwed into the threads of the second mounting tab 3134.

Pivot axes of the opening 3137 and the openings 3306 (e.g., used to form joints 3136, 3140, respectively, with the suspension linkage 3104) can be parallel to each other and can be clocked or nonparallel (e.g., perpendicular) to a pivot axis between the extender body 3100 and the shock 3102 defined by the collet axle 3304 (e.g., at the joint 3138). This allows for relative motion between the extender body 3100, the shock 3102, and the suspension linkage 3104 as the extender body 3100 and the shock 3102 are being mounted on the suspension linkage 3104, but provides a rigid, non-rotating connection between the pivot axis of the opening 3137 and the pivot axes of the openings 3306 when the extender body 3100 and the shock 3102 are mounted on the suspension linkage 3104. In other words, the shock 3102 and the extender body 3100 can be constrained in a rigid non-rotating connection with one another when the shock 3102 and the extender body 3100 are mounted to the suspension linkage 3104.

As illustrated in FIG. 34, various bearings 3302 can be positioned within the connection between the extender body 3100 and the shock 3102. The bearings 3302 can be bushings, planar bearings, spherical bearings, other bearings, friction reducers, friction reducing elements, or the like. In the example of FIGS. 31A through 34, the bearings 3302 include four bearings 3302, with two bearings 3302 provided for each of the extender bodies 3100a, 3100b. One bearing 3302 can be provided on each side of each of the extender bodies 3100a, 3100b. The bearings 3302 can allow for low-friction or frictionless movement between the shock 3102 and each of the extender bodies 3100a, 3100b forming the extender body 3100. Movement between the shock 3102 and the extender body 3100 can be a result of misalignment of suspension elements of the suspension linkage 3104. Providing the bearings 3302 between the extender body 3100 and the shock 3102 can reduce wear on the shock 3102 caused by movement and misalignment between components of the suspension linkage 3104 and the shock 3102. An axis of the joint 3138 between the shock 3102 and the extender body 3100 can be clocked (e.g., nonparallel to) mounting axes of the extender body 3100 and the shock 3102 that are coupled to the suspension linkage 3104 (e.g., the joints 3140, 3136, respectively). This can provide for rigid coupling of the extender body 3100 and the shock 3102 to the suspension linkage 3104, while allowing for some slight movement between the shock 3102 and the extender body 3100.

### Extender Body—Example 2—1-Part Extender Body

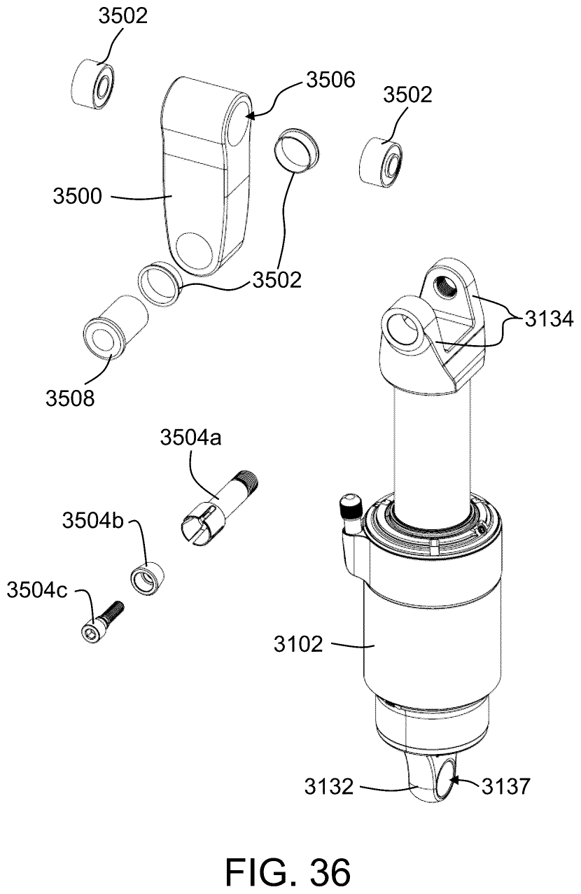

FIGS. 35 and 36 illustrate various views of an extender body 3500 coupled to a shock 3102. The extender body 3500 can include a single body portion or body component and can be a single-component body or a unitary body. The extender body 3500 can each be relatively linear or I-shaped.

The extender body 3500 can be coupled to mounting tabs 3134 of the shock 3102 at a joint 3138. Similar to the extender body 3100, the extender body 3500 can be coupled to an upper link 3110 of a suspension linkage 3104 at a joint 3140. The extender body 3500 can be coupled to the shock 3102 and to the upper link 3110 by any suitable attachment mechanism, such as a fastener that can include a bolt, a machine screw, a pin, a collet axle, or the like. The extender body 3500 can include bearings 3502 (e.g., bushings, planar bearings, spherical bearings, or other bearings) that allow for rotation between the extender body 3500 and each of the shock 3102 and the upper link 3110. For example, the extender body 3500 can rotate relative to the upper link 3110 about an axis defined by the joint 3140. The extender body 3500 can rotate relative to the shock 3102 about an axis defined by the joint 3138. Providing floating threads for the joints 3138, 3140, or providing spherical bearings in the extender body 3500, the shock 3102, and/or the upper link 3110 can allow for additional degrees of freedom in the rotation of the extender body 3500 relative to the shock 3102 and the upper link 3110 and can allow for greater degrees of misalignment between the extender body 3500 and each of the shock 3102 and the upper link 3110. The extender body 3500 can include an opening 3506 through which a fastener extends to secure the extender body 3500 to the upper link 3110 at the joint 3140.

The extender body 3500 can be secured to the shock 3102 by a collet axle 3504. The collet axle 3504 can include a collet 3504a, a taper 3504b, and a cap 3504c. As illustrated in FIG. 36, the collet 3504a can be inserted through a first of the mounting tabs 3134 of the shock 3102, through a spacer 3508 (that extends through bearings 3502 in the extender body 3500) and screwed into threads in a second of the mounting tabs 3134 of the shock 3102. The collet 3504a can include an inner tapered surface and the taper 3504b can include a corresponding outer tapered surface. The cap 3504c can be inserted into the taper 3504b and screwed into the collet 3504a such that the tapered surfaces of the taper 3504b and the collet 3504a interface with one another, the collet 3504a expands, and interference between the collet 3504a and the first mounting tab 3134 can secure the collet axle 3504 in the first mounting tab 3134. Securing the extender body 3500 to the shock 3102 using the collet axle 3504 can allow for large tolerances in dimensions of the extender body 3500 and the mounting tabs 3134 of the shock 3102 and prevents the bearings 3502 from being overloaded. However, other fasteners can also be used. For example, the extender body 3500 can be secured to the shock 3102 by a bolt that extends through the first mounting tab 3134 and the spacer 3508 and is screwed into the threads of the second mounting tab 3134.

Pivot axes of the opening 3137 and the opening 3506 (e.g., used to form joints 3136, 3140, respectively, with the suspension linkage 3104) can be parallel to each other and can be clocked or nonparallel (e.g., perpendicular) to a pivot axis between the extender body 3500 and the shock 3102 defined by the collet axle 3504 (e.g., at the joint 3138). This allows for relative motion between the extender body 3500, the shock 3102, and the suspension linkage 3104 as the extender body 3500 and the shock 3102 are being mounted on the suspension linkage 3104, but provides a rigid, non-rotating connection between the pivot axis of the opening 3137 and the pivot axis of the opening 3506 when the extender body 3500 and the shock 3102 are mounted on the suspension linkage 3104. In other words, the shock 3102 and the extender body 3500 can be constrained in a rigid non-rotating connection with one another when the shock 3102 and the extender body 3500 are mounted to the suspension linkage 3104.

As illustrated in FIG. 36, various bearings 3502 can be positioned within the connection between the extender body 3500 and the shock 3102. The bearings 3502 can be bushings, planar bearings, spherical bearings, other bearings, friction reducers, friction reducing elements, or the like. In the example of FIGS. 35 and 36, the bearings 3502 include two bearings 3502, with one bearing 3502 provided on each side of each of the extender body 3500. The bearings 3502 can allow for low-friction or frictionless movement between the shock 3102 and the extender body 3500. Movement between the shock 3102 and the extender body 3500 can be a result of misalignment of suspension elements of the suspension linkage 3104. Providing the bearings 3502 between the extender body 3500 and the shock 3102 can reduce wear on the shock 3102 caused by movement and misalignment between components of the suspension linkage 3104 and the shock 3102. An axis of the joint 3138 between the shock 3102 and the extender body 3500 can be clocked (e.g., nonparallel to) mounting axes of the extender body 3500 and the shock 3102 that are coupled to the suspension linkage 3104 (e.g., the joints 3140, 3136, respectively). This can provide for rigid coupling of the extender body 3500 and the shock 3102 to the suspension linkage 3104, while allowing for some slight movement between the shock 3102 and the extender body 3500.

### Extender Body—Example 3—2-Part Extender Body

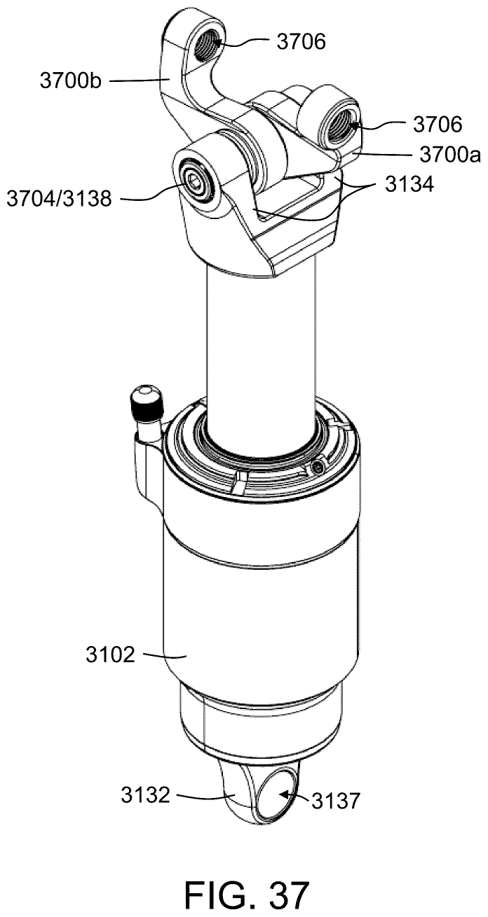

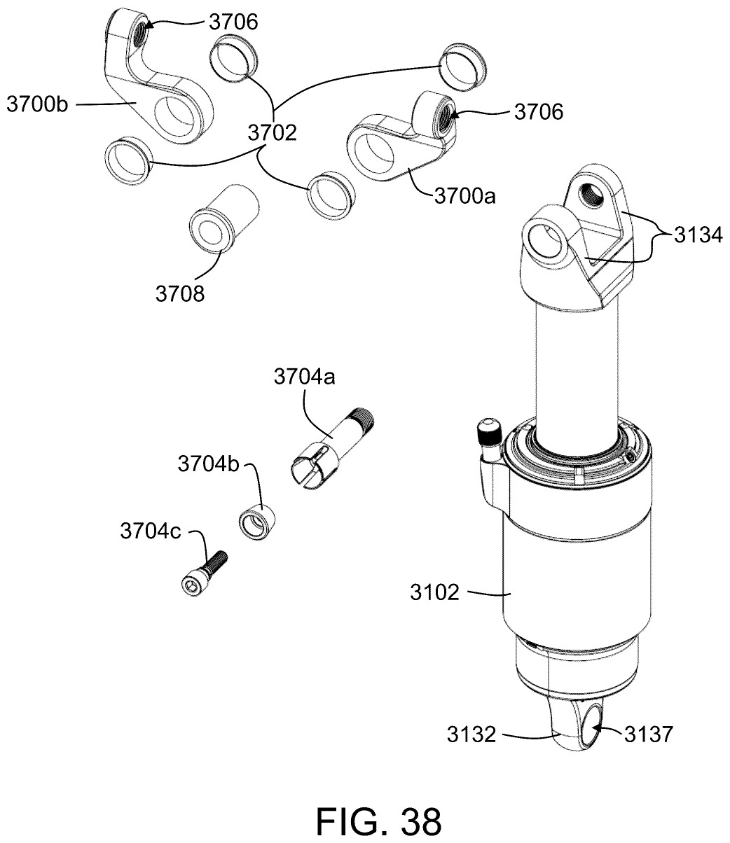

FIGS. 37 and 38 illustrate various views of an extender body 3700 coupled to a shock 3102. As illustrated in FIGS. 37 and 38, the extender body 3700 can include a first extender body 3700a and a second extender body 3700b. In other words, the extender body 3700 includes two body portions or components, the extender bodies 3700a, 3700b. The extender body 3700 can be U-shaped with each of the extender bodies 3700a, 3700b forming half of the U-shape of the extender body 3700.

The extender body 3700 can be coupled to mounting tabs 3134 of the shock 3102 at a joint 3138. Similar to the extender body 3100, the extender body 3700 can be coupled to an upper link 3110 of a suspension linkage 3104 at a joint 3140. The extender body 3700 can be coupled to the shock 3102 and to the upper link 3110 by any suitable attachment mechanism, such as a fastener that can include a bolt, a machine screw, a pin, a collet axle, or the like. The extender body 3700 can include bearings 3702 (e.g., bushings, planar bearings, spherical bearings, or other bearings) that allow for rotation between the extender body 3700 and each of the shock 3102 and the upper link 3110. For example, the extender body 3700 can rotate relative to the upper link 3110 about an axis defined by the joint 3140. The extender body 3700 can rotate relative to the shock 3102 about an axis defined by the joint 3138. Providing floating threads for the joints 3138, 3140, or providing spherical bearings in the extender body 3700, the shock 3102, and/or the upper link 3110 can allow for additional degrees of freedom in the rotation of the extender body 3700 relative to the shock 3102 and the upper link 3110 and can allow for greater degrees of misalignment between the extender body 3700 and each of the shock 3102 and the upper link 3110. The extender body 3700 can include openings 3706 through which respective fasteners extend to secure the extender body 3700 to the upper link 3110 at the joint 3140.

In the example of FIGS. 31A through 34 and the example of FIGS. 35 and 36, a single fastener can be used to secure the extender bodies 3100, 3500 to the suspension linkage 3104. In the example of FIGS. 37 and 38, two fasteners can be used to secure the extender body 3700 to the suspension linkage. For example, a first fastener can be inserted through the upper link 3110 (e.g., a drive side of the upper link 3110) and screwed into threads in the opening 3706 in the extender body 3700a. A second fastener can be inserted through the upper link 3110 (e.g., a non-drive side of the upper link 3110) and screwed into threads in the opening 3706 in the extender body 3700b. The joint 3140 can be defined by axes extending through each of the first and second fastener. Floating threads can be included in the openings 3706 and/or spherical bearings can be included in the upper link 3110 to allow for additional degrees of freedom in the rotation of the extender body 3700 relative to the upper link 3110 and can allow for greater degrees of misalignment between the extender body 3700 and the upper link 3110.

The extender body 3700 can be secured to the shock 3102 by a collet axle 3704. The collet axle 3704 can include a collet 3704a, a taper 3704b, and a cap 3704c. As illustrated in FIG. 38, the collet 3704a can be inserted through a first of the mounting tabs 3134 of the shock 3102, through a spacer 3708 (that extends through bearings 3702 in the extender body 3700) and screwed into threads in a second of the mounting tabs 3134 of the shock 3102. The collet 3704a can include an inner tapered surface and the taper 3704b can include a corresponding outer tapered surface. The cap 3704c can be inserted into the taper 3704b and screwed into the collet 3704a such that the tapered surfaces of the taper 3704b and the collet 3704a interface with one another, the collet 3704a expands, and interference between the collet 3704a and the first mounting tab 3134 can secure the collet axle 3704 in the first mounting tab 3134. Securing the extender body 3700 to the shock 3102 using the collet axle 3704 can allow for large tolerances in dimensions of the extender body 3700 and the mounting tabs 3134 of the shock 3102 and prevents the bearings 3702 from being overloaded. However, other fasteners can also be used. For example, the extender body 3700 can be secured to the shock 3102 by a bolt that extends through the first mounting tab 3134 and the spacer 3708 and is screwed into the threads of the second mounting tab 3134.

Pivot axes of the opening 3137 and the opening 3706 (e.g., used to form joints 3136, 3140, respectively, with the suspension linkage 3104) can be parallel to each other and can be clocked or nonparallel (e.g., perpendicular) to a pivot axis between the extender body 3700 and the shock 3102 defined by the collet axle 3704 (e.g., at the joint 3138). This allows for relative motion between the extender body 3700, the shock 3102, and the suspension linkage 3104 as the extender body 3700 and the shock 3102 are being mounted on the suspension linkage 3104, but provides a rigid, non-rotating connection between the pivot axis of the opening 3137 and the pivot axis of the opening 3706 when the extender body 3700 and the shock 3102 are mounted on the suspension linkage 3104. In other words, the shock 3102 and the extender body 3700 can be constrained in a rigid non-rotating connection with one another when the shock 3102 and the extender body 3700 are mounted to the suspension linkage 3104.

As illustrated in FIG. 38, various bearings 3702 can be positioned within the connection between the extender body 3700 and the shock 3102. The bearings 3702 can be bushings, planar bearings, spherical bearings, other bearings, friction reducers, friction reducing elements, or the like. In the example of FIGS. 37 and 38, the bearings 3702 include four bearings 3702, with two bearings 3702 provided for each of the extender bodies 3700a, 3700b. One bearing 3702 can be provided on each side of each of the extender bodies 3700a, 3700b. The bearings 3702 can allow for low-friction or frictionless movement between the shock 3102 and the extender body 3700. Movement between the shock 3102 and the extender body 3700 can be a result of misalignment of suspension elements of the suspension linkage 3104. Providing the bearings 3702 between the extender body 3700 and the shock 3102 can reduce wear on the shock 3102 caused by movement and misalignment between components of the suspension linkage 3104 and the shock 3102. An axis of the joint 3138 between the shock 3102 and the extender body 3700 can be clocked (e.g., nonparallel to) mounting axes of the extender body 3700 and the shock 3102 that are coupled to the suspension linkage 3104 (e.g., the joints 3140, 3136, respectively). This can provide for rigid coupling of the extender body 3700 and the shock 3102 to the suspension linkage 3104, while allowing for some slight movement between the shock 3102 and the extender body 3700.

### General Examples of the Present Disclosure

A suspension assembly for a two-wheeled vehicle may be described and shown herein, for instance in the examples provided. The two-wheeled vehicle includes a suspended body, a rear linkage, and a suspension resistance device. The suspended body and the rear linkage can define a suspension linkage of the two-wheeled vehicle. The suspension resistance device resists movement of the suspension linkage. The suspension resistance device defines at least two primary mounting features, each at a mounting location. Each primary mounting feature, in some examples, includes an aperture defining an axis. The aperture may, in one example, be threaded to receive a threaded fastener for securement to another structure to which it may connected. The aperture may receive a bearing or bushing to facilitate a pivotal joint with another structure to which it may connected. The bearing or bushing may have a threaded internal diameter to receive a threaded fastener. The primary mounting features on a suspension resistance device may define aperture axes that are parallel to each other, or in other examples may define aperture axes that are nonparallel to each other. Nonparallel aperture axes may be offset by angles of more than 0 degrees, more than 15 degrees, more than 30 degrees, more than 45 degrees, more than 60 degrees, more than 75 degrees, and up to and including 90 degrees.

In one example the mounting locations of the primary mounting features may be at opposing ends of the suspension resistance device, such as for example with a standard shock. In other examples the mounting location of one of the primary mounting features may be at an end of the suspension resistance device, with another primary mounting feature located along the length of the suspension resistance device, such as for example with a trunnion shock.

The distance between the at least two primary mounting features defines a primary mounting length. The primary mounting length may range between a first primary mounting length at a first state or configuration and a second primary mounting length at a second state or configuration. The first state or configuration may be an extended configuration and the second state or configuration may be a compressed configuration, or vice versa. The primary mounting length in the extended configuration may be greater than the primary mounting length in the compressed configuration.

Regarding the examples provided herein, and including at least that described above, the suspension resistance device may be connected at one, or first, primary mounting feature to the suspended body, and maybe be coupled at the other, or 2^{nd}, primary mounting feature to the suspension linkage. In this example, the suspension resistance device may be coupled to the suspension linkage by at least one reducing body.

Regarding the examples provided herein, and including at least that described above, the at least one reducing body may be connected between the suspension resistance device and the suspension linkage. In one example, the reducing body may be a positioning bracket. The reducing body may include at least two connecting features each at a connecting location. The distance between the at least two connecting features defines a reduction length (also an offset length). The reduction length may be defined by the desired dynamic performance of the suspension system in combination with the suspension resistance device. For example, the reduction length may be from less than 1 mm to about 5 mm, or to about 10 mm, or to about 15 mm, or to about 20 mm, or to about 25 mm, or to about 30 mm, or greater.

In one example, one connecting feature of the reducing body may attach to the suspension linkage, which in one example may be a pivotal connection. The other connecting feature of the reducing body may attach to a primary mounting feature of the suspension resistance device, which may be in one example a rigid connection or in another example may be a pivotal connection.

In some examples the other or second mounting feature of the reducing body may be attached to the suspension linkage. The attachment to the suspension linkage may be by a pivotal connection.

By attaching the reducing body to the suspension resistance device, the primary length of the suspension resistance device may be changed to an effective shock length. In some examples, the reducing body offsets or decreases the primary mounting length. In some examples the reducing body offsets the first primary mounting length. In some examples the reducing body offsets the second primary mounting length. In some examples the reducing body offsets the first and second primary mounting lengths by about the same amount

Additionally, in some examples, for example with respect to at least the structures of the examples provided herein, in one example, the primary mounting length of the suspension resistance device may be defined as the distance between first mounting feature and the second mounting feature, each mounting feature including an aperture defining an axis. In one example the axes of the mounting features are non-parallel. In one example, the reducing body may be rigidly connected to one of the apertures.

With continuing reference to the two-wheeled vehicle suspension assembly of the examples provided herein, and particularly with respect to a trunnion shock, in another example, the primary mounting length of the suspension resistance device may be defined as the distance between a mounting feature at one end of the suspension resistance device, and a mounting feature located along a length of the suspension resistance device. Each mounting feature may include an aperture defining an axis. The reducing body may be rigidly connected to one of the mounting features, and the axes of the mounting features may be nonparallel.

Continuing with respect to the two-wheeled vehicle suspension assembly of the examples provided herein, in another example (e.g., the example illustrated in FIGS. 12 and 13), the primary mounting length of the suspension resistance device may be defined as the distance between a mounting feature at one end of the suspension resistance device, and a mounting feature defined on a planar surface located at an opposite end of the suspension resistance device. The reducing body may be rigidly connected to the planar feature.

In another example of the present disclosure, a two-wheeled vehicle with a suspension assembly can include a suspended body (e.g., a front frame), a rear linkage (e.g., a rear frame), and a suspension resistance device (e.g., a shock) connected between the suspended body and the rear linkage. The suspension resistance device defines first and second opposing ends. One of the first and second opposing ends defines a first mounting feature and the other of the first and second opposing ends defines a second mounting feature. A primary mounting length may be defined by a distance between the first and second mounting features. A reducing body, such as an instender bracket, may be connected at a first connecting feature to one of the first or second mounting features of the suspension resistance device. The other one of the first or second mounting features of the suspension resistance device may be connected to the suspended body (e.g., the front frame). The instender bracket may also be connected at a second connection feature to the rear linkage. The distance between the connection feature on the instender bracket that may be attached to the rear linkage and the mounting feature of the suspension resistance device that may be connected to the suspended body defines an effective mounting length of the instender bracket and the suspension resistance device. The effective mounting length may be less than the primary mounting length of the suspension resistance device. In one example, this difference in length may referred to as a reduction length.

In another example, a two-wheeled vehicle with a suspension assembly may include a front frame (e.g., a suspended body), a rear frame (e.g., a chainstay and a seatstay), and a suspension linkage (e.g., linkage bodies connecting the chainstay and seatstay to the suspended body, such as an upper link, a center link, and a lower link). The suspension linkage may be attached to the rear frame and the front frame, and a suspension resistance device may be connected between suspension linkage and the front frame. The suspension resistance device can include a first portion and a second portion that may move relative to one another, such as in a longitudinal direction (e.g., along a length of each of the first and second portions). In one example, the first portion and second portion may be movably connected at inner ends and configured to move telescopically relative to one another. Each of the first and second portions may define a respective first and second outer end. The first portion may define a first mounting feature at, near or adjacent to the first outer end. The second portion may define a second mounting feature at, near or adjacent to the second outer end. The distance between the first and second mounting features may be referred to as a primary mounting length of the suspension resistance device.

The first outer end of the suspension resistance device may be connected, such as, for example, at the first mounting feature to the suspension linkage by a reducing body. The reducing body may be an instender bracket. The second mounting feature of the suspension resistance device may be attached to the front frame. The reducing body may define a first connection feature attached to the first mounting feature of the suspension resistance device. The reducing body may define a second connection feature attached to the suspension linkage. The reducing body may include a body portion that extends from the first mounting feature on the suspension resistance device and along at least part of the length of the first portion to the second connection feature on the reducing body, which as noted above, may be attached to the suspension linkage. The distance between the first connection feature and the second connection feature of the reducing body defines a reduction length. The reducing body reduces the primary mounting length of the suspension resistance device by the reduction length, which then establishes an effective mounting length of the suspension resistance device.

One example of the present disclosure relates to a two wheeled vehicle suspension assembly including a suspended body; a rear frame; a suspension linkage, wherein the suspended body, the rear frame, and the suspension linkage include a plurality of links movably joined together; a suspension resistance device including at least two primary mounting features defining a primary mounting length therebetween, the suspension resistance device operably coupled at the at least two primary mounting features between at least two of the movably joined links to define a dynamic performance of the rear frame with respect to the suspended body when actuated between a first configuration and a second configuration; and at least one reducing body connected between one of the primary mounting features of the suspension resistance device and one of the at least two movably joined links, the at least one reducing body reducing the primary mounting length by a reduction length.

In some examples, the at least two mounting features to which the suspension resistance device is operably coupled can be the suspension linkage and the suspended body. In some examples, the reducing body can be rigidly connected at one of the two primary mounting features. In some examples, the reducing body can be connected to the suspension resistance device and can be operably connected to the suspension linkage.

In some examples, the reducing body can reduce the primary mounting length by the same amount in both the first configuration and the second configuration. In some examples, each of the primary mounting feature can include an aperture defining an axis. The primary mounting length can be defined by a distance between the axes of each of the two apertures. The axes of the apertures can be non-parallel.

In some examples, one of the at least two primary mounting features can be located adjacent an end of the suspension resistance device. The other of the at least two primary mounting features can be located along the length of the suspension resistance device. Each of the primary mounting features can include an aperture defining an axis. The reducing body can be rigidly connected to the primary mounting features. The axes of the apertures can be non-parallel. In some examples, the aperture of one of the at least two primary mounting features located along the length of the suspension resistance device can be threaded.

In some examples, the suspension resistance device can include a shaft and a body. The primary mounting feature attached along the length of the suspension resistance device can be positioned on the body.

In some examples, one end of the suspension resistance device can define a surface extending generally laterally across the suspension resistance device. One of the at least two primary mounting fixtures can be formed on the lateral surface. The reducing body can be rigidly connected to the lateral surface. In some examples, the lateral surface can be planar. In some examples, the one of the at least two primary mounting fixtures can be an aperture.

Another example of the present disclosure relates to a two wheeled vehicle including a suspension assembly including a front frame and a rear frame; a suspension linkage operably coupled between the front frame and the rear frame; and a suspension resistance device coupled between the suspension linkage and the front frame. The suspension resistance device can define first and second opposing ends. One of the first and second opposing ends can define a first mounting feature and the other of the first and second opposing ends can define a second mounting feature. A distance between the first and second mounting features can define a primary shock length. An instender bracket can define a first connection feature and a second connection feature. The first connection feature can be connected to one of the first or second mounting features and the second connection feature can be connected to the suspension linkage (also referred to as a linkage system). A distance between the connection feature on the instender bracket attached to the suspension linkage and the mounting feature of the suspension resistance device connected to the suspended body can define an effective mounting length. In some examples, the effective shock length can be less than the primary mounting length.

Yet another example of the present disclosure relates to a two wheeled vehicle including a suspension assembly including a front frame, a rear frame, and a suspension linkage including a plurality of link bodies. The suspension linkage can be movably attached to the rear frame and coupled with the front frame. A suspension resistance device can be coupled between suspension linkage and the front frame. The suspension resistance device can include a first portion and a second portion movably coupled at respective inner ends and configured to move telescopically relative to one another. Each of the first and second portions can define a respective first and second outer end. One of the outer ends can be coupled with the front frame and the other of the outer ends can be coupled with the suspension linkage. The first portion can define a mounting feature and the second portion can define a mounting feature, wherein a distance between the mounting features can define a primary mounting length. The suspension assembly for the two wheeled vehicle can further include a reducing body having a body portion defining at least two connection features. A distance between the at least two connection features can define a reduction length. One connection feature can be connected to the suspension linkage and the other connection feature can be connected to a mounting feature on a portion of the suspension resistance device coupled with the suspension linkage. A distance from the connection feature on the reducing body that can be attached to the suspension linkage to the mounting feature on the suspension resistance device attached to the front frame can define an effective mounting length. The effective mounting length can be less than the primary mounting length by approximately the reduction length.

In some examples, the body portion can extend from the first mounting feature along at least part of the length of the first portion to the one of the connection features attached to the suspension linkage.

In any of the above examples, the reducing body can include one or more components. In any of the above examples, at least one connection feature on a reducer body can include a flip chip to allow modification of the geometry of a suspension assembly.

All relative and directional references (including upper, lower, upward, downward, left, right, leftward, rightward, top, bottom, side, above, below, front, middle, back, vertical, horizontal, and so forth) are given by way of example to aid the reader's understanding of the particular examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

It may be possible to express at least some of the novel and inventive features of the present disclosure by reference to one or more of the following numbered clauses.

Those skilled in the art will appreciate that the presently disclosed examples teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A two-wheeled vehicle suspension assembly comprising:
a plurality of links movably joined together, the plurality of links comprising a suspended body and a rear frame and defining a suspension linkage;
a suspension resistance device comprising a first primary mounting feature and a second primary mounting feature, the suspension resistance device defining a primary mounting length between the first and second primary mounting features; and
a reducing body coupled between the suspension resistance device and the plurality of links;
wherein:
the suspension resistance device is operably coupled at the first and second primary mounting features between at least two links of the plurality of links;
the suspension resistance device defines a dynamic performance of the rear frame with respect to the suspended body when actuated between a first configuration and a second configuration;
the reducing body is coupled to the first primary mounting feature and one of the at least two links of the plurality of links; and
the reducing body reduces the primary mounting length by a reduction length.

2. The two-wheeled vehicle suspension assembly of claim 1, wherein the at least two links of the plurality of links to which the suspension resistance device is operably coupled comprise the suspension linkage and the suspended body.

3. The two-wheeled vehicle suspension assembly of claim 1, wherein the reducing body is operably coupled to the suspension resistance device and the suspension linkage.

4. The two-wheeled vehicle suspension assembly of claim 1, wherein the reducing body is rigidly coupled to the suspension resistance device.

5. The two-wheeled vehicle suspension assembly of claim 1, wherein the reducing body reduces the primary mounting length by the reduction length in both the first configuration and the second configuration.

6. The two-wheeled vehicle suspension assembly of claim 1, wherein:
the first primary mounting feature includes a first aperture defining a first axis;
the second primary mounting feature includes a second aperture defining a second axis;
the primary mounting length is defined by a distance between the first axis and the second axis; and
the first axis is nonparallel to the second axis.

7. The two-wheeled vehicle suspension assembly of claim 1, wherein:
one of the first or second primary mounting features is located adjacent a first end of the suspension resistance device;
the other of the first or second primary mounting features is located along a length of the suspension resistance device;
the first primary mounting feature includes a first aperture defining a first axis;
the second primary mounting feature includes a second aperture defining a second axis;
the reducing body is rigidly coupled to the first primary mounting feature; and
the first axis is nonparallel to the second axis.

8. The two-wheeled vehicle suspension assembly of claim 7, wherein the first or second aperture of the other of the first or second primary mounting features is threaded.

9. The two-wheeled vehicle suspension assembly of claim 7, wherein:
the suspension resistance device comprises a shaft and a body; and
the other of the first or second primary mounting features is positioned on the body.

10. The two-wheeled vehicle suspension assembly of claim 1, wherein:
one end of the suspension resistance device defines a surface extending laterally across the suspension resistance device;
the first primary mounting feature is formed on the surface; and
the reducing body is rigidly coupled to the surface.

11. The two-wheeled vehicle suspension assembly of claim 10, wherein the surface is planar.

12. The two-wheeled vehicle suspension assembly of claim 11, wherein the first primary mounting feature comprises an aperture in the surface.

13. A two-wheeled vehicle including a suspension assembly comprising:
a suspended body;
a suspension linkage coupled to the suspended body;
a suspension resistance device coupled between the suspended body and the suspension linkage; and
an instender bracket defining a first connection feature and a second connection feature;
wherein:
the suspension resistance device defines a first end and a second end opposite the first end;
the first end defines a first mounting feature;
the second end defines a second mounting feature;
a distance between the first and second mounting features defines a primary shock length;
the first connection feature is coupled to one of the first or second mounting features;
the second connection feature is coupled to the suspension linkage; and
a distance between the second connection feature and the other of the first or second mounting features defines an effective shock length.

14. The two-wheeled vehicle of claim 13, wherein the effective shock length is less than the primary shock length.

15. A two-wheeled vehicle including a suspension assembly comprising:
a front frame;
a suspension linkage comprising a plurality of link bodies, the suspension linkage movably coupled with the front frame;
a reducing body comprising a body portion defining a first connection feature and a second connection feature, a distance between the first connection feature and the second connection feature defining a reduction length; and
a suspension resistance device coupled between the suspension linkage and the front frame, the suspension resistance device comprising:
a first portion comprising a first inner end and a first outer end and defining a first mounting feature; and
a second portion comprising a second inner end and a second outer end and defining a second mounting feature;
wherein:
the second portion is movably coupled to the first portion at the first and second inner ends;
the first and second portions are configured to move telescopically relative to one another;
the first outer end is coupled with the front frame;
the second outer end is coupled with the suspension linkage;
a distance between the first and second mounting features defines a primary mounting length;
the first connection feature is coupled to the suspension linkage;
the second connection feature is coupled to the second mounting feature of the suspension resistance device;
a distance from the first connection feature to the first mounting feature defines an effective mounting length; and
the effective mounting length is less than the primary mounting length by the reduction length.

16. The two-wheeled vehicle of claim 15, wherein the body portion extends from the second mounting feature along at least part of a length of the second portion to the first connection feature.

17. The two-wheeled vehicle of claim 15, wherein:
the body portion is a first component; and
the reducing body further comprises a second component.

18. The two-wheeled vehicle of claim 15, wherein:
the first or second connection feature comprises a flip chip; and
the reducing body defines a first reduction length or a second reduction length depending on an orientation of the flip chip.

19. A reducer body for a suspension linkage comprising:
a first mounting axis configured to couple the reducer body to a suspension linkage; and
a second mounting axis configured to couple the reducer body to a shock;
wherein:
the first mounting axis is nonparallel to the second mounting axis; and
the reducer body is configured to reduce an effective mounting length of the shock.

20. The reducer body of claim 19, wherein:
the first mounting axis is defined at a first aperture; and
the first aperture is threaded.

21. The reducer body of claim 19, wherein the reducer body comprises a first component and a second component coupled to the first component at the second mounting axis.

22. The reducer body of claim 21, wherein the second body is disposed between a first portion and a second portion of the first body.

23. The reducer body of claim 21, wherein the reducer body is configured to be coupled to the shock with a mounting feature of the shock between the first and second bodies.

24. The reducer body of claim 19, wherein the first mounting axis and the second mounting axis are configured to pivotally couple the reducer body to the suspension linkage and the shock, respectively.

25. The reducer body of claim 19, wherein the first mounting axis is configured to pivotally couple the reducer body to the suspension linkage and the second mounting axis is configured to rigidly couple the reducer body to the shock.

26. The reducer body of claim 19, wherein:
the reducer body comprises a first connection feature and a second connection feature; and
the reducer body is configured to be coupled to the shock with a mounting feature of the shock between the first and second connection features.

27. The reducer body of claim 19, wherein the second mounting axis is defined at an aperture, the aperture comprising threads.

28. The reducer body of claim 19, further comprising a flip chip, wherein:
the first or second mounting axis is defined by an aperture of the flip chip; and
the reducer body is configured to reduce the effective mounting length of the shock by a different reduction length depending on an orientation of the flip chip.

29. The reducer body of claim 19, wherein the reducer body is configured to be coupled between a first mounting feature and a second mounting feature of the shock.

30. The reducer body of claim 19, wherein:
an inner diameter of the reducer body is configured to extend along a portion of a length of the shock; and
the inner diameter is greater than an outer diameter of a shaft portion of the shock and less than an outer diameter of a body portion of the shock.

31. An extender body for a suspension linkage comprising:
a first mounting axis configured to pivotally couple the extender body to a suspension linkage;
a friction reducer; and
a second mounting axis extending through the friction reducer and configured to pivotally couple the extender body to a shock;
wherein:
the first mounting axis is nonparallel to the second mounting axis; and
the extender body is configured to increase an effective mounting length of the shock.

32. The extender body of claim 31, wherein:
the first mounting axis is defined at a first aperture; and
the first aperture is threaded.

33. The extender body of claim 31, wherein the extender body comprises a first component and a second component coupled to the first component at the second mounting axis.

34. The extender body of claim 33, wherein the first mounting axis is defined at a first aperture in the first component and a second aperture in the second component.

35. The extender body of claim 34, wherein the first aperture and the second aperture are threaded.

36. The extender body of claim 31, wherein the friction reducer is a bushing.

37. The extender body of claim 31, wherein the friction reducer is a bearing.
